(19) United States
(12) Patent Application Publication
(10) Pub. No.: US 2026/0230003 A1
(43) Pub. Date: Aug. 6, 2026

(54) POWER CONVERTER

(71) Applicant: Panasonic Intellectual Property Management Co., Ltd., Osaka (JP)

(72) Inventors: Yutaka KAMON, Osaka (JP); Koji HIGASHIYAMA, Osaka (JP); Yasuhiro ARAI, Shiga (JP); Ryosuke MAEDA, Kyoto (JP)

(21) Appl. No.: 19/149,794

(22) PCT Filed: Jan. 30, 2024
(86) PCT No.: PCT/JP2024/002730

§ 371 Date: Jul. 21, 2025

(30) Foreign Application Priority Data
Feb. 2, 2023 (JP) 2023-014912

(51) Int. Cl. H02M 7/487; H02M 1/00; H02M 1/084; H02M 7/48

(52) U.S. Cl. CPC H02M 7/487; H02M 1/0025; H02M 1/0058; H02M 1/0845; H02M 7/4815

(57) ABSTRACT

A controller performs, when determining that resonant currents respectively passing through two or more switches be going to flow through a resonant inductor simultaneously, a first operation and a second operation. The first operation includes shortening a high-level period of a control signal for a first switch by a shortening period. The second operation includes shifting a high-level period of a control signal for either the first switch or a second switch to cause the high-level period of the control signal for the first switch to begin when a standby period has passed since a point in time when a current value of a resonant current passing through the second switch agreed with a current value of a load current flowing through an AC terminal corresponding to the second switch after the current value of the resonant current passing through the second switch had become equal to an extreme value.

### TECHNICAL FIELD

The present disclosure generally relates to a power converter. More particularly, the present disclosure relates to a power converter having the ability to convert DC power into AC power.

### BACKGROUND ART

Patent Literature 1 discloses a power converter for converting DC power into multiphase AC power.

The power converter of Patent Literature 1 includes a main switching means (power converter circuit), two capacitors, one coil (resonant inductor), a plurality of auxiliary switch elements, and a control means. The main switching means includes a plurality of main switching circuits provided for respective phases of the multiphase AC power. Each of the plurality of main switching circuits is implemented as a pair of main switch elements which are connected in series between both terminals of a DC power supply and uses, as the output node of its associated phase, the interconnection node of the pair of main switch elements. The two capacitors divide the voltage of the DC power supply. One end of the coil is connected to a voltage division node of the two capacitors. The plurality of auxiliary switch elements connect the other end of the coil and the output nodes of the respective phases. When determining that a plurality of phase currents be going to flow through the coil, the control means controls the plurality of auxiliary switch elements to make the amount of current flowing through at least one phase smaller than a preset amount.

### CITATION LIST

### Patent Literature

Patent Literature 1: JP 2010-233306 A

### SUMMARY OF INVENTION

In the power converter of Patent Literature 1, the control means controls, when determining that a plurality of phase currents be going to flow through the coil, the plurality of auxiliary switch elements to make the amount of current flowing through at least one phase smaller than the preset amount, and therefore, the control means does not make soft switching of a main switch corresponding to the at least one phase.

An object of the present disclosure is to provide a power converter having the ability to make soft switching with more reliability.

A power converter according to an aspect of the present disclosure includes a first DC terminal and a second DC terminal, a power converter circuit, a plurality of AC terminals, a plurality of switches, a plurality of resonant capacitors, a resonant inductor, a regenerative capacitor, and a controller. The power converter circuit includes a plurality of first switching elements and a plurality of second switching elements. In the power converter circuit, a plurality of switching circuits, in each of which one of the plurality of first switching elements and a corresponding one of the plurality of second switching elements are connected one to one in series, are connected to each other in parallel. In the power converter circuit, the plurality of first switching elements are connected to the first DC terminal, and the plurality of second switching elements are connected to the second DC terminal. The plurality of AC terminals are provided one to one for the plurality of switching circuits. Each of the plurality of AC terminals is connected to a connection node between the first switching element and the second switching element of a corresponding one of the plurality of switching circuits. The plurality of switches are provided one to one for the plurality of switching circuits. Each of the plurality of switches has a first end thereof connected to the connection node between the first switching element and the second switching element of a corresponding one of the plurality of switching circuits. The plurality of switches have their respective second ends connected in common to a common connection node. The plurality of resonant capacitors are provided one to one for the plurality of switches. Each of the plurality of resonant capacitors is connected between the first end of a corresponding one of the plurality of switches and the second DC terminal. The resonant inductor has a first end and a second end. In the resonant inductor, the first end of the resonant inductor is connected to the common connection node. The regenerative capacitor has a third end and a fourth end. In the regenerative capacitor, the third end of the regenerative capacitor is connected to either the first DC terminal or the second DC terminal. The controller applies a control signal, having a potential alternating between a high level and a low level, to each of the plurality of first switching elements, the plurality of second switching elements, and the plurality of switches. The controller sets, with respect to each of the plurality of switching circuits, a dead time period between a high-level period of the control signal for the first switching element and a high-level period of the control signal for the second switching element and sets a high-level period of the control signal for each of the plurality of switches based on the dead time period with respect to a corresponding switching circuit belonging to the plurality of switching circuits. Each of the plurality of AC terminals allows a load current, passing through either the first switching element or the second switching element of the corresponding switching circuit, to flow therethrough. The controller performs, when determining that resonant currents respectively passing through two or more switches belonging to the plurality of switches be going to flow through the resonant inductor simultaneously, a first operation and further performs a second operation, supposing the two or more switches include two switches corresponding one to one to two AC terminals causing load currents of the same polarity to flow therethrough which belong to the plurality of AC terminals and one of the two switches is a first switch and a remaining one of the two switches is a second switch. The first operation includes shortening a high-level period of a control signal for the first switch by a shortening period from a period including a resonant half cycle and an additional time. The resonant half cycle is determined by capacitance of one resonant capacitor corresponding to the first switch which belongs to the plurality of resonant capacitors and inductance of the resonant inductor. The additional time is determined by a voltage of the regenerative capacitor, inductance of the resonant inductor, and a load current value. The second operation includes shifting a high-level period of a control signal for at least one of the first switch or the second switch to cause the high-level period of the control signal for the first switch to begin when a standby period has passed since a point in time when a current value of a resonant current passing through the second switch agreed with a current value of a load current flowing through an AC terminal corresponding to the second switch which belongs to the two or more AC terminals after the current value of the resonant current passing through the second switch had become equal to an extreme value.

A power converter according to the present disclosure achieves the advantage of enabling soft switching to be made with more reliability.

### BRIEF DESCRIPTION OF DRAWINGS

FIG. 1 is a circuit diagram of a system including a power converter according to a first embodiment;

FIG. 2 illustrates how the power converter operates in a situation where its controller has performed a basic operation when a load current >0 and its resonant capacitor is subjected to a charging operation;

FIG. 3 also illustrates how the power converter operates in a situation where its controller has performed the basic operation when the load current >0 and its resonant capacitor is subjected to the charging operation;

FIG. 4 shows how duties and load currents, respectively corresponding to three-phase voltage instructions in an AC load connected to a plurality of AC terminals of the power converter, change with time;

FIG. 5 shows a first current threshold value and a second current threshold value for use in the controller of the power converter;

FIG. 6 illustrates how the power converter operates in a situation where its controller has performed the basic operation when a load current >0 and its resonant capacitor is subjected to a discharging operation;

FIG. 7 also illustrates how the power converter operates in a situation where its controller has performed the basic operation when the load current <0 and its resonant capacitor is subjected to the discharging operation;

FIG. 8 illustrates how the power converter operates in a situation where its controller has performed the basic operation when the load current <0 and its resonant capacitor is subjected to the charging operation;

FIG. 9 is a timing chart illustrating how the power converter operates in a situation where its controller performs a first operation and a second operation;

FIG. 10 is a timing chart illustrating how the power converter operates in the situation where its controller performs the first operation and the second operation;

FIG. 11 is a timing chart illustrating how the power converter operates in the situation where its controller performs the first operation and the second operation;

FIG. 12 is a timing chart illustrating how the power converter operates in the situation where its controller performs the first operation and the second operation;

FIG. 13 is a timing chart illustrating how a controller of a power converter according to a first variation of the first embodiment operates;

FIG. 14 is a timing chart illustrating how a controller of a power converter according to a second variation of the first embodiment operates;

FIG. 15 is a timing chart illustrating how the controller of the power converter operates;

FIG. 16 is a timing chart illustrating how a power converter according to a second embodiment operates in a situation where its controller performs a first operation and a second operation;

FIG. 17 is a timing chart illustrating how the power converter according to the second embodiment operates in the situation where its controller performs the first operation and the second operation;

FIG. 18 is a timing chart illustrating how a power converter according to a third embodiment operates in a situation where its controller performs a first operation and a second operation;

FIG. 19 is a timing chart illustrating how a power converter according to a fourth embodiment operates in a situation where its controller performs a first operation and a second operation;

FIG. 20 is a timing chart illustrating how a power converter according to a fifth embodiment operates in a situation where its controller performs a first operation and a second operation;

FIG. 21 is a timing chart illustrating how a power converter according to a sixth embodiment operates in a situation where its controller performs a first operation and a second operation;

FIG. 22 is a timing chart illustrating how a power converter according to a seventh embodiment operates in a situation where its controller performs a first operation and a second operation;

FIG. 23 is a timing chart illustrating how a power converter according to an eighth embodiment operates in a situation where its controller performs a first operation and a second operation;

FIG. 24 is a timing chart illustrating how a power converter according to a ninth embodiment operates in a situation where its controller performs a first operation and a second operation;

FIG. 25 is a timing chart illustrating how a power converter according to a tenth embodiment operates in a situation where its controller performs a first operation and a second operation;

FIG. 26 is a circuit diagram of a system including a power converter according to an eleventh embodiment;

FIG. 27 is a circuit diagram of a system including a power converter according to a twelfth embodiment;

FIG. 28 is a circuit diagram of a system including a power converter according to a thirteenth embodiment;

FIG. 29 is a circuit diagram of a system including a power converter according to a fourteenth embodiment;

FIG. 30 is a circuit diagram of a system including a power converter according to a fifteenth embodiment;

FIG. 31 is a circuit diagram of a system including a power converter according to a sixteenth embodiment;

FIG. 32 is a circuit diagram of a system including a power converter according to a seventeenth embodiment; and

FIG. 33 is a circuit diagram of a system including a power converter according to an eighteenth embodiment.

### DESCRIPTION OF EMBODIMENTS

### First Embodiment

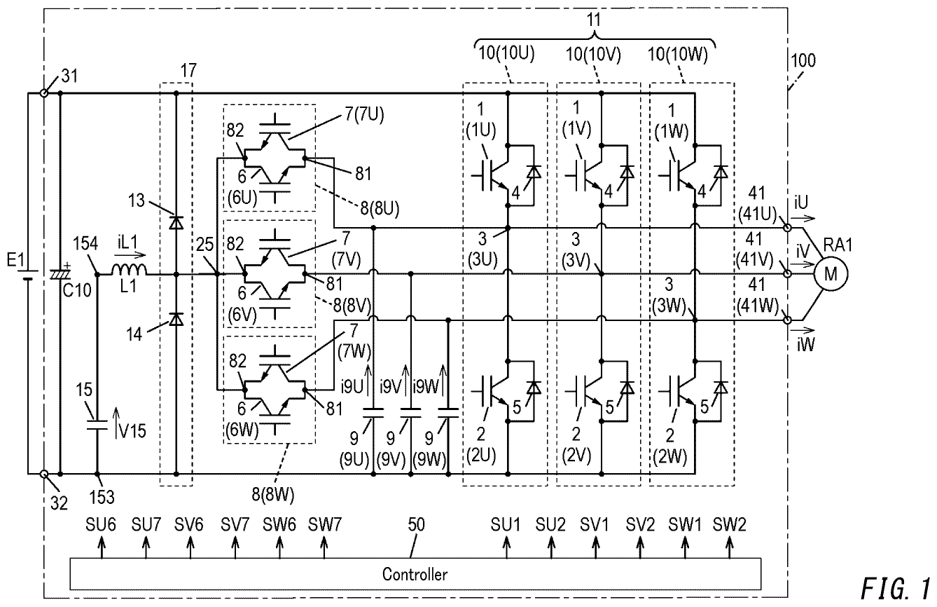

A power converter 100 according to a first embodiment will be described with reference to FIGS. 1-12.

### (1) Overall Configuration for Power Converter

The power converter 100 includes a first DC terminal 31 and a second DC terminal 32, and a plurality of (e.g., three) AC terminals 41 as shown in FIG. 1, for example. A DC power supply E1 is connected between the first DC terminal 31 and the second DC terminal 32. An AC load RA1 is connected to the plurality of AC terminals 41. The AC load RA1 may be, for example, a three-phase motor. The power converter 100 converts the DC output of the DC power supply E1 into AC power and outputs the AC power to the AC load RA1. The DC power supply E1 may include, for example, a solar cell or a fuel cell. The DC power supply E1 may include a DC-DC converter. In the power converter 100, if the plurality of AC terminals 41 are three AC terminals 41, then the AC power may be, for example, three-phase AC power having U-, V-, and W-phases.

The power converter 100 includes a power converter circuit 11, a plurality of (e.g., three) switches 8, a plurality of (e.g., three) resonant capacitors 9, a regenerative capacitor 15, a resonant inductor L1, and a controller 50. The power converter 100 further includes a protection circuit 17 and a capacitor C10. Each of the plurality of switches 8 may be, for example, a bidirectional switch.

The power converter circuit 11 includes a plurality of (e.g., three) first switching elements 1 and a plurality of (e.g., three) second switching elements 2. In the power converter circuit 11, a plurality of (e.g., three) switching circuits 10, in each of which one of the plurality of first switching elements 1 and a corresponding one of the plurality of second switching elements 2 are connected one to one in series, are connected in parallel. In the power converter circuit 11, the plurality of first switching elements 1 are connected to the first DC terminal 31 and the plurality of second switching elements 2 are connected to the second DC terminal 32. The plurality of AC terminals 41 are provided one to one for the plurality of switching circuits 10. Each of the plurality of AC terminals 41 is connected to a connection node 3 between the first switching element 1 and the second switching element 2 of a corresponding one of the plurality of switching circuits 10. The plurality of switches 8 are provided one to one for the plurality of switching circuits 10. Each of the plurality of switches 8 has a first end 81 thereof connected to the connection node 3 between the first switching element 1 and the second switching element 2 of a corresponding one of the plurality of switching circuits 10. The plurality of resonant capacitors 9 are provided one to one for the plurality of switches 8. Each of the plurality of resonant capacitors 9 is connected between the first end 81 of a corresponding one of the plurality of switches 8 and the second DC terminal 32. The resonant inductor L1 has a first end and a second end. The first end of the resonant inductor LI is connected to a common connection node 25. The regenerative capacitor 15 has a third end 153 and a fourth end 154. In the regenerative capacitor 15, the third end 153 thereof is connected to the second DC terminal 32 and the fourth end 154 thereof is connected to the common connection node 25 via the resonant inductor L1. The controller 50 controls the plurality of first switching elements 1, the plurality of second switching elements 2, and the plurality of switches 8.

### (2) Details of Power Converter

In the following description, as for the plurality of switching circuits 10, the switching circuits 10 for the U-, V, and W-phases will be hereinafter referred to as a “switching circuit 10U,” a “switching circuit 10V,” and a “switching circuit 10W,” respectively, for the sake of convenience of description. Also, in the following description, the first switching element 1 and second switching element 2 of the switching circuit 10U will be hereinafter referred to as a “first switching element 1U” and a “second switching element 2U,” respectively. Likewise, in the following description, the first switching element 1 and second switching element 2 of the switching circuit 10V will be hereinafter referred to as a “first switching element 1V” and a “second switching element 2V,” respectively. Likewise, in the following description, the first switching element 1 and second switching element 2 of the switching circuit 10W will be hereinafter referred to as a “first switching element 1W” and a “second switching element 2W,” respectively. Furthermore, in the following description, the connection node 3 between the first switching element 1U and the second switching element 2U will be hereinafter referred to as a “connection node 3U,” the connection node 3 between the first switching element 1V and the second switching element 2V will be hereinafter referred to as a “connection node 3V,” and the connection node 3 between the first switching element 1W and the second switching element 2W will be hereinafter referred to as a “connection node 3W.” Furthermore, in the following description, the AC terminal 41 connected to the connection node 3U will be hereinafter referred to as an “AC terminal 41U,” the AC terminal 41 connected to the connection node 3V will be hereinafter referred to as an “AC terminal 41V,” and the AC terminal 41 connected to the connection node 3W will be hereinafter referred to as an “AC terminal 41W.” Furthermore, in the following description, the resonant capacitor 9 connected to the second switching element 2U in parallel will be hereinafter referred to as a “resonant capacitor 9U,” the resonant capacitor 9 connected to the second switching element 2V in parallel will be hereinafter referred to as a “resonant capacitor 9V,” and the resonant capacitor 9 connected to the second switching element 2W in parallel will be hereinafter referred to as a “resonant capacitor 9W.” Furthermore, in the following description, the switch 8 connected to the connection node 3U will be hereinafter referred to as a “switch 8U,” the switch 8 connected to the connection node 3V will be hereinafter referred to as a “switch 8V,” and the switch 8 connected to the connection node 3W will be hereinafter referred to as a “switch 8W.”

In the power converter 100, the higher-potential output terminal (positive electrode) of the DC power supply E1 is connected to the first DC terminal 31, and the lower-potential output terminal (negative electrode) of the DC power supply E1 is connected to the second DC terminal 32. Also, in the power converter 100, the U-, V, and W-phase terminals of the AC load RA1 are connected to the three AC terminals 41U, 41V, and 41W, respectively.

In the power converter circuit 11, each of the plurality of (e.g., three) first switching elements 1 and the plurality of (e.g., three) second switching elements 2 has a control terminal, a first main terminal, and a second main terminal. The respective control terminals of the plurality of first switching elements 1 and the plurality of second switching elements 2 are connected to the controller 50. In each of the plurality of switching circuits 10 of the power converter 100, the first main terminal of the first switching element 1 is connected to the first DC terminal 31, the second main terminal of the first switching element 1 is connected to the first main terminal of the second switching element 2, and the second main terminal of the second switching element 2 is connected to the second DC terminal 32. In each of the plurality of switching circuits 10, the first switching element 1 is a high-side switching element (P-side switching element) and the second switching element 2 is a low-side switching element (N-side switching element). Each of the plurality of first switching elements 1 and the plurality of second switching elements 2 may be, for example, an insulated gate bipolar transistor (IGBT). Thus, in each of the plurality of first switching elements 1 and the plurality of second switching elements 2, the control terminal, the first main terminal, and the second main terminal thereof are a gate terminal, a collector terminal, and an emitter terminal, respectively.

The power converter circuit 11 further includes a plurality of (e.g., three) first diodes 4 which are connected one to one to the plurality of (e.g., three) first switching elements 1 in antiparallel and a plurality of (e.g., three) second diodes 5 which are connected one to one to the plurality of (e.g., three) second switching elements 2 in antiparallel. In each of the plurality of first diodes 4, the anode of the first diode 4 is connected to the second main terminal (emitter terminal) of the first switching element 1 corresponding to the first diode 4, and the cathode of the first diode 4 is connected to the first main terminal (collector terminal) of the first switching element 1 corresponding to the first diode 4. In each of the plurality of second diodes 5, the anode of the second diode 5 is connected to the second main terminal (emitter terminal) of the second switching element 2 corresponding to the second diode 5, and the cathode of the second diode 5 is connected to the first main terminal (collector terminal) of the second switching element 2 corresponding to the second diode 5.

The U-phase terminal of the AC load RA1 may be connected, for example, to the connection node 3U between the first switching element 1U and the second switching element 2U via the AC terminal 41U. The V-phase of the AC load RA1 may be connected, for example, to the connection node 3V between the first switching element 1V and the second switching element 2V via the AC terminal 41V. The W-phase of the AC load RA1 may be connected, for example, to the connection node 3W between the first switching element 1W and the second switching element 2W via the AC terminal 41W.

The plurality of resonant capacitors 9 are provided one to one for the plurality of switches 8. Each of the plurality of resonant capacitors 9 is connected between the first end 81 of its corresponding switch 8 and the second DC terminal 32. The power converter 100 includes a plurality of resonant circuits. The plurality of resonant circuits includes a resonant circuit having the resonant capacitor 9U and the resonant inductor L1, a resonant circuit having the resonant capacitor 9V and the resonant inductor L1, and a resonant circuit having the resonant capacitor 9W and the resonant inductor L1. The plurality of resonant circuits shares the resonant inductor L1 in common.

Each of the plurality of switches 8 may include, for example, two IGBTs, namely, a first IGBT 6 and a second IGBT 7, which are connected together in antiparallel. In each of the plurality of switches 8, the collector terminal of the first IGBT 6 and the emitter terminal of the second IGBT 7 are connected to each other and the emitter terminal of the first IGBT 6 and the collector terminal of the second IGBT 7 are connected to each other. In each of the plurality of switches 8, the emitter terminal of the first IGBT 6 is connected to the connection node 3 of the switching circuit 10 corresponding to the switch 8 including the first IGBT 6. In each of the plurality of switches 8, the collector terminal of the second IGBT 7 is connected to the connection node 3 of the switching circuit 10 corresponding to the switch 8 including the second IGBT 7. The switch 8U is connected to the connection node 3U between the first switching element 1U and the second switching element 2U. The switch 8V is connected to the connection node 3V between the first switching element 1V and the second switching element 2V. The switch 8W is connected to the connection node 3W between the first switching element 1W and the second switching element 2W. In the following description, the first IGBT 6 and second IGBT 7 of the switch 8U will be hereinafter referred to as a “first IGBT 6U” and a “second IGBT 7U,” respectively, the first IGBT 6 and second IGBT 7 of the switch 8V will be hereinafter referred to as a “first IGBT 6V” and a “second IGBT 7V,” respectively, and the first IGBT 6 and second IGBT 7 of the switch 8W will be hereinafter referred to as a “first IGBT 6W” and a “second IGBT 7W,” respectively, for the sake of convenience of description.

The plurality of switches 8 are controlled by the controller 50. In other words, the first IGBT 6U, the second IGBT 7U, the first IGBT 6V, the second IGBT 7V, the first IGBT 6W, and the second IGBT 7W are controlled by the controller 50.

The resonant inductor L1 has a first end and a second end. In the resonant inductor L1, the first end of the resonant inductor L1 is connected to the common connection node 25 and the second end of the resonant inductor L1 is connected to the fourth end 154 of the regenerative capacitor 15.

The regenerative capacitor 15 is connected between the second end of the resonant inductor L1 and the second DC terminal 32. The regenerative capacitor 15 may be, for example, a film capacitor.

The protection circuit 17 includes a third diode 13 and a fourth diode 14. The third diode 13 is connected between the common connection node 25 and the first DC terminal 31. In the third diode 13, the anode of the third diode 13 is connected to the common connection node 25 and the cathode of the third diode 13 is connected to the first DC terminal 31. The fourth diode 14 is connected between the common connection node 25 and the second DC terminal 32. In the fourth diode 14, the anode of the fourth diode 14 is connected to the second DC terminal 32 and the cathode of the fourth diode 14 is connected to the common connection node 25. Thus, the fourth diode 14 is connected to the third diode 13 in series.

The capacitor C10 is connected between the first DC terminal 31 and the second DC terminal 32 and is connected to the power converter circuit 11 in parallel. The capacitor C10 may be, for example, an electrolytic capacitor.

The controller 50 controls the plurality of first switching elements 1, the plurality of second switching elements 2, and the plurality of switches 8. The agent that performs the functions of the controller 50 includes a computer system. The computer system includes a single or a plurality of computers. The computer system may include a processor and a memory as principal hardware components thereof. The computer system serves as the agent that performs the functions of the controller 50 according to the present disclosure by making the processor execute a program stored in the memory of the computer system. The program may be stored in advance in the memory of the computer system. Alternatively, the program may also be downloaded through a telecommunications line or be distributed after having been recorded in a non-transitory storage medium such as a memory card, an optical disc, or a hard disk drive (magnetic disk), any of which is readable for the computer system. The processor of the computer system may be made up of a single or a plurality of electronic circuits including a semiconductor integrated circuit (IC) or a large-scale integrated circuit (LSI). Those electronic circuits may be either integrated together on a single chip or distributed on multiple chips, whichever is appropriate. Those multiple chips may be aggregated together in a single device or distributed in multiple devices without limitation.

The controller 50 outputs control signals SU1, SV1, SW1 to control the ON/OFF states of the plurality of first switching elements 1U, 1V, 1W, respectively. Each of the control signals SU1, SV1, SW1 may be, for example, a pulse width modulation (PWM) signal having, for example, a potential level that alternates between a first potential level (hereinafter referred to as a “low level”) and a second potential level (hereinafter referred to as a “high level”) higher than the first potential level. The first switching elements 1U, 1V, 1W respectively turn ON when the control signals SU1, SV1, SW1 have high level and respectively turn OFF when the control signals SU1, SV1, SW1 have low level. In addition, the controller 50 also outputs control signals SU2, SV2, SW2 to control the ON/OFF states of the plurality of second switching elements 2U, 2V, 2W, respectively. Each of the control signals SU2, SV2, SW2 may be, for example, a PWM signal having, for example, a potential level that alternates between the first potential level (hereinafter referred to as a “low level”) and the second potential level (hereinafter referred to as a “high level”) higher than the first potential level. The second switching elements 2U, 2V, 2W respectively turn ON when the control signals SU2, SV2, SW2 have high level and respectively turn OFF when the control signals SU2, SV2, SW2 have low level.

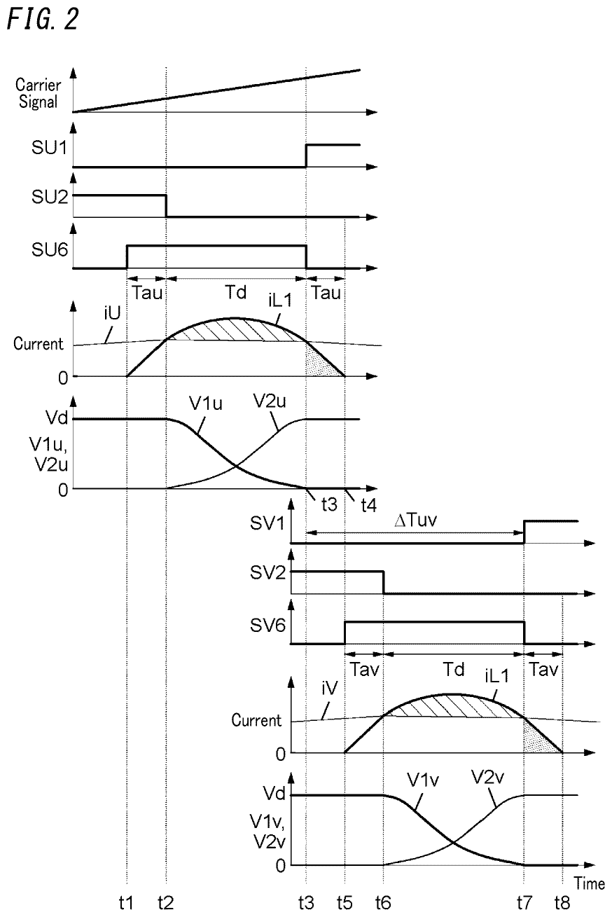

The controller 50 generates, using a carrier signal (refer to FIG. 2) having a saw-tooth waveform, the control signals SU1, SV1, SW1 for the plurality of first switching elements 1U, 1V, 1W, respectively, and the control signals SU2, SV2, SW2 for the plurality of second switching elements 2U, 2V, 2W, respectively. More specifically, the controller 50 generates, based on at least the carrier signal and a U-phase voltage instruction, the control signals SU1, SU2 to be applied to the first switching element 1U and the second switching element 2U, respectively. Also, the controller 50 generates, based on at least the carrier signal and a V-phase voltage instruction, the control signals SV1, SV2 to be applied to the first switching element 1V and the second switching element 2V, respectively. Furthermore, the controller 50 generates, based on at least the carrier signal and a W-phase voltage instruction, the control signals SW1, SW2 to be applied to the first switching element 1W and the second switching element 2W, respectively. The U-phase voltage instruction, the V-phase voltage instruction, and the W-phase voltage instruction may be, for example, sinusoidal wave signals, of which the phases are different from each other by 120 degrees and of which the amplitude (voltage instruction value) changes with time. Note that the waveform of the carrier signal does not have to be the saw-tooth waveform but may also be a triangular waveform or a mirror-reversed version of the saw-tooth waveform shown in FIG. 2. Also, the U-phase voltage instruction, the V-phase voltage instruction, and the W-phase voltage instruction each have one cycle of the same length. In addition, one cycle of the U-phase voltage instruction, the V-phase voltage instruction, and the W-phase voltage instruction is longer than one cycle of the carrier signal.

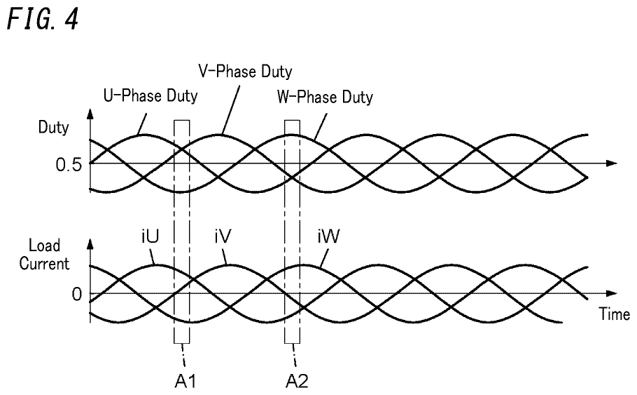

The duty of the control signals SU1, SU2 to be applied from the controller 50 to the first switching element 1U and the second switching element 2U, respectively, varies in accordance with the U-phase voltage instruction. In FIG. 4, the duty of the control signal SU1 is shown as a “U-phase duty.” The controller 50 (refer to FIG. 1) generates the control signal SU1 to be applied to the first switching element 1U by comparing the U-phase voltage instruction with the carrier signal. The controller 50 generates the control signal SU2 to be applied to the second switching element 2U by inverting the control signal SU1 to be applied to the first switching element 1U. In addition, to prevent the respective ON periods of the first switching element 1U and the second switching element 2U from overlapping with each other, the controller 50 sets a dead time period Td (refer to FIG. 2) between a high-level period of the control signal SU1 and a high-level period of the control signal SU2.

The duty of the control signals SV1, SV2 to be applied from the controller 50 to the first switching element 1V and the second switching element 2V, respectively, varies in accordance with the V-phase voltage instruction. In FIG. 4, the duty of the control signal SV1 is shown as a “V-phase duty.” The controller 50 (refer to FIG. 1) generates the control signal SV1 to be applied to the first switching element 1V by comparing the V-phase voltage instruction with the carrier signal. The controller 50 also generates the control signal SV2 to be applied to the second switching element 2V by inverting the control signal SV1 to be applied to the first switching element 1V. In addition, to prevent the respective ON periods of the first switching element 1V and the second switching element 2V from overlapping with each other, the controller 50 sets a dead time period Td (refer to FIG. 2) between a high-level period of the control signal SV1 and a high-level period of the control signal SV2.

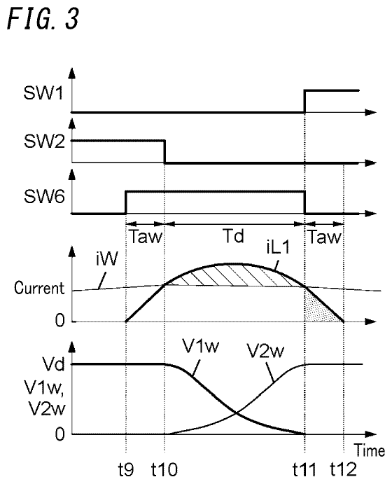

The duty of the control signals SW1, SW2 to be applied from the controller 50 to the first switching element 1W and the second switching element 2W, respectively, varies in accordance with the W-phase voltage instruction. In FIG. 4, the duty of the control signal SW1 is shown as a “W-phase duty.” The controller 50 (refer to FIG. 1) generates the control signal SW1 to be applied to the first switching element 1W by comparing the W-phase voltage instruction with the carrier signal. The controller 50 generates the control signal SW2 to be applied to the second switching element 2W by inverting the control signal SW1 to be applied to the first switching element 1W. In addition, to prevent the respective ON periods of the first switching element 1W and the second switching element 2W from overlapping with each other, the controller 50 sets a dead time period Td (refer to FIG. 3) between a high-level period of the control signal SW1 and a high-level period of the control signal SW2.

The U-phase voltage instruction, the V-phase voltage instruction, and the W-phase voltage instruction may be, for example, sinusoidal wave signals, of which the phases are different from each other by 120 degrees and of which the amplitude changes with time. Thus, the respective duties (i.e., U-, V-, and W-phase duties) of the control signals SU1, SV1, SW1 change in the form of sinusoidal waves, of which the phases are different from each other by 120 degrees, as shown in FIG. 4, for example. In the same way, the respective duties of the control signals SU2, SV2, SW2 also change in the form of sinusoidal waves, of which the phases are different from each other by 120 degrees.

The controller 50 generates the respective control signals SU1, SU2, SV1, SV2, SW1, SW2 based on the carrier signal, the respective voltage instructions, and information about the state of the AC load RA1. For example, if the AC load RA1 is a three-phase motor, the information about the state of the AC load RA1 may include, for example, detection values provided by a plurality of current sensors for respectively detecting output currents (hereinafter referred to as “load currents”) iU, iV, iW flowing respectively through the U-, V-, and W-phases of the AC load RA1.

The plurality of switches 8, the resonant inductor L1, the plurality of resonant capacitors 9, and the regenerative capacitor 15 are provided to make zero-voltage soft switching of the 14 plurality of first switching elements 1 and the plurality of second switching elements 2.

In this power converter 100, the controller 50 controls not only the plurality of first switching elements 1 and the plurality of second switching elements 2 of the power converter circuit 11 but also the plurality of switches 8 as well.

The controller 50 generates control signals SU6, SU7, SV6, SV7, SW6, SW7 for controlling the respective ON/OFF states of the first IGBT 6U, the second IGBT 7U, the first IGBT 6V, the second IGBT 7V, the first IGBT 6W, and the second IGBT 7W, respectively, and outputs the control signals SU6, SU7, SV6, SV7, SW6, SW7 to the respective gate terminals of the first IGBT 6U, the second IGBT 7U, the first IGBT 6V, the second IGBT 7V, the first IGBT 6W, and the second IGBT 7W.

If the first IGBT 6U is ON and the second IGBT 7U is OFF, the switch 8U allows a charging current that flows through the regenerative capacitor 15, the resonant inductor L1, the switch 8U, and the resonant capacitor 9U in this order to pass therethrough. The charging current is a current for charging the resonant capacitor 9U with electricity. On the other hand, if the first IGBT 6U is OFF and the second IGBT 7U is ON, the switch 8U allows a discharging current that flows through the resonant capacitor 9U, the switch 8U, the resonant inductor L1, and the regenerative capacitor 15 in this order to pass therethrough. The discharging current is a current for discharging electricity from the resonant capacitor 9U.

If the first IGBT 6V is ON and the second IGBT 7V is OFF, the switch 8V allows a charging current that flows through the regenerative capacitor 15, the resonant inductor L1, the switch 8V, and the resonant capacitor 9V in this order to pass therethrough. The charging current is a current for charging the resonant capacitor 9V with electricity. On the other hand, if the first IGBT 6V is OFF and the second IGBT 7V is ON, the switch 8V allows a discharging current that flows through the resonant capacitor 9V, the switch 8V, the resonant inductor L1, and the regenerative capacitor 15 in this order to pass therethrough. The discharging current is a current for discharging electricity from the resonant capacitor 9V.

If the first IGBT 6W is ON and the second IGBT 7W is OFF, the switch 8W allows a charging current that flows through the regenerative capacitor 15, the resonant inductor L1, the switch 8W, and the resonant capacitor 9W in this order to pass therethrough. The charging current is a current for charging the resonant capacitor 9W with electricity. On the other hand, if the first IGBT 6W is OFF and the second IGBT 7W is ON, the switch 8W allows a discharging current that flows through the resonant capacitor 9W, the switch 8W, the resonant inductor L1, and the regenerative capacitor 15 in this order to pass therethrough. The discharging current is a current for discharging electricity from the resonant capacitor 9W.

### (3) Operation of Power Converter

In the following description, as for a current iL1 flowing through the resonant inductor L1, if the current flows in the direction indicated by the arrow shown in FIG. 1, then the polarity of the current iL1 is supposed to be positive. On the other hand, if the current iL1 flows in the direction opposite from the one indicated by the arrow shown in FIG. 1, then the polarity of the current iL1 is supposed to be negative. In addition, in the following description, as for each of the load currents iU, iV, iW respectively flowing through the U-, V-, and W-phases of the AC load RA1, if the load current iU, iV, iW flows in the direction indicated by a corresponding one of the arrows shown in FIG. 1, then the polarity of the load current iU, iV, iW is supposed to be positive. On the other hand, if the load current iU, iV, iW flows in the direction opposite from the one indicated by the arrow shown in FIG. 1, then the polarity of the load current iU, iV, iW is supposed to be negative. Furthermore, as for each of currents i9U, i9V, i9W flowing through the resonant capacitors 9U, 9V, 9W, respectively, if the current i9U, i9V, i9W flows in the direction indicated by a corresponding one of the arrows shown in FIG. 1, then the polarity of the current i9U, i9V, i9W is supposed to be positive. On the other hand, if the current i9U, i9V, i9W flows in the direction opposite from the one indicated by the arrow shown in FIG. 1, then the polarity of the current i9U, i9V, i9W is supposed to be negative. Thus, in the case of the discharging operation of discharging electricity from the resonant capacitor 9U, 9V, 9W, the polarity of the current i9U, i9V, i9W is positive. On the other hand, in the case of the charging operation of charging the resonant capacitor 9U, 9V, 9W with electricity, the polarity of the current i9U, i9V, i9W is negative.

In this power converter 100, the first IGBT 6U of the switch 8U may turn OFF in a state where the first IGBT 6U of the switch 8U is ON and a positive current iL1 is flowing through the resonant inductor L1, for example. In that case, the current iL1 flowing through the resonant inductor L1 is regenerated to the power converter circuit 11 via the third diode 13 until the current iL1 goes zero due to the consumption of energy of the resonant inductor L1. Also, in this power converter 100, the second IGBT 7U of the switch 8U may turn OFF in a state where the second IGBT 7U of the switch 8U is ON and a negative current iL1 is flowing through the resonant inductor L1, for example. In that case, the current iL1 flows through the resonant inductor L1 along the path passing through the fourth diode 14, the resonant inductor L1, and the regenerative capacitor 15 in this order until the current iL1 goes zero due to the consumption of energy of the resonant inductor L1.

Furthermore, in this power converter 100, the first IGBT 6V of the switch 8V may turn OFF in a state where the first IGBT 6V of the switch 8V is ON and a positive current iL1 is flowing through the resonant inductor L1, for example. In that case, the current iL1 flowing through the 16 resonant inductor L1 is regenerated to the power converter circuit 11 via the third diode 13 until the current iL1 goes zero due to the consumption of energy of the resonant inductor L1. Furthermore, in this power converter 100, the second IGBT 7V of the switch 8V may turn OFF in a state where the second IGBT 7V of the switch 8V is ON and a negative current iL1 is flowing through the resonant inductor L1, for example. In that case, the current iL1 flows through the resonant inductor L1 along the path passing through the fourth diode 14, the resonant inductor L1, and the regenerative capacitor 15 in this order until the current iL1 goes zero due to the consumption of energy of the resonant inductor L1.

Furthermore, in this power converter 100, the first IGBT 6W of the switch 8W may turn OFF in a state where the first IGBT 6W of the switch 8W is ON and a positive current iL1 is flowing through the resonant inductor L1, for example. In that case, the current iL1 flowing through the resonant inductor L1 is regenerated to the power converter circuit 11 via the third diode 13 until the current iL1 goes zero due to the consumption of energy of the resonant inductor L1. Furthermore, in this power converter 100, the second IGBT 7W of the switch 8W may turn OFF in a state where the second IGBT 7W of the switch 8W is ON and a negative current iL1 is flowing through the resonant inductor L1, for example. In that case, the current iL1 flows through the resonant inductor L1 along the path passing through the fourth diode 14, the resonant inductor L1, and the regenerative capacitor 15 in this order until the current iL1 goes zero due to the consumption of energy of the resonant inductor L1.

The controller 50 sets a dead time period Td between the high-level period of the control signal SU1, SV1, SW1 for the first switching element 1U, 1V, 1W and the high-level period of the control signal SU2, SV2, SW2 for the second switching element 2U, 2V, 2W with respect to each of the plurality of switching circuits 10. In addition, the controller 50 also sets the high-level period of a control signal for each of the plurality of switches 8 based on the dead time period Td with respect to a corresponding one of the plurality of switching circuits 10. In this case, the controller 50 sets the length of the high-level period of the control signal for each of the plurality of switches 8 as, for example, the sum of the length of a first period and the length of a second period. The length of the first period is an N (where N is an integer) times as long as a resonant half cycle which is determined by the capacitance of the resonant capacitor 9 corresponding to the switch 8 and the inductance of the resonant inductor L1. Supposing the resonant cycle is Tres, the length of the first period is calculated by N×(Tres/2). The end time of the first period, i.e., the point in time when the period that is N times as long as the resonant half cycle ends preferably agrees with the end time of the dead time period Td for the switching circuit 10 corresponding to the switch 8. For example, in the example shown in FIG. 2, N=1 is satisfied and the length of the control signal SU6 between a time t2 and a time t3 is the length of the first period. More specifically, the length of the first period is designed at Tres/2=length of the dead time period Td with N supposed to be 1. In other words, FIG. 2 shows an example in which the capacitance of the resonant capacitor 9 and the inductance of the resonant inductor L1 are selected to make Tres/2 equal to the length of the dead time period Td. The length of the second period may be, for example, the additional time Tau which is determined by the voltage of the regenerative capacitor 15, the inductance of the resonant inductor L, and the load current value. The length of the first period described above is an exemplary value according to an ideal design. Alternatively, the length of the first period may also be equal to or greater than 90% and equal to or less than 110% of the length N×(Tres/2). The length of the second period described above is an exemplary value according to an ideal design. Alternatively, the length of the second period may also be equal to or greater than 90% and equal to or less than 110% of the additional time (e.g., the additional time Tau in the example shown in FIG. 2) determined by the voltage of the regenerative capacitor 15, the inductance of the resonant inductor L, and the load current value.

Next, a basic operation of zero-voltage soft switching to be performed on each of the plurality of first switching elements 1 and the plurality of second switching elements 2 will be described with reference to FIGS. 1-8. As used herein, the “basic operation” refers to an operation to be performed when resonant currents, passing through two or more switches 8 belonging to the plurality of switches 8, are not going to flow simultaneously through the resonant inductor L1. It will be described, after the basic operation has been described, how this power converter 100 operates when the controller 50 determines that the resonant currents passing through the two or more switches 8 belonging to the plurality of switches 8 be going to flow simultaneously.

### (3.1) Basic Operation

When the zero-voltage soft switching is performed on the first switching element 1, the voltage across the first switching element 1 needs to be reduced to zero just before the first switching element 1 as the target of zero-voltage soft switching turns ON. When the zero-voltage soft switching is performed on the second switching element 2, the voltage across the second switching element 2 needs to be reduced to zero just before the second switching element 2 as the target of zero-voltage soft switching turns ON. In the following description, the switching element (which is either the first switching element 1 or the second switching element 2) as the target of the zero-voltage soft switching will be hereinafter referred to as a “target switching element.”

The basic operation of the controller 50 changes according to the polarity (i.e., either positive or negative) of a load current flowing through the AC terminal 41 connected to the target switching element and depending on whether the resonant capacitor 9 connected to the target switching element in series or in parallel is performing the charging operation or the discharging operation. The load current has positive polarity when flowing from the AC terminal 41 toward the AC load RA1 and has negative polarity when flowing from the AC load RA1 toward the AC terminal 41. While the resonant capacitor 9 is performing the charging operation, the voltage across the resonant capacitor 9 increases. On the other hand, while the resonant capacitor 9 is performing the discharging operation, the voltage across the resonant capacitor 9 decreases. The voltage across each of the plurality of second switching elements 2 is the same as the voltage across the resonant capacitor 9 connected to the second switching element 2 in parallel.

### (3.1.1) Operation of Soft-Switching First Switching Element When Load Current >0

If the target of the soft switching is a first switching element 1 (hereinafter referred to as a “target first switching element 1”) and the polarity of the load current flowing through the AC terminal 41 connected to the target first switching element 1 is positive, then the controller 50 turns ON the first IGBT 6 corresponding to the target first switching element 1. In this manner, the controller 50 causes the resonant inductor L1 and resonant capacitor 9 connected to the target first switching element 1 to produce resonance, thereby charging the resonant capacitor 9 with electric charges supplied from the regenerative capacitor 15 and reducing the voltage across the target first switching element 1 to zero. This allows the power converter 100 to make zero-voltage soft switching of the target first switching element 1.

The control signals SU1, SU2 to be respectively applied from the controller 50 to the first switching element 1U and the second switching element 2U of the switching circuit 10U in a situation where the target first switching element is the first switching element 1U of the switching circuit 10U are shown in FIG. 2. In addition, the control signal SU6 to be applied from the controller 50 to the first IGBT 6U of the switch 8U, the load current iU flowing through the U-phase of the AC load RA1, the current iL1 flowing through the resonant inductor L1, the voltage V1u across the first switching element 1U, and the voltage V2u across the second switching element 2U are also shown in FIG. 2. Furthermore, the control signals SV1, SV2 to be respectively applied from the controller 50 to the first switching element 1V and the second switching element 2V of the switching circuit 10V in a situation where the target first switching element is the first switching element 1V of the switching circuit 10V are also shown in FIG. 2. In addition, the control signal SV6 to be applied from the controller 50 to the first IGBT 6V of the switch 8V, the load current iV flowing through the V-phase of the AC load RA1, the current iL1 flowing through the resonant inductor L1, the voltage V1v across the first switching element 1V, and the voltage V2v across the second switching element 2V are also shown in FIG. 2. In FIG. 2, the voltage value of the DC power supply E1 is designated by Vd.

Furthermore, the dead time period Td that the controller 50 sets to prevent the first switching element 1 and the second switching element 2 of the same phase from turning ON simultaneously is also shown in FIG. 2. Besides, an additional time Tau set by the controller 50 with respect to the control signal SU6 for the first IGBT 6U of the switch 8U and an additional time Tav set by the controller 50 with respect to the control signal SV6 for the first IGBT 6V of the switch 8V are also shown in FIG. 2. The additional time Tau and the additional time Tav will be described later.

The control signals SW1, SW2 to be respectively applied from the controller 50 to the first switching element 1W and the second switching element 2W of the switching circuit 10W in a situation where the target first switching element is the first switching element 1W of the switching circuit 10W are shown in FIG. 3. In addition, the control signal SW6 to be applied from the controller 50 to the first IGBT 6W of the switch 8W and the load current iW flowing through the W-phase of the AC load RA1 are also shown in FIG. 3. The current iL1 flowing through the resonant inductor L1 is also shown in FIG. 3. The voltage V1w across the first switching element 1W and the voltage V2w across the second switching element 2 are also shown in FIG. 3. In FIG. 3, the voltage value of the DC power supply E1 is designated by Vd.

Furthermore, the dead time period Td that the controller 50 sets to prevent the first switching element 1W and the second switching element 2W from turning ON simultaneously is also shown in FIG. 3. Besides, an additional time Taw set by the controller 50 with respect to the control signal SW6 for the first IGBT 6W of the switch 8W is also shown in FIG. 3. The additional time Taw will be described later.

The additional time Tau is an amount of time that the controller 50 provides to make the high-level period of the control signal SU6 longer than the dead time period Td by setting the beginning time t1 of the high-level period of the control signal SU6 at a point in time earlier than the beginning time t2 of the dead time period Td as shown in FIG. 2. The length of the additional time Tau is determined by the value of the load current iU. To start producing the LC resonance from the beginning time t2 of the dead time period Td, it is preferable that the value of the current iL1 agree with the value of the load current iU at the beginning time t2 of the dead time period Td. This is because as long as iL1<iU is satisfied, all of the current iL1 flows through the AC load RA1, and therefore, the resonant capacitor 9U cannot be charged. The end time of the high-level period of the control signal SU6 may be simultaneous with, or later than, the end time t3 of the dead time period Td. In the example shown in FIG. 2, the end time of the high-level period of the control signal SU6 is set to be simultaneous with the end time t3 of the dead time period Td. The controller 50 sets the high-level period of the control signal SU6 at Tau+Td. That is to say, by setting N=1 and Tres/2=length of the dead time period Td, the controller 50 sets the length of the first period at N×Tres/2=Td. In the switching circuit 10U, the voltage V2u across the second switching element 2U becomes Vd at the end time t3 of the dead time period Td, and the voltage V1u across the first switching element 1U goes zero at the end time t3 of the dead time period Td. In the example shown in FIG. 2, the current iL1 starts flowing through the resonant inductor L1 at the beginning time t1 of the high-level period of the control signal SU6 and goes zero at a time t4 when the additional time Tau has passed since the end time t3 of the dead time period Td. As for the current iL1, the current iL1 satisfies iL1>iU from the beginning time t2 of the dead time period Td, and therefore, the current iL1 in the hatched part of the current waveform shown as the fifth waveform from the top of FIG. 2 flows into the resonant capacitor 9U to produce LC resonance. From the end time t3 of the dead time period Td and on, the current iL1 will be regenerated to the power converter circuit 11 via the third diode 13 directly connected to the resonant inductor L1.

To start producing the LC resonance at the beginning time t2 of the dead time period Td and end a resonant half cycle at the end time of the dead time period Td as described above, the controller 50 determines the additional time Tau based on the load current iU such that iL1=iU is satisfied at the beginning time t2 of the dead time period Td. More specifically, using either the detection result of the load current iU by a current sensor or a signal processing value thereof, or an estimated value of the load current iU, the inductance L of the resonant inductor L1 that has been stored in advance, and the detection result of the voltage V15 at the regenerative capacitor 15 (i.e., the potential V15 at the fourth terminal 154 of the regenerative capacitor 15), for example, the controller 50 determines the additional time Tau by the equation: Tau=iU×(L/V15). In this case, as the detection result of the load current iU or the signal processing value thereof, either a detection value at a carrier cycle at which the additional time Tau is added or a detection value at a timing closest to the carrier cycle may be used. Also, in this case, as the estimated value of the load current iU, a value of the load current iU estimated at the carrier cycle at which the additional time Tau is added may be used, for example. The resonant half cycle in the case of the basic operation is one half of a resonant cycle, which is the reciprocal of the resonant frequency of a resonant circuit including the resonant inductor L1 and one resonant capacitor 9. Thus, if the inductance of the resonant inductor L1 is L and the capacitance of the resonant capacitor 9 is C, then the resonant half cycle is π×(L·C)^{1/2}. The controller 50 sets the resonant half cycle in the case of the basic operation to make the resonant half cycle as long as the length of the dead time period Td, for example.

The additional time Tav is an amount of time that the controller 50 provides to make the high-level period of the control signal SV6 longer than the dead time period Td by setting the beginning time t5 of the high-level period of the control signal SV6 at a point in time earlier than the beginning time t6 of the dead time period Td as shown in FIG. 2. The length of the additional time Tav is determined by the value of the load current iV. To start producing LC resonance from the beginning time t6 of the dead time period Td, it is preferable that the value of the current iL1 agree with the value of the load current iV at the beginning time t6 of the dead time period Td. This is because as long as iL1<iV is satisfied, all of the current iL1 flows through the AC load RA1, and therefore, the resonant capacitor 9V cannot be charged. The end time of the high-level period of the control signal SV6 may be simultaneous with, or later than, the end time t7 of the dead time period Td. In the example shown in FIG. 2, the end time of the high-level period of the control signal SV6 is set to be simultaneous with the end time t7 of the dead time period Td. The controller 50 sets the high-level period of the control signal SV6 at Tav+Td. The voltage V1v across the first switching element 1V goes zero at the end time t7 of the dead time period Td. In the example shown in FIG. 2, the current iL1 starts flowing through the resonant inductor L1 at the beginning time t5 of the high-level period of the control signal SV6 and goes zero at a time t8 when the additional time Tav has passed since the end time t7 of the dead time period Td. As for the current iL1, the current iL1 satisfies iL1≥iV from the beginning time t6 of the dead time period Td and on, and therefore, the current iL1 in the hatched part of the current waveform shown as the tenth waveform from the top of FIG. 2 flows into the resonant capacitor 9V to produce the LC resonance. From the end time t7 of the dead time period Td and on, the current iL1 will be regenerated to the power converter circuit 11 via the third diode 13 directly connected to the resonant inductor L1.

To start producing the LC resonance at the beginning time t6 of the dead time period Td as described above, the controller 50 determines the additional time Tav based on the load current iV such that iL1=iV is satisfied at the beginning time t6 of the dead time period Td. More specifically, using either the detection result of the load current iV by a current sensor or a signal processing value thereof, or an estimated value of the load current iV, the inductance L of the resonant inductor L1 that has been stored in advance, and the detection result of the voltage V15 at the regenerative capacitor 15, for example, the controller 50 determines the additional time Tav by the equation: Tav=iV×(L/V15). In this case, as the detection result of the load current iV or the signal processing value thereof, either a detection value at a carrier cycle at which the additional time Tav is added or a detection value at a timing closest to the carrier cycle may be used. Also, in this case, as the estimated value of the load current iV, a value of the load current iV estimated at the carrier cycle at which the additional time Tav is added may be used, for example.

The additional time Taw is an amount of time that the controller 50 provides to make the high-level period of the control signal SW6 longer than the dead time period Td by setting the beginning time t9 of the high-level period of the control signal SW6 at a point in time earlier than the beginning time t10 of the dead time period Td as shown in FIG. 3. The length of the additional time Taw is determined by the value of the load current iW. To start producing LC resonance from the beginning time t10 of the dead time period Td, it is preferable that the value of the current iL1 agree with the value of the load current iW at the beginning time t10 of the dead time period Td. This is because as long as iL1<iW is satisfied, all of the current iL1 flows through the AC load RA1, and therefore, the resonant capacitor 9W cannot be charged. The end time of the high-level period of the control signal SW6 may be simultaneous with, or later than, the end time t11 of the dead time period Td. In the example shown in FIG. 3, the end time of the high-level period of the control signal SW6 is set to be simultaneous with the end time t11 of the dead time period Td. The controller 50 sets the high-level period of the control signal SW6 at Taw+Td. The voltage V1w across the first switching element 1W goes zero at the end time t11 of the dead time period Td. In the example shown in FIG. 3, the current iL1 starts flowing through the resonant inductor L1 at the beginning time t9 of the high-level period of the control signal SW6 and goes zero at a time t12 when the additional time Taw has passed since the end time t11 of the dead time period Td. As for the current iL1, the current iL1 satisfies iL1≥iW from the beginning time t10 of the dead time period Td and on, and therefore, the current iL1 in the hatched part of the current waveform shown as the fourth waveform from the top of FIG. 3 flows into the resonant capacitor 9W to produce the LC resonance. From the end time t11 of the dead time period Td and on, the current iL1 will be regenerated to the power converter circuit 11 via the third diode 13 directly connected to the resonant inductor L1.

The controller 50 determines the additional time Taw based on the load current iW. More specifically, using the detection result of the load current iW by a current sensor, the inductance L of the resonant inductor L1 that has been stored in advance, and the detection result of the voltage V15 at the regenerative capacitor 15, for example, the controller 50 determines the additional time Taw by the equation: Taw=iW×(L/V15). In this case, as the detection result of the load current iW or the signal processing value thereof, either a detection value at a carrier cycle at which the additional time Taw is added or a detection value at a timing closest to the carrier cycle may be used. Also, in this case, as the estimated value of the load current iW, a value of the load current iW estimated at the carrier cycle at which the additional time Taw is added may be used, for example.

### (3.1.2) Operation of Soft-Switching Second Switching Element When Load Current >0

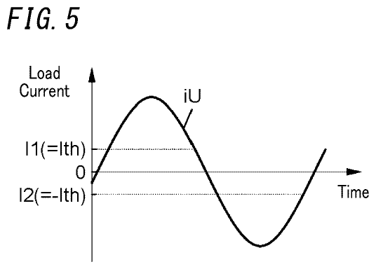

If the target of the soft switching is a second switching element 2 (hereinafter referred to as a “target second switching element 2”) and the polarity of the load current (which is the load current iU, the load current iV, or the load current iW) flowing through the AC terminal 41 connected to the target second switching element 2 is positive, then the controller 50 compares the current value of the load current with a first current threshold value I1 (=Ith, refer to FIG. 5). If the current value of the load current is greater than the first current threshold value I1, the controller 50 does not turn the switch 8 ON. On the other hand, if the current value of the load current is less than the first current threshold value I1, the controller 50 turns the switch 8 ON in the dead time period Td. In this case, the resonant half cycle is supposed to be set to be, for example, as long as the length of the dead time period Td as in the (3.1.1) section. In the power converter 100, if the current value of the load current is greater than the first current threshold value I1, the controller 50 may perform, using the load current iU, a discharging operation on the resonant capacitor 9U connected to the target second switching element 2 in parallel without turning ON the switch 8 corresponding to the target second switching element 2. This allows the power converter 100 to make zero-voltage soft switching of the target second switching element 2.

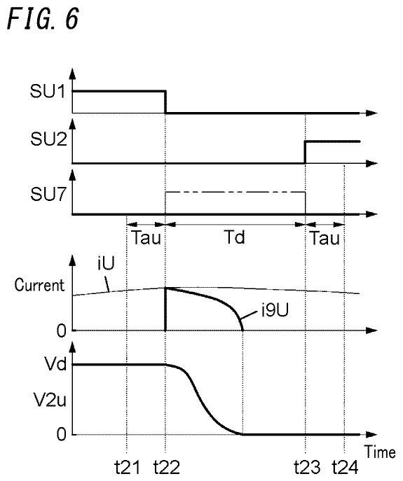

In FIG. 6, the control signals SU1, SU2, SU7, the load current iU, a current i9U flowing from the resonant capacitor 9U, and the voltage V2u across the second switching element 2 are shown as for a situation where the target second switching element 2 is the second switching element 2U of the switching circuit 10U and the current value of the load current is greater than the first current threshold value I1. In addition, the dead time period Td and the additional time Tau set by the controller 50 with respect to a control signal SU7 for the second IGBT 7U of the switch 8U are also shown in FIG. 6.

If the current value of the load current iU is greater than the first current threshold value I1, the controller 50 does not provide any high-level period for the control signal SU7. In that case, in the power converter 100, a current i9U starts flowing from the resonant capacitor 9U at the beginning time t22 of the dead time period Td, the current i9U decreases to zero before the end time t23 of the dead time period Td, and the voltage V2u across the second switching element 2U goes zero before the end time t23 of the dead time period Td. Thus, in the power converter 100, when the control signal SU2 changes from low level to high level at the end time t23 of the dead time period Td, the second switching element 2U is subjected to zero-voltage soft switching.

If the current value of the load current iU is less than the first current threshold value I1, then the controller 50 provides a high-level period for the control signal SU7 as indicated by the two-dot chain in FIG. 6, for example. In that case, the beginning time of the high-level period of the control signal SU7 may be simultaneous with, for example, the beginning time t22 of the dead time period Td. Also, the end time of the high-level period of the control signal SU7 is simultaneous with the end time t23 of the dead time period Td. Thus, in the power converter 100, the voltage V2u across the second switching element 2U goes zero before the end time t23 of the dead time period Td. Consequently, in the power converter 100, when the control signal SU2 changes from low level to high level at the end time t23 of the dead time period Td, the second switching element 2 is subjected to zero-voltage soft switching. Alternatively, the beginning time of the high-level period of the control signal SU7 may be a time t21 which is earlier than the beginning time of the dead time period Td by the additional time Tau. The end time of the high-level period of the control signal SU7 may be a time t24 which is later than the end time t23 of the dead time period Td by the additional time Tau. Note that the time before or after the high-level period overlaps with the dead time period Td does not have to be the additional time Tau but may also be any other preset time. Also, note that how the way to determine the high-level period of a control signal for the switch 8 changes according to the threshold value of the load current is only an example of ideal design, and therefore, should not be construed as limiting. For example, even if the current value of the load current is greater than the first current threshold value I1, the controller 50 may also set the high-level period of the control signal for the switch 8 to turn the switch 8 ON during the dead time period Td. Also, even if the current value of the load current is less than the first current threshold value I1, the controller 50 does not have to turn the switch 8 ON during the dead time period Td. Alternatively, the controller 50 may set the high-level period of the control signal for the switch 8 to, for example, always keep the switch 8 ON throughout the dead time period Td irrespective of the first current threshold value I1. Still alternatively, the controller 50 may always keep the switch 8 OFF irrespective of the first current threshold value I1. Yet alternatively, the controller 50 may perform some of the operations described in the (3.1.2) section in combination as appropriate. Furthermore, the controller 50 does not have to cause the high-level period of a control signal for the switch 8 to agree with the dead time period Td as in the example described above. For example, the high-level period of the control signal for the switch 8 may be designed according to the designed time of the resonant half cycle to have a length different from the length of the dead time period Td.

### (3.1.3) Operation of Soft-Switching Second Switching Element When Load Current <0

If the polarity of the load current (which is the load current iU, the load current iV, or the load current iW) flowing through the AC terminal 41 connected to the target second switching element 2 is negative, then the controller 50 turns ON the second IGBT 7 corresponding to the target second switching element 2. In this manner, the controller 50 causes the resonant capacitor 9 and the resonant inductor L1 connected to the target second switching element 2 to produce resonance, thereby discharging electricity from the resonant capacitor 9 and reducing the voltage across the target second switching element 2 to zero. This allows the power converter 100 to make zero-voltage soft switching of the target second switching element 2.

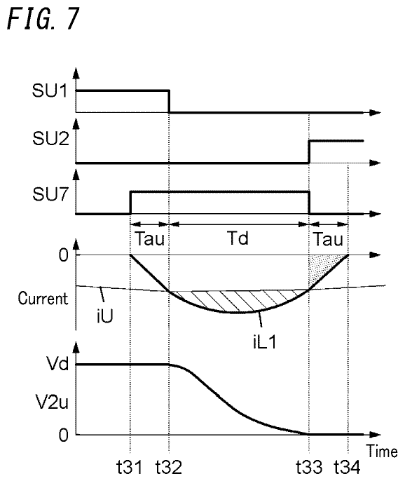

In FIG. 7, the control signals SU1, SU2, SU7, the load current iU, a current iL1 flowing through the resonant inductor L1, and the voltage V2u across the second switching element 2U are shown as for a situation where the target second switching element 2 is the second switching element 2U of the switching circuit 10U.

Furthermore, the dead time period Td that the controller 50 sets to prevent the first switching element 1 and the second switching element 2 of the same phase from turning ON simultaneously is also shown in FIG. 7. Besides, an additional time Tau set by the controller 50 with respect to the control signal SU7 for the second IGBT 7U of the switch 8U is also shown in FIG. 7. The end time of the high-level period of the control signal SU7 may be simultaneous with, or later than, the end time t33 of the dead time period Td. In the example shown in FIG. 7, the end time of the high-level period of the control signal SU7 is set to be simultaneous with the end time t33 of the dead time period Td. The controller 50 sets the high-level period of the control signal SU7 at Tau+Td. In the switching circuit 10U, the voltage V2u across the second switching element 2U goes zero at the end time t33 of the dead time period Td. In the example shown in FIG. 7, the current iL1 starts flowing through the resonant inductor L1 at the beginning time t31 of the high-level period of the control signal SU7 and goes zero at a time t34 when the additional time Tau has passed since the end time t33 of the dead time period Td. As for the current iL1, the current iL1 satisfies iL1≤iU from the beginning time t32 of the dead time period Td, and therefore, LC resonance is produced to cause a resonant current (i.e., a discharging current from the resonant capacitor 9U) to flow from the resonant capacitor 9U toward the resonant inductor L1. From the end time t33 of the dead time period Td and on, the current iL1 will be regenerated to the power converter circuit 11 via the fourth diode 14 directly connected to the resonant inductor L1.

To start producing the LC resonance at the beginning time t32 of the dead time period Td and end a resonant half cycle at the end time t33 of the dead time period Td, the controller 50 determines the additional time Tau based on the load current iU such that iL1=iU is satisfied at the beginning time t32 of the dead time period Td. More specifically, using either the detection result of the output current iU by a current sensor or a signal processing value thereof, or an estimated value of the load current iU, the inductance L of the resonant inductor L1 that has been stored in advance, and the detection result of the voltage V15 at the regenerative capacitor 15, for example, the controller 50 determines the additional time Tau by the equation: Tau=|iU|×(L/V15). In this case, as the load current value (i.e., the detection result of the load current iU or the signal processing value thereof), either a detection value at a carrier cycle at which the additional time Tau is added or a detection value at a timing closest to the carrier cycle may be used. Also, in this case, as the estimated value of the load current iU, a value of the load current iU estimated at the carrier cycle at which the additional time Tau is added may be used, for example. The resonant half cycle in the case of the basic operation is one half of a resonant cycle, which is the reciprocal of the resonant frequency of a resonant circuit including the resonant inductor L1 and one resonant capacitor 9. Thus, if the inductance of the resonant inductor L1 is L and the capacitance of the resonant capacitor 9 is C, then the resonant half cycle is π×(L·C)^{1/2}. The controller 50 sets the resonant half cycle in the case of the basic operation to make the resonant half cycle as long as the length of the dead time period Td, for example.

### (3.1.4) Operation of Soft-Switching First Switching Element When Load Current <0

If the polarity of the load current (which is the load current iU, the load current iV, or the load current iW) flowing through the AC terminal 41 connected to the target first switching element 1 is negative, then the controller 50 compares the current value of the load current with a second current threshold value I2 (=−Ith, refer to FIG. 5). If the current value of the load current is less than the second current threshold value I2, the controller 50 does not turn the switch 8 ON according to an exemplary operation design of the controller 50. On the other hand, if the current value of the load current is greater than the second current threshold value I2, the controller 50 turns the switch 8 ON in the dead time period Td. In this case, the resonant half cycle is supposed to be set to be, for example, as long as the length of the dead time period Td as in the (3.1.1) section. In the power converter 100, if the current value of the load current is less than the second current threshold value I2, the controller 50 may charge, using the load current, the resonant capacitor 9U connected to the target first switching element 1 in series without turning ON the switch 8 corresponding to the target first switching element 1. This allows the power converter 100 to make zero-voltage soft switching of the target first switching element 1.

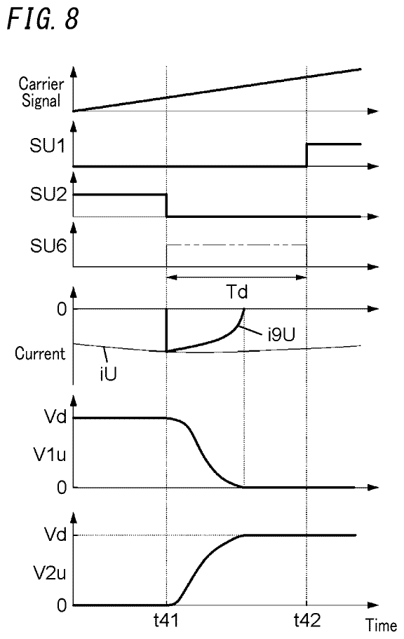

In FIG. 8, the control signals SU1, SU2, SU6, the load current iU, a current i9U flowing from the resonant capacitor 9U, and the voltage V2u across the second switching element 2U are shown as for a situation where the target first switching element 1 is the first switching element 1U of the switching circuit 10U and the current value of the load current is greater than the second current threshold value I2 (in other words, a situation where the absolute value of the current value of the load current is less than the absolute value of the second current threshold value I2). In addition, the dead time period Td is also shown in FIG. 8.

If the current value of the load current is less than the second current threshold value I2 (in other words, if the absolute value of the load current is greater than the absolute value of the second current threshold value I2), the controller 50 does not provide any high-level period for the control signal SU6. In that case, in the power converter 100, a current i9U starts flowing through the resonant capacitor 9U at the beginning time t41 of the dead time period Td. As a result, in the power converter 100, the resonant capacitor 9U is charged with electricity to cause an increase in the voltage V2u across the second switching element 2U. The current i9U goes zero before the end time t23 of the dead time period Td, and the voltage V1u across the first switching element 1U goes zero before the end time t42 of the dead time period Td. Thus, in the power converter 100, when the control signal SU1 changes from low level to high level at the end time t42 of the dead time period Td, the first switching element 1 is subjected to zero-voltage soft switching.

If the current value of the load current is greater than the second current threshold value I2 (in other words, if the absolute value of the load current is less than the absolute value of the second current threshold value), then the controller 50 provides a high-level period for the control signal SU6 as indicated by the two-dot chain in FIG. 8, for example. In that case, the beginning time of the high-level period of the control signal SU6 may be simultaneous with, for example, the beginning time t41 of the dead time period Td. Also, the end time of the high-level period of the control signal SU6 is simultaneous with the end time t42 of the dead time period Td. Thus, in the power converter 100, the voltage V1u across the first switching element 1U goes zero before the end time t42 of the dead time period Td. Consequently, in the power converter 100, when the control signal SU1 changes from low level to high level at the end time t42 of the dead time period Td, the first switching element 1 is subjected to zero-voltage soft switching. Also, note that how the way to determine the high-level period of a control signal for the switch 8 changes according to the threshold value of the load current is only an example of ideal design, and therefore, should not be construed as limiting. For example, even if the current value of the load current is less than the second current threshold value I2, the controller 50 may also set the high-level period of the control signal for the switch 8 to turn the switch 8 ON during the dead time period Td. Also, even if the current value of the load current is greater than the second current threshold value I2, the controller 50 does not have to turn the switch 8 ON during the dead time period Td. Alternatively, the controller 50 may set the high-level period of the control signal for the switch 8 to, for example, always keep the switch 8 ON throughout the dead time period Td irrespective of the second current threshold value I2. Still alternatively, the controller 50 may always keep the switch 8 OFF irrespective of the second current threshold value I2. Yet alternatively, the controller 50 may perform some of the operations described in the (3.1.3) section in combination as appropriate. Furthermore, the controller 50 does not have to cause the high-level period of a control signal for the switch 8 to agree with the dead time period Td as in the example described above. For example, the high-level period of the control signal for the switch 8 may be designed according to the designed time of the resonant half cycle to have a length different from the length of the dead time period Td.

### (3.2) First Operation and Second Operation

The controller 50 performs, when determining that resonant currents respectively passing through two or more switches 8 belonging to the plurality of switches 8 be going to flow through the resonant inductor L1 simultaneously, a first operation and a second operation, supposing that the two or more switches 8 include two switches 8 corresponding one to one to two AC terminals 41 causing load currents of the same polarity to flow therethrough which belong to the plurality of AC terminals 41 and one of the two switches 8 is a first switch and the other of the two switches 8 is a second switch. As used herein, the expression “when determining that resonant currents, respectively passing through two or more switches 8 belonging to the plurality of switches 8, be going to flow simultaneously” refers to a situation where it has been presumed in advance that the resonant currents respectively passing through two or more switches 8 would flow simultaneously through the resonant inductor L1.

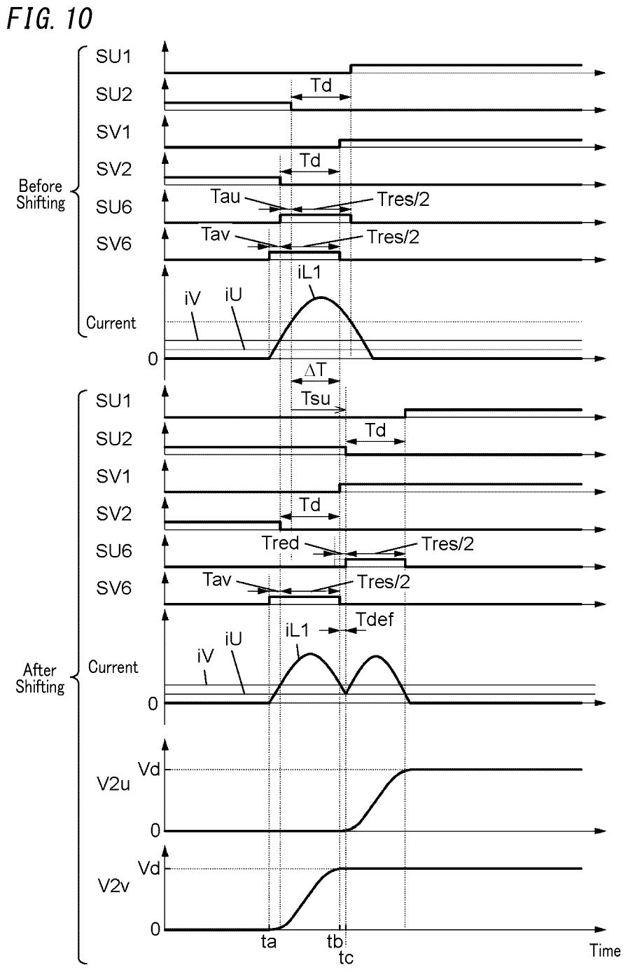

The first operation includes shortening a high-level period of a control signal for the first switch by a shortening period Tred (refer to FIG. 10) from a period including a resonant half cycle and an additional time. The resonant half cycle is determined by the capacitance C of one resonant capacitor 9 corresponding to the first switch which belongs to the plurality of resonant capacitors 9 and the inductance L of the resonant inductor L1. The additional time is determined by a voltage V15 of the regenerative capacitor 15, inductance of the resonant inductor L1, and a load current value. Supposing the resonant cycle of a resonant circuit formed by the inductance L of the resonant inductor L1 and the capacitance C of the resonant capacitor 9 corresponding to the first switch is Tres, Tres=1/{2π(L·C)^{1/2}} and the resonant cycle is Tres/2. Supposing the additional time is Tad and the load current flowing through the AC terminal 41 corresponding to the first switch is i, the additional time Tad is given by Tad=L×i/V15. As for the load current i, if the first switch is the switch 8U, then the load current is the load current iU. If the first switch is the switch 8V, then the load current is the load current iV. If the first switch is the switch 8W, then the load current is the load current iW. As for the additional time Tad, if the first switch is the switch 8U, then the additional time Tad is the additional time Tau. If the first switch is the switch 8V, then the additional time Tad is the additional time Tav. If the first switch is the switch 8W, then the additional time Tad is the additional time Taw.

The second operation includes shifting a high-level period of a control signal for either the first switch or the second switch to cause the high-level period of the control signal for the first switch to begin when a standby period has passed since a point in time when a current value of a resonant current passing through the second switch agreed with a current value of a load current flowing through an AC terminal 41 corresponding to the second switch after the current value of the resonant current passing through the second switch had become equal to an extreme value.

### (3.2.1) Determining Whether Two-Phase Resonant Currents Flow Simultaneously

In the power converter 100, the phases of three-phase (i.e., U-, V-, and W-phase) voltage instructions are different from each other by 120 degrees, but the instruction values of two-phase voltage instructions approach each other every electrical angle of 60 degrees and the duties of two-phase control signals approach each other (refer to regions A1, A2 shown in FIG. 4). Specifically, in the region Al shown in FIG. 4, the duty of the U-phase control signal and the duty of the V-phase control signal become around 0.75. In the region A2 shown in FIG. 4, the duty of the U-phase control signal and the duty of the V-phase control signal become around 0.25. The polarity of the resonant current is the same as the polarity of the current iL1. In the region A1, the polarity of the resonant current is positive. In the region A2, the polarity of the resonant current is negative. In the region A1, the time lag between the beginning time t1 (refer to FIG. 2) of the high-level period of the control signal SU6 to be applied to the first IGBT 6U and the beginning time t5 (refer to FIG. 2) of the high-level period of the control signal SV6 to be applied to the first IGBT 6V becomes so short in one cycle time of the carrier signal, for example, that the U-phase resonant current and the V-phase resonant current may flow simultaneously through the resonant inductor L1. In the power converter 100, the direction of the resonant current in the region A2 is reverse from that of the resonant current in the region Al but the U-phase resonant current and the V-phase resonant current may flow simultaneously through the resonant inductor L1.

Supposing the capacitance of each of the plurality of resonant capacitors 9U, 9U, and 9W is C, if a U-phase current and a V-phase current flow simultaneously through the resonant inductor L1, a capacitor having a combined capacitance (=2×C) of the resonant capacitor 9U and the resonant capacitor 9V is connected to the resonant inductor L1 in series in an equivalent circuit. Thus, in the power converter 100, if two-phase currents flow simultaneously through the resonant inductor L1, then the resonant frequency of a resonant circuit including the resonant inductor L1 changes compared to a situation where a single-phase current flows through the resonant inductor L1. Consequently, the power converter 100 may be unable to make zero-voltage soft switching.

### (3.2.1.1) When Charging Operation is Performed on Resonant Capacitor

FIG. 2 shows an exemplary boundary condition between a situation where the U-phase resonant current and the V-phase resonant current do not overlap with each other (i.e., do not flow simultaneously) and a situation where the U-phase resonant current and the V-phase resonant current overlap with each other (i.e., flow simultaneously). The boundary condition will be described with reference to FIG. 2.

In the power converter 100, if the time lag ΔTuv between the beginning time t3 of the high-level period of the control signal SU1 and the beginning time t7 of the high-level period of the control signal SV1 is equal to or greater than (Tau+Tav+Td), then the U-phase resonant current and the V-phase resonant current do not overlap with each other. On the other hand, if the time lag ΔTuv is less than (Tau+Tav+Td), then the U-phase resonant current and the V-phase resonant current overlap with each other. That is to say, with a threshold value for the time lag ΔTuv set at (Tau+Tav+Td), for example, if the time lag ΔTuv is less than the threshold value, the controller 50 presumes that resonant currents corresponding to the two phases of the switching circuit 10U and the switching circuit 10V belonging to the plurality of switching circuits 10 would flow simultaneously through the resonant inductor L1. Note that this threshold value is only an example, and the threshold value may also be set at any other value. For example, with the error of the additional time Tau and the error of the additional time Tav taken into account, the threshold value may also be set at a value even larger than (Tau+Tav+Td). Alternatively, the threshold value may also be set at Td. In that case, if the time lag ΔTuv is equal to or greater than Td, then the controller 50 determines that the U-phase LC resonant current (i.e., the current in the region indicated by the oblique lines in the resonant inductor current waveform iL1 corresponding to the U-phase in FIG. 2) and the V-phase LC resonant current (i.e., the current in the region indicated by the oblique lines in the resonant inductor current waveform iL1 corresponding to the V-phase in FIG. 2) not be going to overlap with each other in the resonant inductor L1. On the other hand, if the time lag ΔTuv is less than Td, then the controller 50 determines that the U-phase LC resonant current and the V-phase LC resonant current be going to overlap with each other in the resonant inductor L1. Even in that case, the threshold value may also be set at, for example, a value even greater than Td with the error taken into account. In addition, the above-described method for calculating the time lag ΔTuv to determine whether the two-phase resonant currents flow simultaneously is only an example. Rather, any other calculating method may also be adopted as long as a time lag corresponding to the time lag described above may be calculated. For example, as the time lag ΔTuv for use to determine whether the two-phase resonant currents flow simultaneously, a time lag between the end time t2 of the high-level period of the control signal SU2 and the end time t6 of the high-level period of the control signal SV2 may also be used.

In the power converter 100, if the time lag between the beginning time t3 of the high-level period of the control signal SU1 and the beginning time t11 of the high-level period of the control signal SW1 is equal to or greater than (Tau+Taw+Td), then the U-phase resonant current and the W-phase resonant current do not overlap with each other. On the other hand, if the time lag is less than (Tau+Taw+Td), then the U-phase resonant current and the W-phase resonant current overlap with each other. That is to say, with a threshold value for the time lag set at (Tau+Taw+Td), for example, if the time lag is less than the threshold value, the controller 50 presumes that resonant currents corresponding to the two phases of the switching circuit 10U and the switching circuit 10W belonging to the plurality of switching circuits 10 would flow simultaneously through the resonant inductor L1. Note that this threshold value is only an example, and the threshold value may also be set at any other value. For example, with the error of the additional time Tau and the error of the additional time Taw taken into account, the threshold value may also be set at a value even larger than (Tau+Taw+Td). Alternatively, the threshold value may also be set at Td. In that case, if the time lag is equal to or greater than Td, then the controller 50 determines that the U-phase LC resonant current and the W-phase LC resonant current not be going to overlap with each other in the resonant inductor L1. On the other hand, if the time lag is less than Td, then the controller 50 determines that the U-phase LC resonant current and the W-phase LC resonant current be going to overlap with each other in the resonant inductor L1. Even in that case, the threshold value may also be set at, for example, a value even greater than Td with the error taken into account. In addition, the above-described method for calculating the time lag to determine whether the two-phase resonant currents will flow simultaneously is only an example. Rather, any other calculating method may also be adopted as long as a time lag corresponding to the time lag described above may be calculated. For example, as the time lag for use to determine whether the two-phase resonant currents will flow simultaneously, a time lag between the end time t2 of the high-level period of the control signal SU2 and the end time t10 of the high-level period of the control signal SW2 may also be used.

In the power converter 100, if the time lag between the beginning time t7 of the high-level period of the control signal SV1 to be applied to the first switching element 1V of the switching circuit 10V and the beginning time t11 of the high-level period of the control signal SW1 to be applied to the first switching element 1W of the switching circuit 10W is equal to or greater than (Tav+Taw+Td), then the V-phase resonant current and the W-phase resonant current do not overlap with each other. On the other hand, if the time lag is less than (Tav+Taw+Td), then the V-phase resonant current and the W-phase resonant current overlap with each other. That is to say, with a threshold value for the time lag set at (Tav+Taw+Td), for example, if the time lag is less than the threshold value, the controller 50 presumes that resonant currents corresponding to the two phases of the switching circuit 10V and the switching circuit 10W belonging to the plurality of switching circuits 10 would flow simultaneously through the resonant inductor L1. Note that this threshold value is only an example, and the threshold value may also be set at any other value. For example, with the error of the additional time Tav and the error of the additional time Taw taken into account, the threshold value may also be set at a value even larger than (Tav+Taw+Td). Alternatively, the threshold value may also be set at Td. In that case, if the time lag is equal to or greater than Td, then the controller 50 determines that the V-phase LC resonant current and the W-phase LC resonant current not be going to overlap with each other in the resonant inductor L1. On the other hand, if the time lag is less than Td, then the controller 50 determines that the U-phase LC resonant current and the W-phase LC resonant current be going to overlap with each other in the resonant inductor L1. Even in that case, the threshold value may also be set at, for example, a value even greater than Td with the error taken into account. In addition, the above-described method for calculating the time lag to determine whether the two-phase resonant currents will flow simultaneously is only an example. Rather, any other calculating method may also be adopted as long as a time lag corresponding to the time lag described above may be calculated. For example, as the time lag for use to determine whether the two-phase resonant currents will flow simultaneously, a time lag between the end time t6 of the high-level period of the control signal SV2 and the end time t10 of the high-level period of the control signal SW2 may also be used. In this case, the controller 50 sets the resonant half cycle for the basic operation as long a cycle as the dead time period Td, for example. Thus, in the exemplary setting for the threshold value (i.e., Tau+Tav+Td, Tau+Taw+Td, Tav+Taw+Td, or Td) described above, Td means the resonant half cycle. Unless the length of the dead time period Td is set to be as long as the resonant half cycle, the length of the dead time period Td is set to be replaced with the length of the resonant half cycle which is set at Td in the exemplary setting for the threshold value described above. The same statement applies to the discharging operation on the resonant capacitor that will be described in the next section.

### (3.2.1.2) When Discharging Operation is Performed on Resonant Capacitor

When performing a discharging operation on the resonant capacitor 9, the controller 50 may also determine, using the same time lag and threshold value as in the case of performing the charging operation on the resonant capacitor 9, whether two-phase resonant currents will flow simultaneously.

For example, if the time lag between the beginning time of the high-level period of the control signal SU2 and the beginning time of the high-level period of the control signal SV2 is less than a threshold value (e.g., Tau+Tav+Td), then the controller 50 presumes that the U-phase resonant current and the V-phase resonant current would overlap with each other. In addition, if the time lag between the beginning time of the high-level period of the control signal SU2 and the beginning time of the high-level period of the control signal SV2 is less than a threshold value (e.g., Td), then the controller 50 presumes that the U-phase LC resonant current and the V-phase LC resonant current would overlap with each other.

Also, if the time lag between the beginning time of the high-level period of the control signal SU2 and the beginning time of the high-level period of the control signal SW2 is less than a threshold value (e.g., Tau+Taw+Td), then the controller 50 presumes that the U-phase resonant current and the W-phase resonant current would overlap with each other. In addition, if the time lag between the beginning time of the high-level period of the control signal SU2 and the beginning time of the high-level period of the control signal SW2 is less than a threshold value (e.g., Td), then the controller 50 presumes that the U-phase LC resonant current and the W-phase LC resonant current would overlap with each other.

Furthermore, if the time lag between the beginning time of the high-level period of the control signal SV2 and the beginning time of the high-level period of the control signal SW2 is less than a threshold value (e.g., Tav+Taw+Td), then the controller 50 presumes that the V-phase resonant current and the W-phase resonant current would overlap with each other. In addition, if the time lag between the beginning time of the high-level period of the control signal SV2 and the beginning time of the high-level period of the control signal SW2 is less than a threshold value (e.g., Td), then the controller 50 presumes that the V-phase LC resonant current and the W-phase LC resonant current would overlap with each other.

### (3.2.2) First Operation and Second Operation to be Performed When Two-Phase Resonant Currents are Determined to Flow Simultaneously

The controller 50 performs, when determining that resonant currents respectively passing through two switches 8 be going to flow simultaneously through the resonant inductor L1, for example, the first operation and the second operation to shorten the period for which the resonant currents respectively passing through the two switches 8 flow simultaneously through the resonant inductor L1.

The controller 50 performs the first operation and the second operation to prevent the dead time period Td between the high-level period of a control signal to be applied to the first switching element 1 of each of the two switching circuits 10 corresponding to the two switches 8 and the high-level period of a control signal to be applied to the second switching element 2 thereof from changing its length. For example, when shifting the high-level period of the control signal SU6, SU7 to be applied to the switch 8U while performing the second operation, the controller 50 shifts the respective high-level periods of the control signals SU1, SU2 but does not change the duty of any of the control signals SU1, SU2 in one cycle of the carrier signal. Likewise, when shifting the high-level period of the control signal SV6 or SV7 to be applied to the switch 8V, the controller 50 shifts the respective high-level periods of the control signals SV1, SV2 but does not change the duty of any of the control signals SV1, SV2 in one cycle of the carrier signal. In the same way, when shifting the high-level period of the control signal SW6 or SW7 to be applied to the switch 8W, the controller 50 shifts the respective high-level periods of the control signals SW1, SW2 but does not change the duty of any of the control signals SW1, SW2 in one cycle of the carrier signal. In the following description, in a situation where the high-level period of the control signal SU6 or SU7 for the switch 8U is shifted, the amount of time for which the high-level period of the control signal SU6 or SU7 is shifted (hereinafter referred to as a “shifted time”) will be hereinafter designated by Tsu for the sake of convenience of description. Also, in a situation where the high-level period of the control signal SV6 or SV7 for the switch 8V is shifted, the shifted time of the high-level period of the control signal SV6 or SV7 will be hereinafter designated by Tsv for the sake of convenience of description. Furthermore, in a situation where the high-level period of the control signal SW6 or SW7 for the switch 8W is shifted, the shifted time of the high-level period of the control signal SW6 or SW7 will be hereinafter designated by Tws for the sake of convenience of description.

### (3.2.2.1) Operation of Soft-Switching First Switching Element

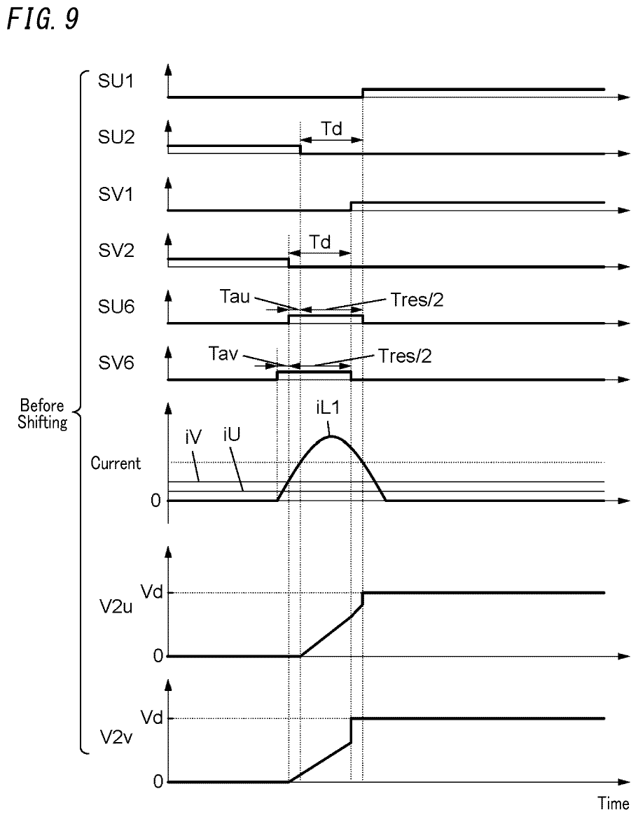

FIG. 9 is a timing chart illustrating, in a situation where the controller 50 has determined in advance that two-phase resonant currents, namely, U- and V-phase resonant currents, be going to flow simultaneously in the period corresponding to the region A1 shown in FIG. 4, the respective waveforms of the control signals SU1, SU2, SV1, SV2, the control signals SU6, SV6, the load currents iU, iV, the current iL1, and the voltages V2u, V2v across the second switching elements 2U, 2V before the first and second operations are performed (which will be hereinafter also referred to as “before shifting”). The upper part of FIG. 10 is a timing chart showing a situation where the controller 50 has determined in advance that two-phase resonant currents, namely, U- and V-phase resonant currents, be going to flow simultaneously in the period corresponding to the region Al shown in FIG. 4. In this case, in the upper part of FIG. 10, shown are the respective waveforms of the control signals SU1, SU2, SV1, SV2, the control signals SU6, SV6, the load currents iU, iV, and the current iL1 before shifting. On the other hand, the lower part of FIG. 10 is a timing chart showing a situation where the controller 50 has performed both the first operation and the second operation (which will be hereinafter referred to as “after shifting”) in the period corresponding to the region A1 shown in FIG. 4. In this case, the lower part of FIG. 10 is a timing chart showing the respective waveforms of the control signals SU1, SU2, SV1, SV2, the control signals SU6, SV6, the load currents iU, iV, the current iL1, and the voltages V2u, V2v across the second switching elements 2U, 2V after shifting. In the example shown in FIG. 10, the polarity of the load currents iU, iV flowing through the two AC terminals 41U, 41V respectively connected to the two switches 8U, 8V is positive and the absolute value of the load current iV is greater than the absolute value of the load current iU. Note that the timing chart shown in FIGS. 9 and 10 shows the waveforms in only a partial period of one cycle of the carrier signal.

In the example shown in FIG. 10, the controller 50 compares, when performing the first operation, the absolute values of the load currents iU, iV with each other, thereby shortening, by the shortening period Tred, the high-level period of the control signal SU6 to be applied to the switch 8U corresponding to one of the two AC terminals 41U, 41V through which a load current with the smaller absolute value flows. In the example shown in FIG. 10, the controller 50 sets the length of the shortening period Tred to make the high-level period of the control signal SU6 as long as the resonant half cycle (=Tres/2). Therefore, in the example shown in FIG. 10, the shortening period Tred is as long as the additional time Tau.

In addition, the controller 50 shifts, when performing the second operation, the high-level period of the control signal SU6 by the shifted time Tsu in such a direction as to postpone the high-level period of the control signal SU6. In this case, the controller 50 shifts each of the high-level period of the control signal SU6 for the switch 8U, the high-level period of the control signal SU1 for the first switching element 1U, and the high-level period of the control signal SU2 for the second switching element 2 by the shifted time Tsu in such a direction as to postpone each of these high-level periods to cause, if the high-level period of a control signal SV6 for the switch 8V begins at a point in time ta, the high-level period of the control signal SU6 for the switch 8U to begin at a point in time tc when a standby period Tdef has passed since a point in time tb when a current value of a resonant current (current iL1) passing through the switch 8V agreed with a current value of a load current iV flowing through an AC terminal 41V corresponding to the switch 8V after the current value of the resonant current (current iL1) passing through the switch 8V had become equal to an extreme value (a maximum value in the example shown in FIG. 10). The absolute value of the resonant current (current iL1) at the point in time tb is greater than the absolute value of the load current iU flowing through the AC terminal 41U corresponding to the switch 8U. The controller 50 determines the standby period Tdef by the equation: Tdef=L×(iV−iU)/V15. The controller 50 determines the shifted time Tsu by the equation: Tsu=ΔT+Tdef. In the example shown in FIG. 10, ΔT is the time lag between the beginning time of the high-level period of the control signal SV1 for the first switching element 1V corresponding to the switch 8V and the end time of the high-level period of the control signal SU2 for the second switching element 2U corresponding to the switch 8U. This makes the current value of the resonant current (current iL1) at the point in time tc when the standby period Tdef ends equal to the absolute value of the load current iU. This allows, even if the high-level period of the control signal SU6 for the switch 8U does not include the additional time Tau but is as long as the resonant half cycle (Tres/2), the power converter 100 to make zero-voltage soft switching of the first switching element 1U.

As can be seen from the waveform of the current iL1 shown in the upper part of FIG. 10 and the waveform of the current iL1 shown in the lower part of FIG. 10, when the controller 50 has determined in advance that two-phase resonant currents, namely, the U- and V-phase resonant currents, be going to flow simultaneously, the controller 50 performs the first operation and the second operation, thus allowing the power converter 100 to shorten the period in which the U-phase resonant current and the V-phase resonant current overlap with each other. In the same way, when the controller 50 has determined in advance that two-phase resonant currents, namely, the U- and W-phase resonant currents, be going to flow simultaneously, the controller 50 performs the first operation and the second operation, thus allowing the power converter 100 to shorten the period in which the U-phase resonant current and the W-phase resonant current overlap with each other. In the same way, when the controller 50 has determined in advance that two-phase resonant currents, namely, the V- and W-phase resonant currents, be going to flow simultaneously, the controller 50 performs the first operation and the second operation, thus allowing the power converter 100 to shorten the period in which the V-phase resonant current and the W-phase resonant current overlap with each other.

In the power converter 100, if the controller 50 does not perform the first operation or the second operation, the voltages V2u, V2v across the second switching elements 2U, 2V do not rise to Vd at a point in time when the control signals SU1, SV1 make a transition from a low-level period to a high-level period (i.e., the end time of the dead time period Td corresponding to each of U- and V-phases) as shown in FIG. 9. That is to say, if the controller 50 does not perform the first operation or the second operation, the resonant capacitors 9U, 9V have not been charged with electricity yet at the end time of the dead time period Td corresponding to each of U- and V-phases. Therefore, if the controller 50 does not perform the first operation or the second operation, then none of the voltages across the first switching elements 1U, 1V decreases to zero at the end time of the dead time period Td corresponding to each of U- and V-phases. Consequently, in the power converter 100, the first switching elements 1U, 1V are hard-switched.

On the other hand, if the controller 50 has performed the first operation and the second operation, the voltages V2u, V2v across the second switching elements 2U, 2V rise to Vd at a point in time when the control signals SU1, SV1 make a transition from a low-level period to a high-level period (i.e., the end time of the dead time period Td corresponding to each of U- and V-phases) as shown in the lower part of FIG. 10. That is to say, if the controller 50 has performed the first operation and the second operation, then the resonant capacitors 9U, 9V have already been charged with electricity at the end time of the dead time period Td corresponding to each of U- and V-phases. Therefore, in the power converter 100, if the controller 50 has performed the first operation and the second operation, the first switching elements 1U, 1V are switched by zero-voltage soft switching.

FIG. 10, which has been referred to above, illustrates how the first operation and the second operation may be performed in a situation where the controller 50 has determined in advance that a U-phase resonant current and a V-phase resonant current be going to flow simultaneously through the resonant inductor L1. However, this is only an example and should not be construed as limiting. For example, even if the controller 50 has determined in advance that a V-phase resonant current and a W-phase resonant current, for example, be going to flow simultaneously through the resonant inductor L1 and even if the controller 50 has determined in advance that a W-phase resonant current and a U-phase resonant current, for example, be going to flow simultaneously through the resonant inductor L1, zero-voltage soft switching may also be made by making the controller 50 perform the first operation and the second operation.

The first operation and second operation to be performed by the controller 50 in the case of the charging operation may be generalized as follows.

When performing the first operation, the controller 50 shortens, by the shortening period Tred, the high-level period of a control signal for the first switch corresponding to a load current with the greater absolute value, out of the first and second switches. On the other hand, when performing the second operation, the controller 50 shifts, by the shifted time, the high-level period of a control signal for the first switch in such a direction as to postpone the high-level period of the control signal. In this case, the controller 50 shifts the high-level period of the control signal for the first switch to cause, if the high-level period of a control signal for the second switch begins at a point in time ta, the high-level period of the control signal for the first switch to begin at a point in time tc when a standby period Tdef has passed since a point in time tb when a current value of a resonant current (current iL1) passing through the second switch agreed with a current value of a load current flowing through an AC terminal 41 corresponding to the second switch after the current value of the resonant current (current iL1) passing through the second switch had become equal to an extreme value. The absolute value of the resonant current (current iL1) at the point in time tb is greater than the absolute value of the load current flowing through the AC terminal 41 corresponding to the first switch. Setting the length of the standby period Tdef as long as the length of the additional time Tad of the control signal for the first switch makes the current value of the resonant current (current iL1) at the point in time tc equal to the absolute value of the load current flowing through the AC terminal 41 corresponding to the first switch.

### (3.2.2.2) Operation of Soft-Switching Second Switching Element

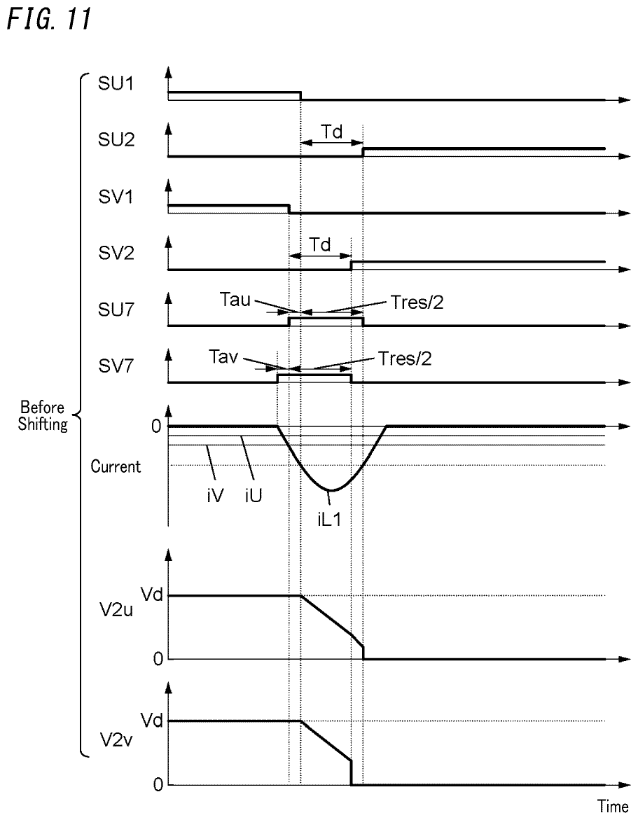

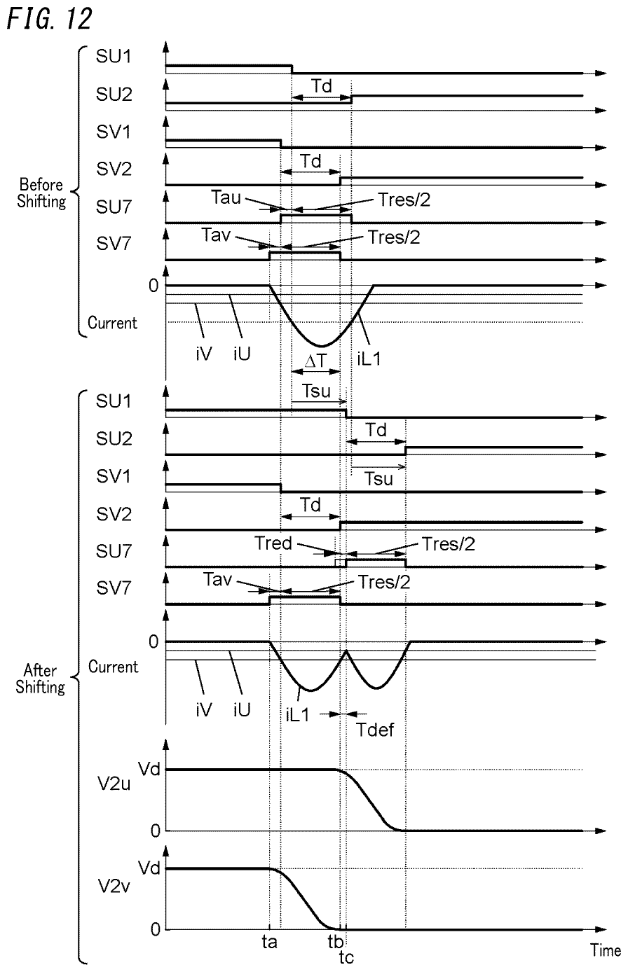

FIG. 11 is a timing chart illustrating, in a situation where the controller 50 has determined in advance that two-phase resonant currents, namely, U- and V-phase resonant currents, be going to flow simultaneously in the period corresponding to the region A2 shown in FIG. 4, the respective waveforms of the control signals SU1, SU2, SV1, SV2, the control signals SU7, SV7, the load currents iU, iV, the current iL1, and the voltages V2u, V2v across the second switching elements 2U, 2V before the first and second operations are performed (which will be hereinafter also referred to as “before shifting”). The upper part of FIG. 12 is a timing chart showing a situation where the controller 50 has determined in advance that two-phase resonant currents, namely, U- and V-phase resonant currents, be going to flow simultaneously in the period corresponding to the region A2 shown in FIG. 4. In this case, the upper part of FIG. 12 is a timing chart showing the respective waveforms of the control signals SU1, SU2, SV1, SV2, the control signals SU7, SV7, the load currents iU, iV, and the current iL1 before shifting. On the other hand, the lower part of FIG. 12 is a timing chart showing a situation where the controller 50 has performed both the first operation and the second operation (which will be hereinafter referred to as “after shifting”) in the period corresponding to the region A2 shown in FIG. 4. In this case, the lower part of FIG. 12 is a timing chart showing the respective waveforms of the control signals SU1, SU2, SV1, SV2, the control signals SU7, SV7, the load currents iU, iV, the current iL1, and the voltages V2u, V2v across the second switching elements 2U, 2V after shifting. In the example shown in FIG. 12, the polarity of the load currents iU, iV flowing through the two AC terminals 41U, 41V respectively connected to the two switches 8U, 8V is negative and the absolute value of the load current iV is greater than the absolute value of the load current iU.

In the example shown in FIG. 12, the controller 50 compares, when performing the first operation, the absolute values of the load currents iU, iV with each other, thereby shortening, by the shortening period Tred, the high-level period of the control signal SU7 to be applied to the switch 8U corresponding to one of the two AC terminals 41U, 41V through which a load current with the larger absolute value flows. In the example shown in FIG. 12, the controller 50 sets the length of the shortening period Tred to make the high-level period of the control signal SU7 as long as the resonant half cycle (=Tres/2). Therefore, in the example shown in FIG. 12, the shortening period Tred is as long as the additional time Tau.

In addition, the controller 50 shifts, when performing the second operation, the high-level period of the control signal SU7 by the shifted time Tsu in such a direction as to postpone the high-level period of the control signal SU7. In this case, the controller 50 shifts each of the high-level period of the control signal SU7 for the switch 8U, the high-level period of the control signal SU1 for the first switching element 1U, and the high-level period of the control signal SU2 for the second switching element 2 by the shifted time Tsu in such a direction as to postpone each of these high-level periods to cause, if the high-level period of a control signal SV7 for the switch 8V begins at a point in time ta, the high-level period of the control signal SU7 for the switch 8U to begin at a point in time tc when a standby period Tdef has passed since a point in time tb when a current value of a resonant current (current iL1) passing through the switch 8V agreed with a current value of a load current iV flowing through an AC terminal 41V corresponding to the switch 8V after the current value of the resonant current (current iL1) passing through the switch 8V had become equal to an extreme value (a minimum value in the example shown in FIG. 12). The absolute value of the resonant current (current iL1) at the point in time tb is greater than the absolute value of the load current iU flowing through the AC terminal 41U corresponding to the switch 8U. The controller 50 determines the standby period Tdef by the equation: Tdef=L×|iV−iU|/V15. The controller 50 determines the shifted time Tsu by the equation: Tsu=ΔT+Tdef. In the example shown in FIG. 12, ΔT is the time lag between the beginning time of the high-level period of the control signal SV2 for the second switching element 2V corresponding to the switch 8V and the end time of the high-level period of the control signal SU1 for the first switching element 1U corresponding to the switch 8U. This makes the current value of the resonant current (current iL1) at the point in time tc when the standby period Tdef ends equal to the absolute value of the load current iU. This allows, even if the high-level period of the control signal SU7 for the switch 8U does not include the additional time Tau but is as long as the resonant half cycle (Tres/2), the power converter 100 to make zero-voltage soft switching of the second switching element 2U.

As can be seen from the waveform of the current iL1 shown in the upper part of FIG. 12 and the waveform of the current iL1 shown in the lower part of FIG. 12, when the controller 50 has determined in advance that two-phase resonant currents, namely, the U- and V-phase resonant currents, be going to flow simultaneously, then the controller 50 performs the first operation and the second operation, thus allowing the power converter 100 to shorten the period in which the U-phase resonant current and the V-phase resonant current overlap with each other. In the same way, when the controller 50 has determined in advance that two-phase resonant currents, namely, the U- and W-phase resonant currents, be going to flow simultaneously, the controller 50 performs the first operation and the second operation, thus allowing the power converter 100 to shorten the period in which the U-phase resonant current and the W-phase resonant current overlap with each other. In the same way, when the controller 50 has determined in advance that two-phase resonant currents, namely, the V- and W-phase resonant currents, be going to flow simultaneously, the controller 50 performs the first operation and the second operation, thus allowing the power converter 100 to shorten the period in which the V-phase resonant current and the W-phase resonant current overlap with each other.

In the power converter 100, if the controller 50 does not perform the first operation or the second operation, the voltages V2u, V2v across the second switching elements 2U, 2V do not decrease to zero at a point in time when the control signals SU2, SV2 make a transition from a low-level period to a high-level period (i.e., the end time of the dead time period Td corresponding to each of U- and V-phases) as shown in FIG. 11. That is to say, if the controller 50 does not perform the first operation or the second operation, electricity has not been discharged from the resonant capacitors 9U, 9V yet at the end time of the dead time period Td corresponding to each of U- and V-phases. Therefore, if the controller 50 does not perform the first operation or the second operation, then none of the voltages across the second switching elements 2U, 2V decreases to zero at the end time of the dead time period Td corresponding to each of U- and V-phases. Consequently, in the power converter 100, the second switching elements 2U, 2V are hard-switched.

On the other hand, if the controller 50 has performed the first operation and the second operation, the voltages V2u, V2v across the second switching elements 2U, 2V decrease to zero at a point in time when the control signals SU2, SV2 make a transition from a low-level period to a high-level period (i.e., the end time of the dead time period Td corresponding to each of U- and V-phases) as shown in the lower part of FIG. 12. That is to say, if the controller 50 has performed the first operation and the second operation, then electricity has already been discharged from the resonant capacitors 9U, 9V at the end time of the dead time period Td corresponding to each of U- and V-phases. Therefore, in the power converter 100, if the controller 50 has performed the first operation and the second operation, the second switching elements 2U, 2V are switched by zero-voltage soft switching.

FIG. 12, which has been referred to above, illustrates how the first operation and the second operation may be performed in a situation where the controller 50 has determined in advance that a U-phase resonant current and a V-phase resonant current be going to flow simultaneously through the resonant inductor L1. However, this is only an example and should not be construed as limiting. For example, even if the controller 50 has determined in advance that a V-phase resonant current and a W-phase resonant current be going to flow simultaneously through the resonant inductor L1 and even if the controller 50 has determined in advance that a W-phase resonant current and a U-phase resonant current be going to flow simultaneously through the resonant inductor L1, zero-voltage soft switching may also be made by making the controller 50 perform the first operation and the second operation.

The first operation and second operation to be performed by the controller 50 in the case of the discharging operation may be generalized as follows.

When performing the first operation, the controller 50 shortens, by the shortening period Tred, the high-level period of a control signal for the first switch corresponding to a load current with the greater absolute value, out of the first and second switches. On the other hand, when performing the second operation, the controller 50 shifts, by the shifted time, the high-level period of a control signal for the first switch in such a direction as to postpone the high-level period. In this case, the controller 50 shifts the high-level period of the control signal for the first switch to cause, if the high-level period of a control signal for the second switch begins at a point in time ta, the high-level period of the control signal for the first switch to begin at a point in time tc when a standby period Tdef has passed since a point in time tb when a current value of a resonant current (current iL1) passing through the second switch agreed with a current value of a load current flowing through an AC terminal 41 corresponding to the second switch after the current value of the resonant current (current iL1) passing through the second switch had become equal to an extreme value. The absolute value of the resonant current (current iL1) at the point in time tb is greater than the absolute value of the load current flowing through the AC terminal 41 corresponding to the first switch. Setting the length of the standby period Tdef as long as the length of the additional time Tad of the control signal for the first switch makes the current value of the resonant current (current iL1) at the point in time tc equal to the absolute value of the load current flowing through the AC terminal 41 corresponding to the first switch.

### (4) Recapitulation

In the power converter 100 according to the first embodiment, the controller 50 performs, when determining that resonant currents respectively passing through two switches 8 belonging to the plurality of switches 8 be going to flow through the resonant inductor L1 simultaneously, a first operation and further performs a second operation. Supposing one of the two switches 8 is a first switch and the other of the two switches 8 is a second switch, the first operation includes shortening a high-level period of a control signal for the first switch by a shortening period Tred from a period including a resonant half cycle (Tred/2) and an additional time Tad. The resonant half cycle (Tred/2) is determined by the capacitance C of one resonant capacitor 9 corresponding to the first switch which belongs to the plurality of resonant capacitors 9 and the inductance L of the resonant inductor L1. The additional time Tad is determined by a voltage V15 of the regenerative capacitor 15, inductance L of the resonant inductor L1, and a load current value. The second operation includes shifting a high-level period of a control signal for the first switch to cause the high-level period of the control signal for the first switch to begin when a standby period Tdef has passed since a point in time when a current value of a resonant current passing through the second switch agreed with a current value of a load current flowing through an AC terminal 41 corresponding to the second switch after the current value of the resonant current passing through the second switch had become equal to an extreme value. This allows the power converter 100 to make soft switching with more reliability.

In the power converter 100, the shortening period Tred may be equal to or shorter than the additional time Tad. This allows the power converter 100 to make soft switching even if the length of the shortening period Tred varies.

Also, in the power converter 100, when performing the second operation, the controller 50 shifts either the high-level period of the control signal for the first switch or the high-level period of the control signal for the second switch. This allows a variation in line voltage to be reduced. Optionally, the controller 50 may also be configured to shift the high-level period of a control signal for the first switch and shift the high-level period of a control signal for the second switch either alternately or at an arbitrary ratio. This allows the power converter 100 to reduce the bias of a variation in the ripple of the line voltage. Furthermore, the power converter 100 may also have periods in which a resonant current flows through the resonant inductor L1 to be distributed, thus allowing for reducing thermal load on the resonant inductor L1.

### First Variation of First Embodiment

A power converter 100 according to a first variation of the first embodiment has the same circuit configuration as the power converter 100 according to the first embodiment (refer to FIG. 1) described above, and therefore, illustration and description thereof will be omitted herein.

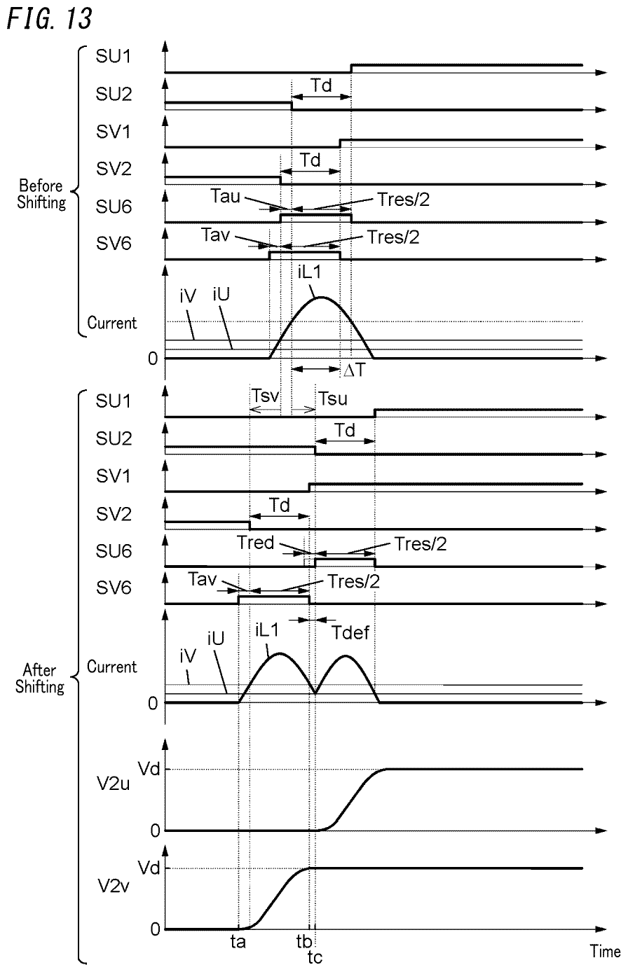

Now, it will be described with reference to FIG. 13 how the power converter 100 according to the first variation performs the operation of soft-switching the first switching elements 1. FIG. 13 may be interpreted in the same way as in FIG. 10, and therefore, description thereof will be omitted herein.

In the example shown in FIG. 13, the controller 50 compares, when performing the first operation, the absolute values of the load currents iU, iV with each other, thereby shortening, by the shortening period Tred, the high-level period of the control signal SU6 to be applied to the switch 8U corresponding to one of the two AC terminals 41U, 41V through which a load current with the smaller absolute value flows. In the example shown in FIG. 13, the controller 50 sets the length of the shortening period Tred to make the high-level period of the control signal SU6 as long as the resonant half cycle (=Tres/2). Therefore, in the example shown in FIG. 13, the shortening period Tred is as long as the additional time Tau.

In addition, the controller 50 shifts, when performing the second operation, the high-level periods of the control signals SU6, SU7 in mutually opposite directions. More specifically, the controller 50 shifts the high-level period of the control signal SU6 by the shifted time Tsu in such a direction as to postpone the high-level period of the control signal SU6 and also shifts the high-level period of the control signal SV6 by the shifted time Tsv in such a direction as to advance the high-level period of the control signal SV6. In this case, the controller 50 shifts each of the respective high-level periods of the control signals SU6, SU1, SU2 by the shifted time Tsu in such a direction as to postpone each of these high-level periods and also shifts each of the respective high-level periods of the control signals SV6, SV1, SV2 by the shifted time Tsv in such a direction as to advance their high-level period to cause, if the high-level period of a control signal SV6 for the switch 8V begins at a point in time ta, the high-level period of the control signal SU6 for the switch 8U to begin at a point in time tc when a standby period Tdef has passed since a point in time tb when a current value of a resonant current (current iL1) passing through the switch 8V agreed with a current value of a load current iV flowing through an AC terminal 41V corresponding to the switch 8V after the current value of the resonant current (current iL1) passing through the switch 8V had become equal to an extreme value (a maximum value in the example shown in FIG. 13). The absolute value of the resonant current (current iL1) at the point in time tb is greater than the absolute value of the load current iU flowing through the AC terminal 41U corresponding to the switch 8U. The controller 50 determines the standby period Tdef by the equation: Tdef=L×(iV−iU)/V15. The controller 50 determines the shifted time Tsu by the equation: Tsu=(ΔT+Tdef)/2 and determines the shifted time Tsv by the equation: Tsv=(ΔT+Tdef)/2. The ratio of the shifted time Tsu to the shifted time Tsv does not have to be one to one but may also be any arbitrary ratio. For example, the controller 50 may determine the shifted time Tsu by the equation Tsu=(ΔT+Tdef)×0.4 and may determine the shifted time Tsv by the equation Tsv=(ΔT+Tdef)×0.6. In the example shown in FIG. 13, ΔT is the time lag between the beginning time of the high-level period of the control signal SV1 for the first switching element 1V corresponding to the switch 8V and the end time of the high-level period of the control signal SU2 for the second switching element 2U corresponding to the switch 8U. This makes the current value of the resonant current (current iL1) at the point in time tc when the standby period Tdef ends equal to the absolute value of the load current iU. This allows, even if the high-level period of the control signal SU6 for the switch 8U does not include the additional time Tau but is as long as the resonant half cycle (Tres/2), the power converter 100 to make zero-voltage soft switching of the first switching element 1U.

As can be seen from the waveform of the current iL1 shown in the upper part of FIG. 13 and the waveform of the current iL1 shown in the lower part of FIG. 13, when the controller 50 has determined in advance that two-phase resonant currents, namely, the U- and V-phase resonant currents, be going to flow simultaneously, the controller 50 performs the first operation and the second operation, thus allowing the power converter 100 to shorten the period in which the U-phase resonant current and the V-phase resonant current overlap with each other. In the same way, when the controller 50 has determined in advance that two-phase resonant currents, namely, the U- and W-phase resonant currents, be going to flow simultaneously, the controller 50 performs the first operation and the second operation, thus allowing the power converter 100 to shorten the period in which the U-phase resonant current and the W-phase resonant current overlap with each other. In the same way, when the controller 50 has determined in advance that two-phase resonant currents, namely, the V- and W-phase resonant currents, be going to flow simultaneously, the controller 50 performs the first operation and the second operation, thus allowing the power converter 100 to shorten the period in which the V-phase resonant current and the W-phase resonant current overlap with each other.

In the power converter 100 according to the first variation, if the controller 50 does not perform the first operation or the second operation, the voltages V2u, V2v across the second switching elements 2U, 2V do not rise to Vd as in the first embodiment at a point in time when the control signals SU1, SV1 make a transition from a low-level period to a high-level period (i.e., the end time of the dead time period Td corresponding to each of U- and V-phases) as shown in FIG. 9. That is to say, if the controller 50 does not perform the first operation or the second operation, the resonant capacitors 9U, 9V have not been charged with electricity yet at the end time of the dead time period Td corresponding to each of U- and V-phases. Therefore, if the controller 50 does not perform the first operation or the second operation, then none of the voltages across the first switching elements 1U, 1V decreases to zero at the end time of the dead time period Td corresponding to each of U- and V-phases. Consequently, in the power converter 100, the first switching elements 1U, 1V are hard-switched.

On the other hand, if the controller 50 has performed the first operation and the second operation, the voltages V2u, V2v across the second switching elements 2U, 2V rise to Vd at a point in time when the control signals SU1, SV1 make a transition from a low-level period to a high-level period (i.e., the end time of the dead time period Td corresponding to each of U- and V-phases) as shown in the lower part of FIG. 13. That is to say, if the controller 50 has performed the first operation and the second operation, then the resonant capacitors 9U, 9V have already been charged with electricity at the end time of the dead time period Td corresponding to each of U- and V-phases. Therefore, in the power converter 100, if the controller 50 has performed the first operation and the second operation, the first switching elements 1U, 1V are switched by zero-voltage soft switching.

FIG. 13 illustrates how the first operation and the second operation may be performed in a situation where the controller 50 has determined in advance that a U-phase resonant current and a V-phase resonant current be going to flow simultaneously through the resonant inductor L1. However, this is only an example and should not be construed as limiting. For example, even if the controller 50 has determined in advance that a V-phase resonant current and a W-phase resonant current be going to flow simultaneously through the resonant inductor L1 and even if the controller 50 has determined in advance that a W-phase resonant current and a U-phase resonant current be going to flow simultaneously through the resonant inductor L1, the first switching element may also be subjected to zero-voltage soft switching by making the controller 50 perform the first operation and the second operation.

In the case of the operation of soft-switching the second switching element 2, zero-voltage soft switching may also be made by making the controller 50 perform the first operation and the second operation. Even in that case, the controller 50 performs the first operation and the second operation supposing that one of two switches 8 corresponding one to one to two AC terminals 41, through which load currents with the same polarity flow, is regarded as a first switch and the other switch is regarded as a second switch.

The first operation and second operation to be performed by the controller 50 may be generalized as follows.

When performing the first operation, the controller 50 shortens, by the shortening period Tred, the high-level period of a control signal for the first switch corresponding to a load current with the greater absolute value, out of the first and second switches. On the other hand, when performing the second operation, the controller 50 shifts the high-level period of a control signal for the first switch in such a direction as to postpone the high-level period thereof and also shifts the high-level period of a control signal for the second switch in such a direction as to advance the high-level period thereof. In this case, the controller 50 shifts the high-level period of the control signal for the second switch and the high-level period of the control signal for the first switch in mutually opposite directions to cause, if the high-level period of a control signal for the second switch begins at a point in time ta, the high-level period of the control signal for the first switch to begin at a point in time tc when a standby period Tdef has passed since a point in time tb when a current value of a resonant current (current iL1) passing through the second switch agreed with a current value of a load current flowing through an AC terminal 41 corresponding to the second switch after the current value of the resonant current (current iL1) passing through the second switch had become equal to an extreme value. The absolute value of the resonant current (current iL1) at the point in time tb is greater than the absolute value of the load current flowing through the AC terminal 41 corresponding to the first switch. Setting the length of the standby period Tdef as long as the length of the additional time Tad of the control signal for the first switch makes the current value of the resonant current (current iL1) at the point in time tc equal to the absolute value of the load current flowing through the AC terminal 41 corresponding to the first switch. This allows the power converter 100 to make soft switching with more reliability.

Furthermore, in the power converter 100 according to the first variation, when performing the first operation and the second operation, the controller 50 shortens the high-level period of one of the two control signals for the two switches 8 and shifts the respective high-level periods of the control signals for the two switches 8 in mutually different directions. This allows the power converter 100 according to the first variation to contribute to increasing the operating frequency and deal with a shorter carrier cycle.

### Second Variation of First Embodiment

A power converter 100 according to a second variation of the first embodiment has the same circuit configuration as the power converter 100 according to the first embodiment (refer to FIG. 1) described above, and therefore, illustration and description thereof will be omitted herein.

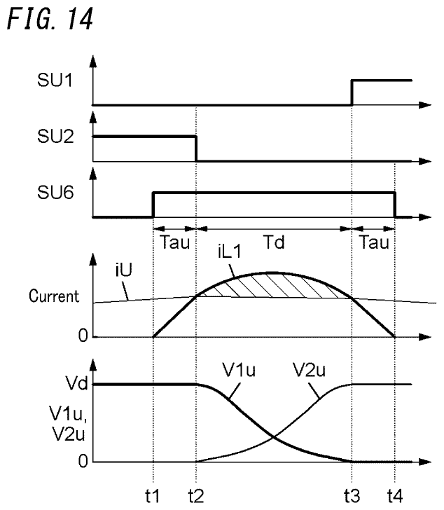

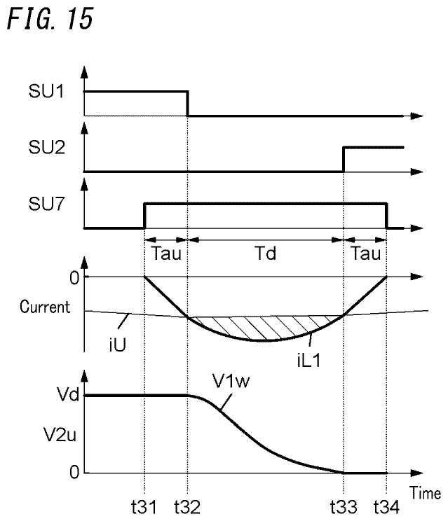

Now it will be described with reference to FIGS. 14 and 15 how the power converter 100 according to the second variation operates.

In the second variation, the controller 50 postpones, by a clamp period (of which the length is as long as the length of the additional time Tau), the end time of the high-level period of the control signal SU6 from the end time t3 of the dead time period Td as shown in FIG. 14. This makes the high-level period of the control signal SU6 longer than in the case shown in FIG. 2. In addition, in the second variation, the controller 50 also postpones, by the clamp period (of which the length is as long as the length of the additional time Tau), the end time of the high-level period of the control signal SU7 from the end time t33 of the dead time period Td as shown in FIG. 15. This makes the high-level period of the control signal SU6 longer than in the case shown in FIG. 7.

In the example shown in FIG. 14, the current iL1 starts flowing through the resonant inductor L1 at the beginning time t1 of the high-level period of the control signal SU6 and goes zero at a point in time t4 when the clamp period (additional time Tau) has passed since the end time t3 of the dead time period Td. As for the current iL1, the current iL1 satisfies iL1≥iU from the beginning time t2 of the dead time period Td, and therefore, the current iL1 in the hatched part of the current waveform shown as the fourth waveform from the top of FIG. 14 flows into the resonant capacitor 9U to produce LC resonance. In the clamp period from the end time t3 of the dead time period Td through the time t4, the current iL1 flows through the path passing through the resonant inductor L1, (the first IGT 6U of) the switch 8U, the AC terminal 41U, and the AC load RA1 in this order.

In the example shown in FIG. 15, the current iL1 starts flowing through the resonant inductor L1 at the beginning time t31 of the high-level period of the control signal SU7 and goes zero at a point in time t34 when the additional time Tau has passed since the end time t33 of the dead time period Td. As for the current iL1, the current iL1 satisfies iL1≤iU from the beginning time t32 of the dead time period Td, and therefore, LC resonance is produced to cause a resonant current (i.e., a discharging current of the resonant capacitor 9U) to flow from the resonant capacitor 9U toward the resonant inductor L1. In the clamp period from the end time t33 of the dead time period Td through the time t34, the current iL1 flows through the path passing through the AC load RA1, (the second IGT 7U of) the switch 8U, and the resonant inductor L1 in this order.

In the second variation, the controller 50 also sets the clamp period (of which the length is as long as the additional time Tav) for the respective high-level periods of the control signals SV6, SV7 and sets the clamp period (of which the length is as long as the additional time Taw) for the respective high-level periods of the control signals SW6, SW7.

The operation of the controller 50 according to the second variation is different from that of the controller 50 according to the first embodiment only in the respect of setting the clamp period.

Thus, in the power converter 100 according to the second variation, as in the power converter 100 according to the first embodiment, the controller 50 also performs, when determining that resonant currents respectively passing through two switches 8 belonging to the plurality of switches 8 be going to flow through the resonant inductor L1 simultaneously, a first operation and further performs a second operation. Supposing one of the two switches 8 is a first switch and the other of the two switches 8 is a second switch, the first operation includes shortening a high-level period of a control signal for the first switch by a shortening period Tred from a period including a resonant half cycle (Tred/2) and an additional time Tad. The resonant half cycle (Tred/2) is determined by one resonant capacitor 9 corresponding to the first switch which belongs to the plurality of resonant capacitors 9 and the resonant inductor L1. The additional time Tad is determined by a voltage V15 of the regenerative capacitor 15 and inductance L of the resonant inductor L1. The second operation includes shifting a high-level period of a control signal for the first switch to cause the high-level period of the control signal for the first switch to begin when a standby period Tdef has passed since a point in time when a current value of a resonant current passing through the second switch agreed with a current value of a load current flowing through an AC terminal 41 corresponding to the second switch after the current value of the resonant current passing through the second switch had become equal to an extreme value. This allows the power converter 100 according to the second variation to make soft switching with more reliability, as well as the power converter 100 according to the first embodiment.

### Second Embodiment

A power converter 100 according to a second embodiment has the same circuit configuration as the power converter 100 according to the first embodiment (refer to FIG. 1) described above, and therefore, illustration and description thereof will be omitted herein.

In the power converter 100 according to the second embodiment, the controller 50 performs, in both the operation of soft-switching the first switching element 1 and the operation of soft switching the second switching element 2, the first operation and the second operation when determining that three-phase resonant currents be going to overlap with each other, which is a difference from the power converter 100 according to the first embodiment.

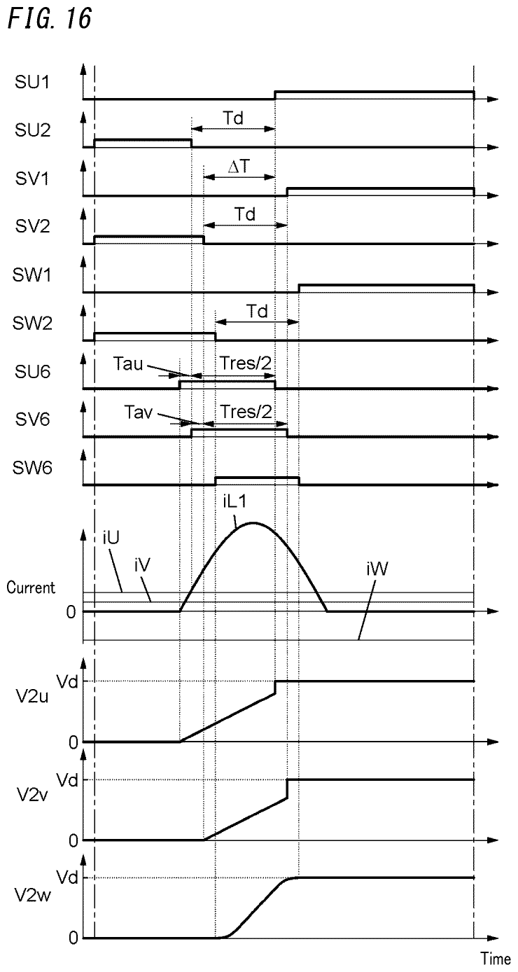

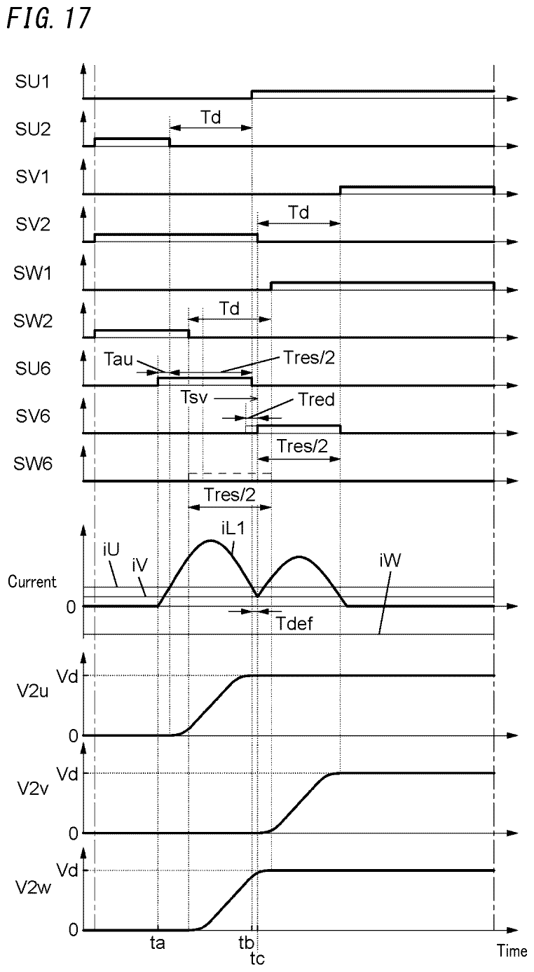

Now it will be described with reference to FIGS. 16 and 17 how the controller 50 performs the operation of soft-switching the first switching element 1 when determining that resonant currents respectively passing through three switches 8 belonging to the plurality of switches 8 be going to flow simultaneously through the resonant inductor L1.

When determining that the resonant currents respectively passing through three switches 8 belonging to the plurality of switches 8 be going to flow simultaneously through the resonant inductor L1, the controller 50 not only performs the first operation and the second operation on at least one of the first switch or the second switch but also stops the operation of a switch 8 corresponding to an AC terminal 41 of one phase, through which a load current of a different polarity flows. That is to say, the controller 50 reduces the high-level period of the control signal to zero within one carrier cycle. As used herein, the expression “when determining that the resonant currents respectively passing through three switches 8 belonging to the plurality of switches 8 be going to flow simultaneously” refers to a situation where it has been presumed in advance that the resonant currents respectively passing through the three switches 8 would flow simultaneously through the resonant inductor L1. The controller 50 determines that the three-phase resonant currents be going to flow simultaneously, for example, if the time lag between the beginning time of the high-level period of the control signal SU6 corresponding to the U-phase and the beginning time of the high-level period of the control signal SV6 corresponding to the V-phase, the time lag between the beginning time of the high-level period of the control signal SV6 corresponding to the V-phase and the beginning time of the high-level period of the control signal SW6 corresponding to the W-phase, and the time lag between the beginning time of the high-level period of the control signal SW6 corresponding to the W-phase and the beginning time of the high-level period of the control signal SU6 corresponding to the U-phase are all less than a threshold value.

Supposing the capacitance of each of the plurality of resonant capacitors 9U, 9U, and 9W is C, if a U-phase current, a V-phase current, and a W-phase current flow simultaneously through the resonant inductor L1, a capacitor having a combined capacitance (=3×C) of the resonant capacitor 9U, the resonant capacitor 9V, and the resonant capacitor 9W is connected to the resonant inductor L1 in series in an equivalent circuit. Thus, in the power converter 100, if three-phase currents flow simultaneously through the resonant inductor L1, then the resonant frequency of a resonant circuit including the resonant inductor L1 changes compared to a situation where a single-phase current flows through the resonant inductor L1. Consequently, the power converter 100 may be unable to make zero-voltage soft switching.

FIG. 16 shows a timing chart illustrating a situation where the controller 50 has determined in advance that three-phase resonant currents, namely, U-, V-, and W-phase resonant currents, be going to flow simultaneously and has not started performing the first operation or the second operation yet (i.e., before shifting). FIG. 16 is a timing chart showing the waveforms of control signals SU1, SU2, SV1, SV2, SW1, SW2, SU6, SV6, SW6, load currents iU, iV, iW, current iL1, and voltages V2u, V2v, V2w across the second switching elements 2U, 2V, 2W. FIG. 17 shows a timing chart illustrating a situation where the controller 50 has determined in advance that three-phase resonant currents, namely, U-, V-, and W-phase resonant currents, be going to flow simultaneously and has performed both the first operation and the second operation (i.e., after shifting). FIG. 17 is a timing chart showing the waveforms of the control signals SU1, SU2, SV1, SV2, SW1, SW2, SU6, SV6, SW6, load currents iU, iV, iW, current iL1, and voltages V2u, V2v, V2w across the second switching elements 2U, 2V, 2W. In FIG. 17, the high-level period of the control signal SW6 before the high-level period of the control signal SW6 is reduced to zero is indicated by the dashed line.

In the example shown in FIG. 16, the polarity of the load currents iU, iV is positive, the polarity of the load current iW is negative, and the absolute value of the load current iU is greater than the absolute value of the load current iV. When performing the first operation, the controller 50 compares, as for the load currents iU, iV having the same polarity, the absolute value of the load current iU with the absolute value of the load current iV and shortens, by the shortening period Tred (refer to FIG. 17), the high-level period of the control signal SV6 for the switch 8V corresponding to the AC terminal 41V through which a load current having the smaller absolute value flows. In the example shown in FIG. 17, the controller 50 sets the length of the shortening period Tred to make the length of the high-level period of the control signal SV6 as long as the length of the resonant half cycle (=Tres/2). Thus, in the example shown in FIG. 17, the shortening period Tred is as long as the additional time Tav.

In addition, the controller 50 shifts, when performing the second operation, the high-level period of the control signal SV6 by the shifted time Tsv in such a direction as to postpone the high-level period of the control signal SV6. In this case, the controller 50 shifts each of the high-level period of the control signal SV6 for the switch 8V, the high-level period of the control signal SV1 for the first switching element 1V, and the high-level period of the control signal SV2 for the second switching element 2 by the shifted time Tsv in such a direction as to postpone each of these high-level periods to cause, if the high-level period of a control signal SU6 for the switch 8U begins at a point in time ta, the high-level period of the control signal SV6 for the switch 8V to begin at a point in time tc when a standby period Tdef has passed since a point in time tb when a current value of a resonant current (current iL1) passing through the switch 8U agreed with a current value of a load current iU flowing through an AC terminal 41 U corresponding to the switch 8U after the current value of the resonant current (current iL1) passing through the switch 8U had become equal to an extreme value (e.g., a maximum value in the example shown in FIG. 17). The absolute value of the resonant current (current iL1) at the point in time tb is greater than the absolute value of the load current iV flowing through the AC terminal 41V corresponding to the switch 8V. The controller 50 determines the standby period Tdef by the equation: Tdef=L×(iV−iU)/V15. The controller 50 determines the shifted time Tsv by the equation: Tsu=ΔT+Tdef. In the example shown in FIG. 16, ΔT is the time lag between the end time of the high-level period of the control signal SV2 for the second switching element 2V corresponding to the switch 8V and the beginning time of the high-level period of the control signal SU1 for the first switching element 1U corresponding to the switch 8U. This makes the current value of the resonant current (current iL1) at the end time tc of the standby period Tdef equal to the absolute value of the load current iV. This allows, even if the high-level period of the control signal SV6 for the switch 8V does not include the additional time Tav but is as long as the resonant half cycle (Tres/2), the power converter 100 to make zero-voltage soft switching of the first switching element 1V.

As can be seen from the waveform of the current iL1 shown in FIG. 16 and the waveform of the current iL1 shown in FIG. 17, the power converter 100 may shorten the period in which the U-phase resonant current and the V-phase resonant current overlap with each other by having the controller 50 perform the first operation and the second operation if the controller 50 has determined in advance that the three-phase resonant currents, namely, the U-, V-, and W-phase resonant currents, be going to flow simultaneously.

In the power converter 100, if the controller 50 does not perform the first operation or the second operation, the voltages V2u, V2v across the second switching elements 2U, 2V do not rise to Vd at a point in time when the control signals SU1, SV1 make a transition from a low-level period to a high-level period (i.e., the end time of the dead time period Td corresponding to each of U- and V-phases) as shown in FIG. 16. That is to say, if the controller 50 does not perform the first operation or the second operation, the resonant capacitors 9U, 9V have not been charged with electricity yet at the end time of the dead time period Td corresponding to each of U- and V-phases. Therefore, if the controller 50 does not perform the first operation or the second operation, then none of the voltages across the first switching elements 1U, 1V decreases to zero at the end time of the dead time period Td corresponding to each of U- and V-phases. Consequently, in the power converter 100, the first switching elements 1U, 1V are hard-switched.

On the other hand, if the controller 50 has performed the first operation and the second operation, the voltages V2u, V2v across the second switching elements 2U, 2V rise to Vd at a point in time when the control signals SU1, SV1 make a transition from a low-level period to a high-level period (i.e., the end time of the dead time period Td corresponding to each of U- and V-phases) as shown in FIG. 17. That is to say, if the controller 50 has performed the first operation and the second operation, then the resonant capacitors 9U, 9V have already been charged with electricity at the end time of the dead time period Td corresponding to each of U- and V-phases. Therefore, in the power converter 100, if the controller 50 has performed the first operation and the second operation, the first switching elements 1U, 1V are switched by zero-voltage soft switching.

FIG. 17, which has been referred to above, illustrates an example in which the first operation and the second operation have been performed in a situation where the load currents iU, iV out of the load currents iU, iV, iW have the same polarity and only the load current iW has a different polarity. However, this is only an example and should not be construed as limiting. Alternatively, zero-voltage soft switching may also be made, for example, even when the controller 50 performs the first operation and the second operation in a situation where the load currents iV, iW out of the load currents iU, iV, iW have the same polarity and only the load current iU has a different polarity. Still alternatively, zero-voltage soft switching of the first switching elements 1U, 1V, 1W may also be made, for example, even when the controller 50 performs the first operation and the second operation in a situation where the load currents iW, iU out of the load currents iU, iV, iW have the same polarity and only the load current iV has a different polarity.

Even in the case of the operation of soft-switching the second switching elements 2, zero-voltage soft switching may also be made by making the controller 50 perform the first operation and the second operation. That is to say, if one of two switches 8 corresponding one to one to two AC terminals 41, through which load currents having the same polarity flow, is a first switch and the other switch is a second switch, the controller 50 also performs the first operation and the second operation and stops operating another switch 8 corresponding to a load current having a different polarity (i.e., reduces the length of the high-level period to zero).

In the power converter 100 according to the second embodiment, the controller 50 performs, when determining that resonant currents respectively passing through three switches 8 belonging to the plurality of switches 8 be going to flow through the resonant inductor L1 simultaneously, a first operation and further performs a second operation. Supposing one of the two switches 8 corresponding one to one to two AC terminals 41, through which load currents having the same polarity flow and which belong to the three AC terminals 41, among the three switches 8 is a first switch and the other of the two switches 8 is a second switch, the first operation includes shortening a high-level period of a control signal for the first switch by a shortening period Tred from a period including a resonant half cycle (Tred/2) and an additional time Tad. The resonant half cycle (Tred/2) is determined by the capacitance C of one resonant capacitor 9 corresponding to the first switch which belongs to the plurality of resonant capacitors 9 and the inductance L of the resonant inductor L1. The additional time Tad is determined by a voltage V15 of the regenerative capacitor 15 and inductance L of the resonant inductor L1. The second operation includes shifting a high-level period of a control signal for the first switch to cause the high-level period of the control signal for the first switch to begin when a standby period Tdef has passed since a point in time when a current value of a resonant current passing through the second switch agreed with a current value of a load current flowing through an AC terminal 41 corresponding to the second switch after the current value of the resonant current passing through the second switch had become equal to an extreme value. This allows the power converter 100 to make soft switching with more reliability.

### Third Embodiment

A power converter 100 according to a third embodiment has the same circuit configuration as the power converter 100 according to the first embodiment (refer to FIG. 1) described above, and therefore, illustration and description thereof will be omitted herein.

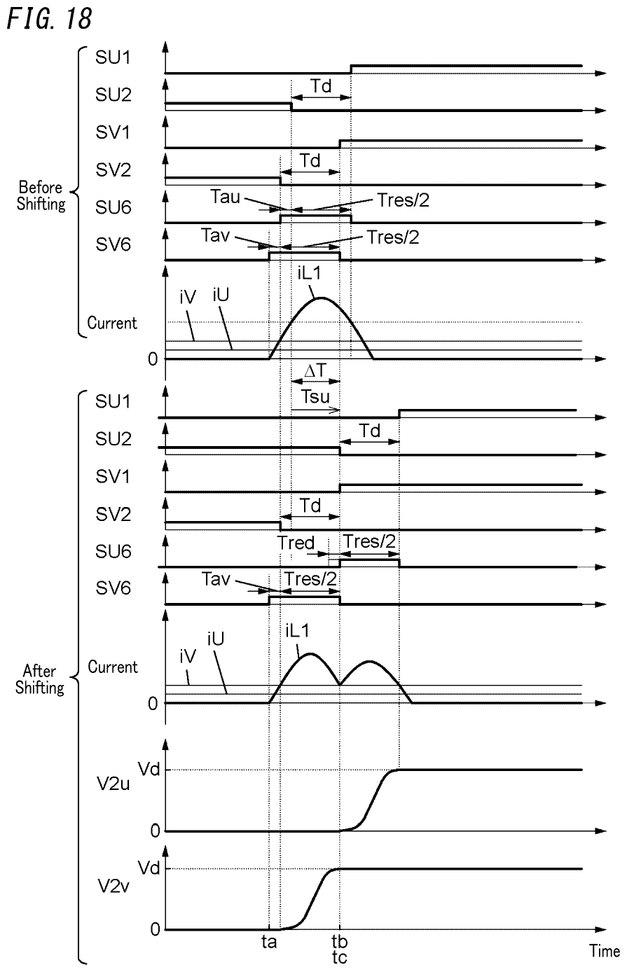

Now, it will be described with reference to FIG. 18 how the power converter 100 according to the third embodiment performs the operation of soft-switching the first switching elements 1. FIG. 18 may be interpreted in the same way as in FIG. 10, and therefore, description thereof will be omitted herein.

In the example shown in FIG. 18, the controller 50 compares, when performing the first operation, the absolute values of the load currents iU, iV with each other, thereby shortening, by the shortening period Tred, the high-level period of the control signal SU6 to be applied to the switch 8U corresponding to one of the two AC terminals 41U, 41V through which a load current with the smaller absolute value flows. In the example shown in FIG. 18, the controller 50 sets the length of the shortening period Tred to make the high-level period of the control signal SU6 as long as the resonant half cycle (=Tres/2). Therefore, in the example shown in FIG. 18, the shortening period Tred is as long as the additional time Tau.

In addition, the controller 50 shifts, when performing the second operation, the high-level period of the control signal SU6 by the shifted time Tsu in such a direction as to postpone the high-level period of the control signal SU6. In this case, the controller 50 shifts the high-level period of the control signal SU6 for the switch 8U, the high-level period of the control signal SU1 for the first switching element 1U, and the high-level period of the control signal SU2 for the second switching element 2U by the shifted time Tsu in such a direction as to postpone each of these high-level periods to cause, if the high-level period of a control signal SV6 for the switch 8V begins at a point in time ta, the high-level period of the control signal SU6 for the switch 8U to begin at a point in time tc when a standby period Tdef (refer to FIG. 10) has passed since a point in time tb when a current value of a resonant current (current iL1) passing through the switch 8V agreed with a current value of a load current iV flowing through an AC terminal 41V corresponding to the switch 8V after the current value of the resonant current (current iL1) passing through the switch 8V had become equal to an extreme value (e.g., a maximum value in the example shown in FIG. 18). In the third embodiment, the length of the standby period Tdef (refer to FIG. 10) is set at zero. The absolute value of the resonant current (current iL1) at the point in time tb is greater than the absolute value of the load current iU flowing through the AC terminal 41U corresponding to the switch 8U. The controller 50 sets the length of the shifted time Tsu as long as ΔT. In the example shown in FIG. 18, ΔT is the time lag between the beginning time of the high-level period of the control signal SV1 for the first switching element 1V corresponding to the switch 8V and the end time of the high-level period of the control signal SU2 for the second switching element 2U corresponding to the switch 8U. This allows, even if the high-level period of the control signal SU6 for the switch 8U does not include the additional time Tau but is as long as the resonant half cycle (Tres/2), the power converter 100 to make zero-voltage soft switching of the first switching element 1U.

As can be seen from the waveform of the current iL1 shown in the upper part of FIG. 18 and the waveform of the current iL1 shown in the lower part of FIG. 18, when the controller 50 has determined in advance that two-phase resonant currents, namely, the U- and V-phase resonant currents, be going to flow simultaneously, the controller 50 performs the first operation and the second operation, thus allowing the power converter 100 to shorten the period in which the U-phase resonant current and the V-phase resonant current overlap with each other.

In the power converter 100, if the controller 50 does not perform the first operation or the second operation, the first switching elements 1U, 1V are hard-switched as shown in FIG. 9.

On the other hand, in the power converter 100, the controller 50 performs the first operation and the second operation, and therefore, the first switching elements 1U, 1V are switched by zero-voltage soft switching as shown in FIG. 18.

In the same way, if the controller 50 has determined in advance that two-phase resonant currents, namely, the U-phase resonant current and the W-phase resonant current, be going to flow simultaneously, the controller 50 performs the first operation and the second operation, thus allowing the power converter 100 to shorten the period in which the U-phase resonant current and the W-phase resonant current overlap with each other to make zero-voltage soft switching of the first switching elements 1U, 1W. Also, if the controller 50 has determined in advance that two-phase resonant currents, namely, the V-phase resonant current and the W-phase resonant current, be going to flow simultaneously, the controller 50 performs the first operation and the second operation, thus allowing the power converter 100 to shorten the period in which the V-phase resonant current and the W-phase resonant current overlap with each other to make zero-voltage soft switching of the first switching elements 1V, 1W.

Even in the case of the operation of soft-switching the second switching elements 2, zero-voltage soft switching may also be made by making the controller 50 perform the first operation and the second operation. That is to say, if one of two switches 8 corresponding one to one to two AC terminals 41, through which load currents having the same polarity flow, is a first switch and the other switch is a second switch, the controller 50 also performs the first operation and the second operation.

### Fourth Embodiment

A power converter 100 according to a fourth embodiment has the same circuit configuration as the power converter 100 according to the first embodiment (refer to FIG. 1) described above, and therefore, illustration and description thereof will be omitted herein.

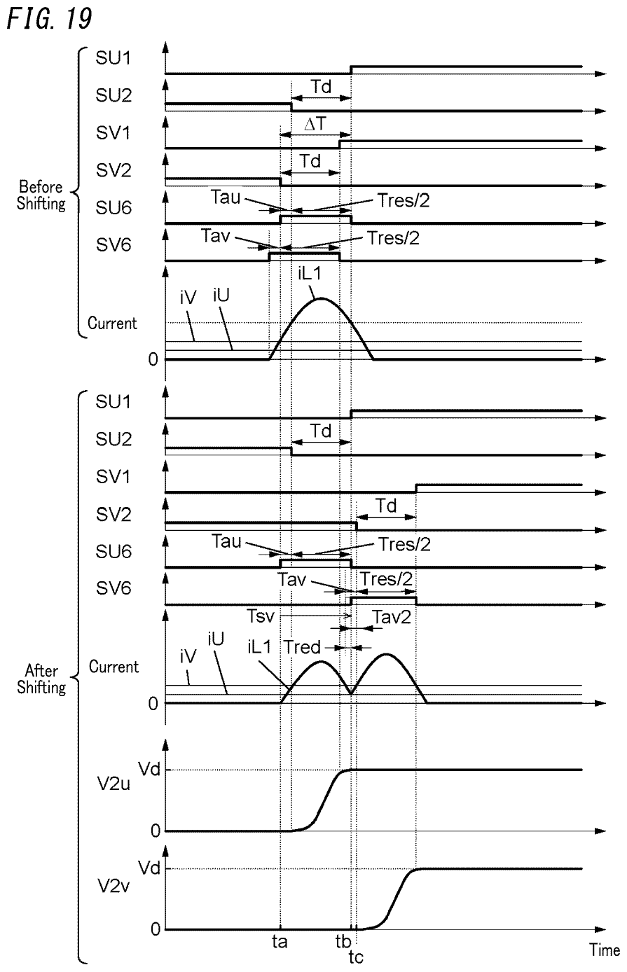

Now, it will be described with reference to FIG. 19 how the power converter 100 according to the fourth embodiment performs the operation of soft-switching the first switching elements 1. FIG. 19 may be interpreted in the same way as in FIG. 10, and therefore, description thereof will be omitted herein.

In the example shown in FIG. 19, the controller 50 compares, when performing the first operation, the absolute values of the load currents iU, iV with each other, thereby shortening, by the shortening period Tred, the high-level period of the control signal SV6 to be applied to the switch 8V corresponding to one AC terminal 41V out of the two AC terminals 41U, 41V through which a load current with the larger absolute value flows. The controller 50 determines the shortening period Tred by the equation Tred=Tav−Tav2. In this case, the controller 50 determines Tav2 by the equation Tav2=L×(iV−iU)/V15. In other words, shortening the high-level period by the shortening period Tred causes the additional time Tav of the control signal SV6 to be shortened to Tav2. As used herein, Tav2 refers to an additional time that remains after the control signal SV6 has been shortened by the shortening period Tred.

In addition, the controller 50 shifts, when performing the second operation, the high-level period of the control signal SV6 by the shifted time Tsv in such a direction as to postpone the high-level period of the control signal SV6. In this case, the controller 50 shifts the high-level period of the control signal SV6 for the switch 8V, the high-level period of the control signal SV1 for the first switching element 1V, and the high-level period of the control signal SV2 for the second switching element 2V by the shifted time Tsv in such a direction as to postpone each of these high-level periods to cause, if the high-level period of a control signal SV6 for the switch 8V begins at a point in time ta, the resonant half cycle included in the high-level period of the control signal SV6 for the switch 8V to begin at a point in time tc when a new additional time Tav2 has passed since a point in time tb when a current value tb of a resonant current (current iL1) passing through the switch 8V agreed with a current value of a load current iU flowing through an AC terminal 41U corresponding to the switch 8U after the current value of the resonant current (current iL1) passing through the switch 8V had become equal to an extreme value (e.g., a local maximum value in the example shown in FIG. 19). As used herein, the new additional time Tav2 refers to a time that remains after the additional time Tad of the original control signal SV6 has been shortened by the shortening period Tred. The absolute value of the resonant current (current iL1) at the point in time tb is equal to the absolute value of the load current iU and less than the absolute value of the load current iV. The controller 50 determines the shortening period Tred by the equation Tred=Tav−Tav2. In this case, the controller 50 determines the new Tav2 by the equation Tav2=Lx (iV−iU)/V15. The controller 50 sets the shifted time Tsu as long as ΔT. In the example shown in FIG. 19, ΔT is the time lag between the beginning time of the high-level period of the control signal SU1 for the first switching element 1U corresponding to the switch 8U and the end time of the high-level period of the control signal SV2 for the second switching element 2V corresponding to the switch 8V. This makes the current value of the resonant current (current iL1) at the end time tc of the new additional time Tav2 equal to the absolute value of the load current iV. This allows, even if the additional time Tav for the high-level period of the control signal SV6 for the switch 8V is shortened from the original additional time Tav to the new additional time Tav2, the power converter 100 to make zero-voltage soft switching of the first switching element 1U.

As can be seen from the waveform of the current iL1 shown in the upper part of FIG. 19 and the waveform of the current iL1 shown in the lower part of FIG. 19, when the controller 50 has determined in advance that two-phase resonant currents, namely, the U- and V-phase resonant currents, be going to flow simultaneously, the controller 50 performs the first operation and the second operation, thus allowing the power converter 100 to shorten the period in which the U-phase resonant current and the V-phase resonant current overlap with each other.

In the power converter 100, if the controller 50 does not perform the first operation or the second operation, the first switching elements 1U, 1V are hard-switched as shown in FIG. 9.

On the other hand, in the power converter 100, the controller 50 performs the first operation and the second operation, and therefore, the first switching elements 1U, 1V are switched by zero-voltage soft switching as shown in FIG. 19.

In the same way, if the controller 50 has determined in advance that two-phase resonant currents, namely, the U-phase resonant current and the W-phase resonant current, be going to flow simultaneously, the controller 50 performs the first operation and the second operation, thus allowing the power converter 100 to shorten the period in which the U-phase resonant current and the W-phase resonant current overlap with each other to make zero-voltage soft switching of the first switching elements 1U, 1W. Also, if the controller 50 has determined in advance that two-phase resonant currents, namely, the V-phase resonant current and the W-phase resonant current, be going to flow simultaneously, the controller 50 performs the first operation and the second operation, thus allowing the power converter 100 to shorten the period in which the V-phase resonant current and the W-phase resonant current overlap with each other to make zero-voltage soft switching of the first switching elements 1V, 1W.

Even in the case of the operation of soft-switching the second switching elements 2, zero-voltage soft switching may also be made by making the controller 50 perform the first operation and the second operation. That is to say, if one of two switches 8 corresponding one to one to two AC terminals 41, through which load currents having the same polarity flow, is a first switch and the other switch is a second switch, the controller 50 also performs the first operation and the second operation.

### Fifth Embodiment

A power converter 100 according to a fifth embodiment has the same circuit configuration as the power converter 100 according to the first embodiment (refer to FIG. 1) described above, and therefore, illustration and description thereof will be omitted herein.

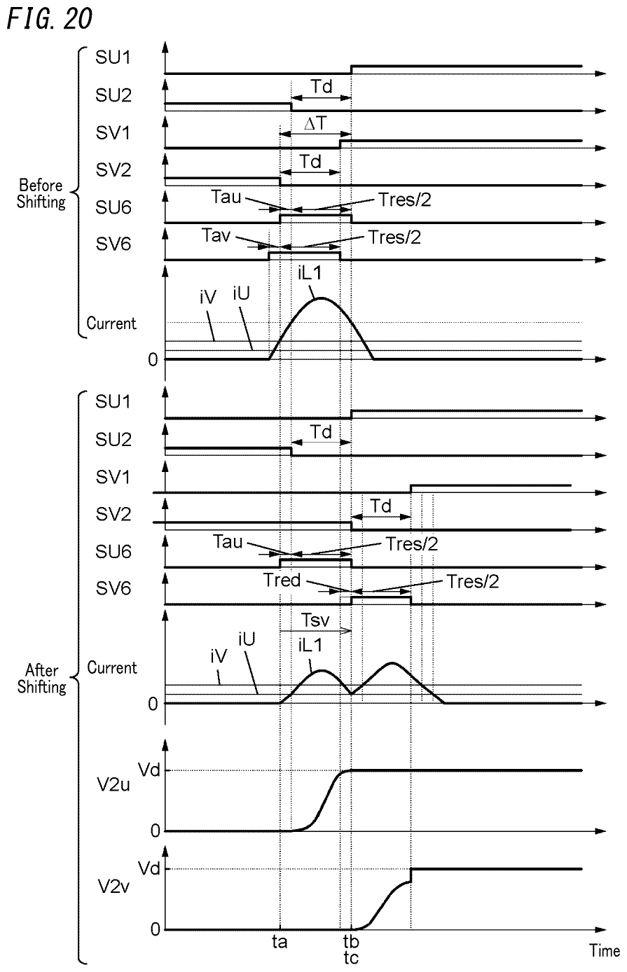

Now, it will be described with reference to FIG. 20 how the power converter 100 according to the fifth embodiment performs the operation of soft-switching the first switching elements 1. FIG. 20 may be interpreted in the same way as in FIG. 19, and therefore, description thereof will be omitted herein.

In the power converter 100 according to the fifth embodiment, the controller 50 sets the additional time Tav2 (refer to FIG. 19) after the additional time Tav for the control signal SV6 has been shortened by the shortening period Tred at zero (i.e., the shortening period Tred according to the fourth embodiment satisfies Tred=Tav), which is a difference from the power converter 100 according to the fourth embodiment.

In the example shown in FIG. 20, the controller 50 compares, when performing the first operation, the absolute values of the load currents iU, iV with each other, thereby shortening, by the shortening period Tred, the high-level period of the control signal SV6 to be applied to the switch 8V corresponding to one AC terminal 41V, through which a load current with the larger absolute value flows, out of the two AC terminals 41U, 41V. In the example shown in FIG. 20, the controller 50 sets the shortening period Tred that satisfies Tred=Tav.

In addition, the controller 50 shifts, when performing the second operation, the high-level period of the control signal SV6 by the shifted time Tsv in such a direction as to postpone the high-level period of the control signal SV6. In this case, the controller 50 shifts the high-level period of the control signal SV6 for the switch 8V, the high-level period of the control signal SV1 for the first switching element 1V, and the high-level period of the control signal SV2 for the second switching element 2V by the shifted time Tsv in such a direction as to postpone each of these high-level periods to cause, if the high-level period of a control signal SU6 for the switch 8U begins at a point in time ta, the resonant half cycle included in the high-level period of the control signal SV6 for the switch 8V to begin at a point in time tc when a standby period Tdef has passed since a point in time tb when a current value of a resonant current (current iL1) passing through the switch 8U agreed with a current value of a load current iU flowing through an AC terminal 41U corresponding to the switch 8U after the current value of the resonant current (current iL1) passing through the switch 8U had become equal to an extreme value (e.g., a local maximum value in the example shown in FIG. 20). The absolute value of the resonant current (current iL1) at the point in time tb is equal to the absolute value of the load current iU and less than the absolute value of the load current iV. The controller 50 sets the additional time Tav2 (refer to FIG. 19) after the additional time Tav for the control signal SV6 has been shortened by the shortening period Tred at zero. In addition, the controller 50 sets the shifted time Tsv that satisfies Tsv=ΔT. In the example shown in FIG. 20, ΔT is the time lag between the beginning time of the high-level period of the control signal SU1 for the first switching element 1U corresponding to the switch 8U and the end time of the high-level period of the control signal SV2 for the second switching element 2V corresponding to the switch 8V. This allows the power converter 100 to make zero-voltage soft switching of the first switching element 1U and substantially make zero-voltage soft switching of the first switching element 1V. This may make the voltage V2v across the second switching element 2V at the end time of the high-level period of the control signal SV6 even closer to Vd than in the case shown in FIG. 9, thus substantially making soft switching.

As can be seen from the waveform of the current iL1 shown in the upper part of FIG. 20 and the waveform of the current iL1 shown in the lower part of FIG. 20, when the controller 50 has determined in advance that two-phase resonant currents, namely, the U- and V-phase resonant currents, be going to flow simultaneously, the controller 50 performs the first operation and the second operation, thus allowing the power converter 100 to shorten the period in which the U-phase resonant current and the V-phase resonant current overlap with each other.

In the same way, if the controller 50 has determined in advance that two-phase resonant currents, namely, the U-phase resonant current and the W-phase resonant current, be going to flow simultaneously, the controller 50 performs the first operation and the second operation, thus allowing the power converter 100 to shorten the period in which the U-phase resonant current and the W-phase resonant current overlap with each other. Also, if the controller 50 has determined in advance that two-phase resonant currents, namely, the V-phase resonant current and the W-phase resonant current, will flow simultaneously, the controller 50 performs the first operation and the second operation, thus allowing the power converter 100 to shorten the period in which the V-phase resonant current and the W-phase resonant current overlap with each other.

Even in the case of the operation of soft-switching the second switching elements 2, the controller 50 also performs the first operation and the second operation. That is to say, if one of two switches 8 corresponding one to one to two AC terminals 41, through which load currents having the same polarity flow, is a first switch and the other switch is a second switch, the controller 50 also performs the first operation and the second operation.

### Sixth Embodiment

A power converter 100 according to a sixth embodiment has the same circuit configuration as the power converter 100 according to the first embodiment (refer to FIG. 1) described above, and therefore, illustration and description thereof will be omitted herein.

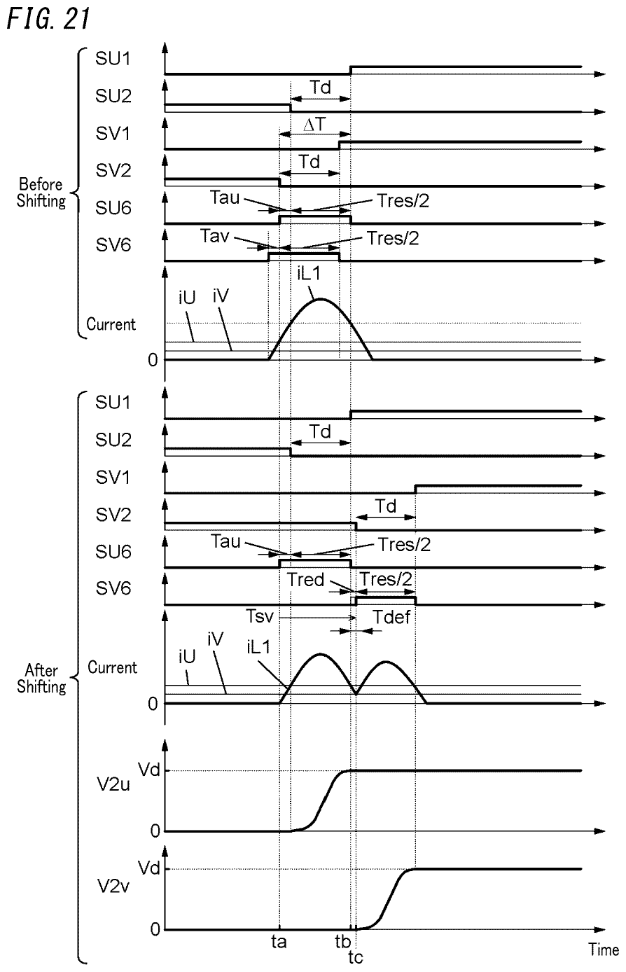

Now, it will be described with reference to FIG. 21 how the power converter 100 according to the sixth embodiment performs the operation of soft-switching the first switching elements 1. FIG. 21 may be interpreted in the same way as in FIG. 10, and therefore, description thereof will be omitted herein.

In the example shown in FIG. 21, the controller 50 compares, when performing the first operation, the absolute values of the load currents iU, iV with each other, thereby shortening, by the shortening period Tred, the high-level period of the control signal SV6 to be applied to the switch 8V corresponding to one AC terminal 41V, through which a load current with the smaller absolute value flows, out of the two AC terminals 41U, 41V. In the example shown in FIG. 21, the controller 50 sets the shortening period Tred that satisfies Tred=Tav.

In addition, the controller 50 shifts, when performing the second operation, the high-level period of the control signal SV6 by the shifted time Tsv in such a direction as to postpone the high-level period of the control signal SV6. In this case, the controller 50 shifts the high-level period of the control signal SV6 for the switch 8V, the high-level period of the control signal SV1 for the first switching element 1V, and the high-level period of the control signal SV2 for the second switching element 2V by the shifted time Tsv in such a direction as to postpone each of these high-level periods to cause, if the high-level period of a control signal SV6 for the switch 8V begins at a point in time ta, the resonant half cycle included in the high-level period of the control signal SV6 for the switch 8V to begin at a point in time tc when a standby period Tdef has passed since a point in time tb when a current value of a resonant current (current iL1) passing through the switch 8V agreed with a current value of a load current iU flowing through an AC terminal 41U corresponding to the switch 8U after the current value of the resonant current (current iL1) passing through the switch 8V had become equal to an extreme value (e.g., a local maximum value in the example shown in FIG. 21). The absolute value of the resonant current (current iL1) at the point in time tb is equal to the absolute value of the load current iU and greater than the absolute value of the load current iV. The controller 50 determines the standby period Tdef by the equation Tdef=L×(iU−iV)/V15. In addition, the controller 50 determines the shifted time Tsv by the equation Tsv=ΔT+Tdef. In the example shown in FIG. 21, ΔT is the time lag between the beginning time of the high-level period of the control signal SU1 for the first switching element 1U corresponding to the switch 8U and the end time of the high-level period of the control signal SV2 for the second switching element 2V corresponding to the switch 8V. This allows the power converter 100 to make zero-voltage soft switching of the first switching elements 1U, 1V by having the controller 50 perform the first operation and the second operation when the controller 50 has determined in advance that two-phase resonant currents, namely, the U-phase resonant current and the V-phase resonant current, be going to flow through the resonant inductor L1.

In the same way, if the controller 50 has determined in advance that two-phase resonant currents, namely, the U-phase resonant current and the W-phase resonant current, be going to flow simultaneously, the controller 50 performs the first operation and the second operation, thus allowing the power converter 100 to make zero-voltage soft switching of the first switching elements 1U, 1W. Also, if the controller 50 has determined in advance that two-phase resonant currents, namely, the V-phase resonant current and the W-phase resonant current, be going to flow simultaneously, the controller 50 performs the first operation and the second operation, thus allowing the power converter 100 to make zero-voltage soft switching of the first switching elements 1V, 1W.

Even in the case of the operation of soft-switching the second switching elements 2, the controller 50 also performs the first operation and the second operation. That is to say, if one of two switches 8 corresponding one to one to two AC terminals 41, through which load currents having the same polarity flow, is a first switch and the other switch is a second switch, the controller 50 also performs the first operation and the second operation. This allows the power converter 100 to make zero-voltage soft switching of the second switching elements 2.

### Seventh Embodiment

A power converter 100 according to a seventh embodiment has the same circuit configuration as the power converter 100 according to the first embodiment (refer to FIG. 1) described above, and therefore, illustration and description thereof will be omitted herein.

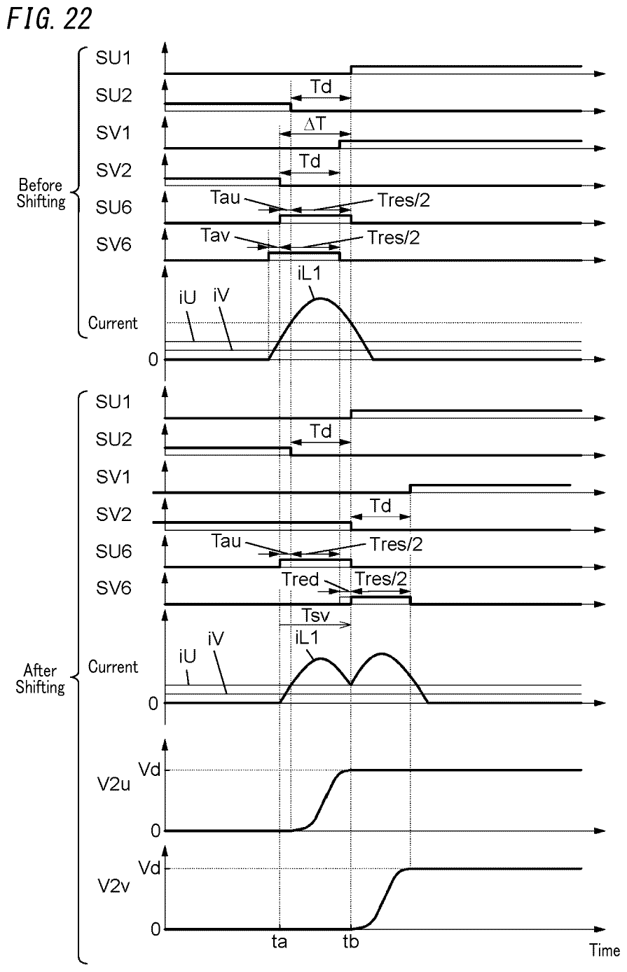

Now, it will be described with reference to FIG. 22 how the power converter 100 according to the seventh embodiment performs the operation of soft-switching the first switching elements 1. FIG. 22 may be interpreted in the same way as in FIG. 21, and therefore, description thereof will be omitted herein.

In the power converter 100 according to the seventh embodiment, the controller 50 sets the standby period Tdef (refer to FIG. 21) at zero, which is a difference from the power converter 100 according to the sixth embodiment.

In the example shown in FIG. 22, the controller 50 compares, when performing the first operation, the absolute values of the load currents iU, iV with each other, thereby shortening, by the shortening period Tred, the high-level period of the control signal SV6 to be applied to the switch 8V corresponding to one AC terminal 41V, through which a load current with the smaller absolute value flows, out of the two AC terminals 41U, 41V. In the example shown in FIG. 22, the controller 50 sets the shortening period Tred that satisfies Tred=Tav.

In addition, the controller 50 shifts, when performing the second operation, the high-level period of the control signal SV6 by the shifted time Tsv in such a direction as to postpone the high-level period of the control signal SV6. In this case, the controller 50 shifts the high-level period of the control signal SV6 for the switch 8V, the high-level period of the control signal SV1 for the first switching element 1V, and the high-level period of the control signal SV2 for the second switching element 2V by the shifted time Tsv in such a direction as to postpone each of these high-level periods to cause, if the high-level period of a control signal SU6 for the switch 8U begins at a point in time ta, the resonant half cycle included in the high-level period of the control signal SV6 for the switch 8V to begin at a point in time tc when the standby period Tdef has passed since a point in time tb when a current value of a resonant current (current iL1) passing through the switch 8U agreed with a current value of a load current iU flowing through an AC terminal 41U corresponding to the switch 8U after the current value of the resonant current (current iL1) passing through the switch 8U had become equal to an extreme value (e.g., a local maximum value in the example shown in FIG. 22). The absolute value of the resonant current (current iL1) at the point in time tb is equal to the absolute value of the load current iU and greater than the absolute value of the load current iV. The controller 50 sets the standby period Tdef at zero. In addition, the controller 50 sets the shifted time Tsv that satisfies Tsv=ΔT+Tdef. In the example shown in FIG. 22, ΔT is the time lag between the beginning time of the high-level period of the control signal SU1 for the first switching element 1U corresponding to the switch 8U and the end time of the high-level period of the control signal SV2 for the second switching element 2V corresponding to the switch 8V. This allows the power converter 100 to make zero-voltage soft switching of the first switching elements 1U, 1V by having the controller 50 perform the first operation and the second operation when the controller 50 has determined in advance that the U-phase resonant current and the V-phase resonant current be going to flow through the resonant inductor L1.

In the same way, if the controller 50 has determined in advance that two-phase resonant currents, namely, the U-phase resonant current and the W-phase resonant current, be going to flow simultaneously, the controller 50 performs the first operation and the second operation, thus allowing the power converter 100 to make zero-voltage soft switching of the first switching elements 1U, 1W. Also, if the controller 50 has determined in advance that two-phase resonant currents, namely, the V-phase resonant current and the W-phase resonant current, be going to flow simultaneously, the controller 50 performs the first operation and the second operation, thus allowing the power converter 100 to make zero-voltage soft switching of the first switching elements 1V, 1W.

Even in the case of the operation of soft-switching the second switching elements 2, the controller 50 also performs the first operation and the second operation. That is to say, if one of two switches 8 corresponding one to one to two AC terminals 41, through which load currents having the same polarity flow, is a first switch and the other switch is a second switch, the controller 50 also performs the first operation and the second operation. This allows the power converter 100 to make zero-voltage soft switching of the second switching elements 2.

### Eighth Embodiment

A power converter 100 according to an eighth embodiment has the same circuit configuration as the power converter 100 according to the first embodiment (refer to FIG. 1) described above, and therefore, illustration and description thereof will be omitted herein.

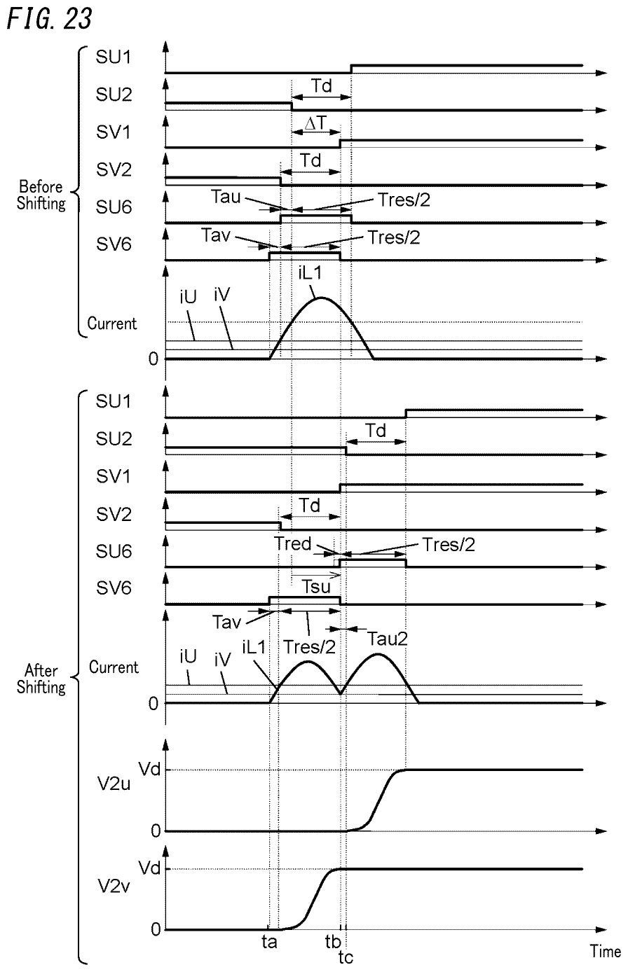

Now, it will be described with reference to FIG. 23 how the power converter 100 according to the eighth embodiment performs the operation of soft-switching the first switching elements 1. FIG. 23 may be interpreted in the same way as in FIG. 10, and therefore, description thereof will be omitted herein.

In the example shown in FIG. 23, the controller 50 compares, when performing the first operation, the absolute values of the load currents iU, iV with each other, thereby shortening, by the shortening period Tred, the high-level period of the control signal SU6 to be applied to the switch 8U corresponding to one AC terminal 41U, through which a load current with the larger absolute value flows, out of the two AC terminals 41U, 41V. In the example shown in FIG. 23, the controller 50 determines the shortening period Tred by the equation Tred=Tau−Tau2. In this case, the controller 50 determines the new Tau2 by the equation Tau2=L×(iU−iV)/V15.

In addition, the controller 50 shifts, when performing the second operation, the high-level period of the control signals SU6 by the shifted time Tsu in such a direction as to postpone the high-level period of the control signal SU6. In this case, the controller 50 shifts the high-level period of the control signal SU6 for the switch 8U, the high-level period of the control signal SU1 for the first switching element 1U, and the high-level period of the control signal SU2 for the second switching element 2U by the shifted time Tsu in such a direction as to postpone each of these high-level periods to cause, if the high-level period of a control signal SV6 for the switch 8V begins at a point in time ta, the resonant half cycle included in the high-level period of the control signal SU6 for the switch 8U to begin at a point in time tc when a new additional time Tau2 has passed since a point in time tb when a current value of a resonant current (current iL1) passing through the switch 8V agreed with a current value of a load current iV flowing through an AC terminal 41V corresponding to the switch 8V after the current value of the resonant current (current iL1) passing through the switch 8V had become equal to an extreme value (e.g., a local maximum value in the example shown in FIG. 23). The absolute value of the resonant current (current iL1) at the point in time tb is equal to the absolute value of the load current iV and less than the absolute value of the load current iU. The controller 50 determines the shortening period Tred by the equation Tred=Tau−Tau2. In this case, the controller 50 determines the new Tau2 by the equation Tau2=L×(iU−iV)/V15. The controller 50 sets the shifted time Tsu as long as ΔT. In the example shown in FIG. 23, ΔT is the time lag between the beginning time of the high-level period of the control signal SV1 for the first switching element 1V corresponding to the switch 8V and the end time of the high-level period of the control signal SU2 for the second switching element 2U corresponding to the switch 8U. This makes the current value of the resonant current (current iL1) at the end time tc of the new additional time Tau2 equal to the absolute value of the load current iU. This allows the power converter 100 to make zero-voltage soft switching of the first switching elements 1V, 1U by having the controller 50 perform the first operation and the second operation.

In the same way, if the controller 50 has determined in advance that two-phase resonant currents, namely, the U-phase resonant current and the W-phase resonant current, be going to flow simultaneously, the controller 50 performs the first operation and the second operation, thus allowing the power converter 100 to shorten the period in which the U-phase resonant current and the W-phase resonant current overlap with each other to make zero-voltage soft switching of the first switching elements 1U, 1W. Also, if the controller 50 has determined in advance that two-phase resonant currents, namely, the V-phase resonant current and the W-phase resonant current, be going to flow simultaneously, the controller 50 performs the first operation and the second operation, thus allowing the power converter 100 to shorten the period in which the V-phase resonant current and the W-phase resonant current overlap with each other to make zero-voltage soft switching of the first switching elements 1V, 1W.

Even in the case of the operation of soft-switching the second switching elements 2, zero-voltage soft switching may also be made by making the controller 50 perform the first operation and the second operation. That is to say, if one of two switches 8 corresponding one to one to two AC terminals 41, through which load currents having the same polarity flow, is a first switch and the other switch is a second switch, the controller 50 also performs the first operation and the second operation.

### Ninth Embodiment

A power converter 100 according to a ninth embodiment has the same circuit configuration as the power converter 100 according to the first embodiment (refer to FIG. 1) described above, and therefore, illustration and description thereof will be omitted herein.

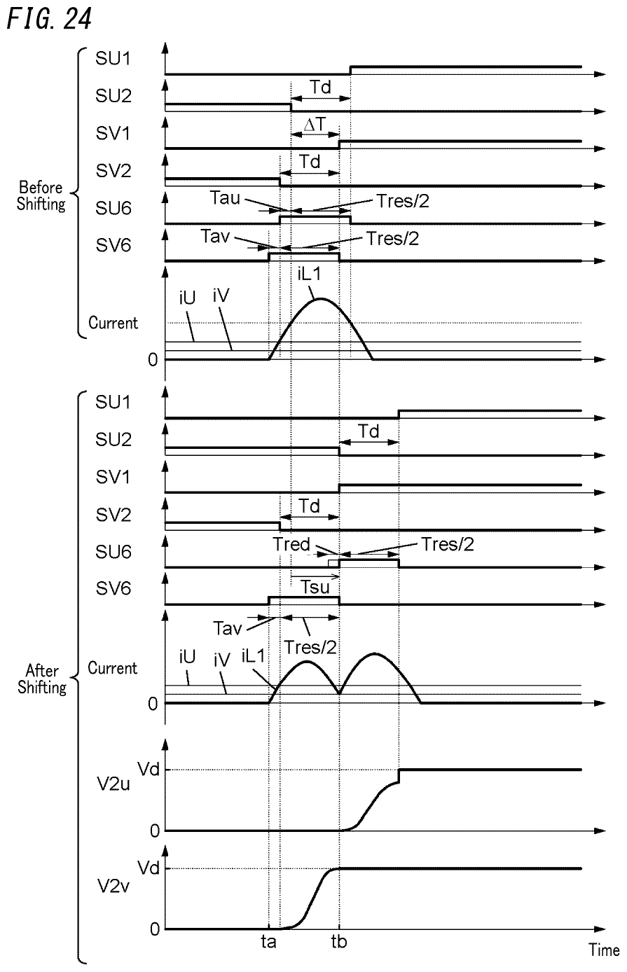

Now, it will be described with reference to FIG. 24 how the power converter 100 according to the ninth embodiment performs the operation of soft-switching the first switching elements 1. FIG. 24 may be interpreted in the same way as in FIG. 23, and therefore, description thereof will be omitted herein.

In the power converter 100 according to the ninth embodiment, the controller 50 sets the additional time Tau2 (refer to FIG. 23) after the additional time Tau for the control signal SU6 has been shortened by the shortening period Tred at zero, which is a difference from the power converter 100 according to the eighth embodiment.

In the example shown in FIG. 24, the controller 50 compares, when performing the first operation, the absolute values of the load currents iU, iV with each other, thereby shortening, by the shortening period Tred, the high-level period of the control signal SU6 to be applied to the switch 8U corresponding to one AC terminal 41U, through which a load current with the larger absolute value flows, out of the two AC terminals 41U, 41V. In the example shown in FIG. 24, the controller 50 sets the shortening period Tred that satisfies Tred=Tau.

In addition, the controller 50 shifts, when performing the second operation, the high-level period of the control signal SU6 by the shifted time Tsu in such a direction as to postpone the high-level period of the control signal SU6. In this case, the controller 50 shifts the high-level period of the control signal SU6 for the switch 8U, the high-level period of the control signal SU1 for the first switching element 1U, and the high-level period of the control signal SU2 for the second switching element 2U by the shifted time Tsu in such a direction as to postpone each of these high-level periods to cause, if the high-level period of a control signal SV6 for the switch 8V begins at a point in time ta, the resonant half cycle included in the high-level period of the control signal SU6 for the switch 8U to begin at a point in time to when a new additional time Tau2 has passed since a point in time tb when a current value of a resonant current (current iL1) passing through the switch 8V agreed with a current value of a load current iV flowing through an AC terminal 41V corresponding to the switch 8V after the current value of the resonant current (current iL1) passing through the switch 8V had become equal to an extreme value (e.g., a local maximum value in the example shown in FIG. 24). The absolute value of the resonant current (current iL1) at the point in time tb is equal to the absolute value of the load current iV and less than the absolute value of the load current iU. The controller 50 sets the additional time Tau2 (refer to FIG. 23) after the additional time Tau for the control signal SU6 has been shortened by the shortening period Tred at zero. In addition, the controller 50 sets the shifted time Tsu by the equation Tsu=ΔT+Tdef (i.e., Tsv=ΔT). In the example shown in FIG. 24, ΔT is the time lag between the beginning time of the high-level period of the control signal SV1 for the first switching element 1V corresponding to the switch 8V and the end time of the high-level period of the control signal SU2 for the second switching element 2U corresponding to the switch 8U. This allows the power converter 100 to make zero-voltage soft switching of the first switching elements 1U, 1V by having the controller 50 perform the first operation and the second operation when the controller 50 has determined in advance that the U-phase resonant current and the V-phase resonant current be going to flow through the resonant inductor L1.

In the same way, if the controller 50 has determined in advance that two-phase resonant currents, namely, the U-phase resonant current and the W-phase resonant current, be going to flow simultaneously, the controller 50 performs the first operation and the second operation, thus allowing the power converter 100 to make zero-voltage soft switching of the first switching elements 1U, 1W. Also, if the controller 50 has determined in advance that two-phase resonant currents, namely, the V-phase resonant current and the W-phase resonant current, be going to flow simultaneously, the controller 50 performs the first operation and the second operation, thus allowing the power converter 100 to make zero-voltage soft switching of the first switching elements 1V, 1W.

Even in the case of the operation of soft-switching the second switching elements 2, the controller 50 also performs the first operation and the second operation. That is to say, if one of two switches 8 corresponding one to one to two AC terminals 41, through which load currents having the same polarity flow, is a first switch and the other switch is a second switch, the controller 50 also performs the first operation and the second operation. This allows the power converter 100 to make zero-voltage soft switching of the second switching elements 2.

### Tenth Embodiment

A power converter 100 according to a tenth embodiment has the same circuit configuration as the power converter 100 according to the first embodiment (refer to FIG. 1) described above, and therefore, illustration and description thereof will be omitted herein.

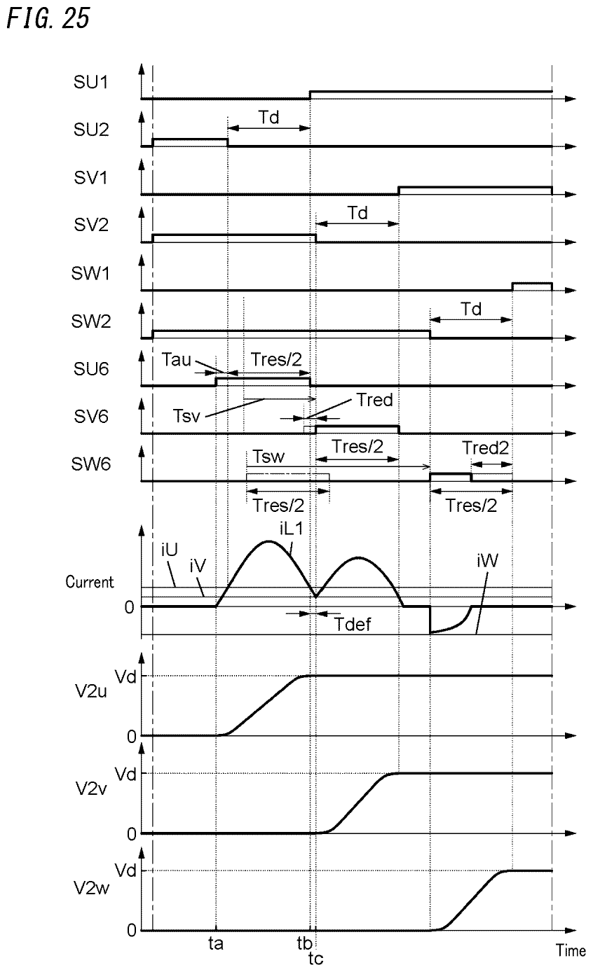

Now, it will be described with reference to FIG. 25 how the power converter 100 according to the tenth embodiment performs the operation of soft-switching the first switching elements 1 when the controller 50 has determined in advance that resonant currents, respectively passing through three switches 8 belonging to the plurality of switches 8, be going to flow simultaneously. FIG. 25 may be interpreted in the same way as in FIG. 17 referred to in the foregoing description of the second embodiment, and therefore, description thereof will be omitted herein.

When determining that the resonant currents respectively passing through three switches 8 belonging to the plurality of switches 8 be going to flow simultaneously through the resonant inductor L1, the controller 50 not only performs the first operation and the second operation on at least one of the first switch or the second switch but also shortens, by the shortening period, the high-level period of a control signal for the switch 8 corresponding to the AC terminal 41 of one phase, through which a load current of a different polarity flows, and shifts the high-level period by the shifted time in such a direction as to postpone or advance the high-level period. The shortening period may have an arbitrary length. The shifted time may also be set arbitrarily.

FIG. 16, which has been referred to in the foregoing description of the second embodiment, shows a timing chart illustrating a situation where the controller 50 has determined in advance that three-phase resonant currents, namely, U-, V-, and W-phase resonant currents, be going to flow simultaneously and have not started performing the first operation or the second operation yet (i.e., before shifting). FIG. 16 is a timing chart showing the waveforms of control signals SU1, SU2, SV1, SV2, SW1, SW2, SU6, SV6, SW6, load currents iU, iV, iW, current iL1, and voltages V2u, V2v, V2w across the second switching elements 2U, 2V, 2W. FIG. 25 shows a timing chart illustrating a situation where if the controller 50 has determined in advance that three-phase resonant currents, namely, U-, V-, and W-phase resonant currents, be going to flow simultaneously, the controller 50 has performed both the first operation and the second operation on the control signal SV6 for the switch 8V out of the two switches 8U, 8V, shortened, by the shortening period Tred2, the high-level period of the control signal SW6 for the switch 8W, and shifted the high-level period by the shifted time Tsw in such a direction as to postpone the high-level period. The shortening period Tred2 may have an arbitrary length. The shifted time Tsw of the control signal SW6 may also be set arbitrarily. In FIG. 25, the high-level period of the control signal SW6 shown in FIG. 16 is indicated by the one-dot chain.

In the example shown in FIG. 16, the polarity of the load currents iU, iV is positive, the polarity of the load current iW is negative, and the absolute value of the load current iU is greater than the absolute value of the load current iV. When performing the first operation, the controller 50 compares, as for the load currents iU, iV having the same polarity, the absolute value of the load current iU with the absolute value of the load current iV and shortens, by the shortening period Tred (refer to FIG. 25), the high-level period of the control signal SV6 for the switch 8V corresponding to the AC terminal 41V through which a load current having the smaller absolute value flows. In the example shown in FIG. 25, the controller 50 sets the length of the shortening period Tred to make the length of the high-level period of the control signal SV6 as long as the length of the resonant half cycle (=Tres/2). Thus, in the example shown in FIG. 25, the shortening period Tred is as long as the additional time Tav (refer to FIG. 16).

In addition, the controller 50 shifts, when performing the second operation, the high-level period of the control signal SV6 by the shifted time Tsv in such a direction as to postpone the high-level period of the control signal SV6. In this case, the controller 50 shifts each of the high-level period of the control signal SV6 for the switch 8V, the high-level period of the control signal SV1 for the first switching element 1V, and the high-level period of the control signal SV2 for the second switching element 2 by the shifted time Tsv in such a direction as to postpone each of these high-level periods to cause, if the high-level period of a control signal SU6 for the switch 8U begins at a point in time ta, the high-level period of the control signal SV6 for the switch 8V to begin at a point in time tc when a standby period Tdef has passed since a point in time tb when a current value of a resonant current (current iL1) passing through the switch 8U agreed with a current value of a load current iU flowing through an AC terminal 41U corresponding to the switch 8U after the current value of the resonant current (current iL1) passing through the switch 8U had become equal to an extreme value (e.g., a maximum value in the example shown in FIG. 25). The absolute value of the resonant current (current iL1) at the point in time tb is greater than the absolute value of the load current iU flowing through the AC terminal 41V corresponding to the switch 8V. The controller 50 determines the standby period Tdef by the equation: Tdef=L×(iU−iV)/V15. The controller 50 determines the shifted time Tsv by the equation: Tsv=ΔT+Tdef. In the example shown in FIG. 16, ΔT is the time lag between the end time of the high-level period of the control signal SV2 for the second switching element 2V corresponding to the switch 8V and the beginning time of the high-level period of the control signal SU1 for the first switching element 1U corresponding to the switch 8U. This makes the current value of the resonant current (current iL1) at the point in time tc when the standby period Tdef ends equal to the absolute value of the load current iV. This allows, even if the high-level period of the control signal SV6 for the switch 8V does not include the additional time Tav but is as long as the resonant half cycle (Tres/2), the power converter 100 to make zero-voltage soft switching of the first switching element 1V.

As can be seen from the waveform of the current iL1 shown in FIG. 16 and the waveform of the current iL1 shown in FIG. 25, the power converter 100 may shorten the period in which the U-phase resonant current and the V-phase resonant current overlap with each other by having the controller 50 perform the first operation and the second operation if the controller 50 has determined in advance that the three-phase resonant currents, namely, the U-, V-, and W-phase resonant currents, be going to flow simultaneously. In addition, the controller 50 shortens, by the shortening period Tred2, the high-level period of the control signal SW6 for the switch 8W and shifts the high-level period by the shifted time Tsw in such a direction as to postpone the high-level period of the control signal SW6, thus preventing the W-phase resonant current from overlapping with the U-phase resonant current or the V-phase resonant current.

In the power converter 100, if the controller 50 does not perform the first operation or the second operation, the first switching elements 1U, 1V are hard-switched as shown in FIG. 16.

On the other hand, if the controller 50 performs the first operation and the second operation, then the first switching elements 1U, 1V are switched by zero-voltage soft switching as shown in FIG. 25.

FIG. 25 illustrates an example in which the first operation and the second operation have been performed in a situation where the load currents iU, iV out of the load currents iU, iV, iW have the same polarity and only the load current iW has a different polarity. However, this is only an example and should not be construed as limiting. Alternatively, zero-voltage soft switching may also be made, for example, even when the controller 50 performs the first operation and the second operation in a situation where the load currents iV, iW out of the load currents iU, iV, iW have the same polarity and only the load current iU has a different polarity. Still alternatively, zero-voltage soft switching of the first switching elements 1U, 1V, 1W may also be made, for example, even when the controller 50 performs the first operation and the second operation in a situation where the load currents iW, iU out of the load currents iU, iV, iW have the same polarity and only the load current iV has a different polarity.

Even in the case of the operation of soft-switching the second switching elements 2, zero-voltage switching may also be made by making the controller 50 perform the first operation and the second operation. That is to say, if one of two switches 8 corresponding one to one to two AC terminals 41, through which load currents having the same polarity flow, is a first switch and the other switch is a second switch, the controller 50 also performs the first operation and the second operation and shortens, by the shortening period, the high-level period of a control signal for the switch 8 corresponding to the AC terminal 41, through which a load current with a different polarity flows, and shifts, by the shifted time, the high-level period in such a direction as to either postpone or advance the high-level period.

No matter whether the first switching elements 1 or the second switching elements 2 are going to be soft-switched, if the controller 50 has determined that resonant currents respectively passing through the three switches 8 belonging to the plurality of switches 8 be going to flow simultaneously, the control signal for the switch 8 corresponding to the AC terminal 41, through which a load current of a different polarity flows, may only have its high-level period shortened by the shortening period or may only have its high-level period shifted by the shifted time in such a direction as to either postpone or advance the high-level period.

### Eleventh Embodiment

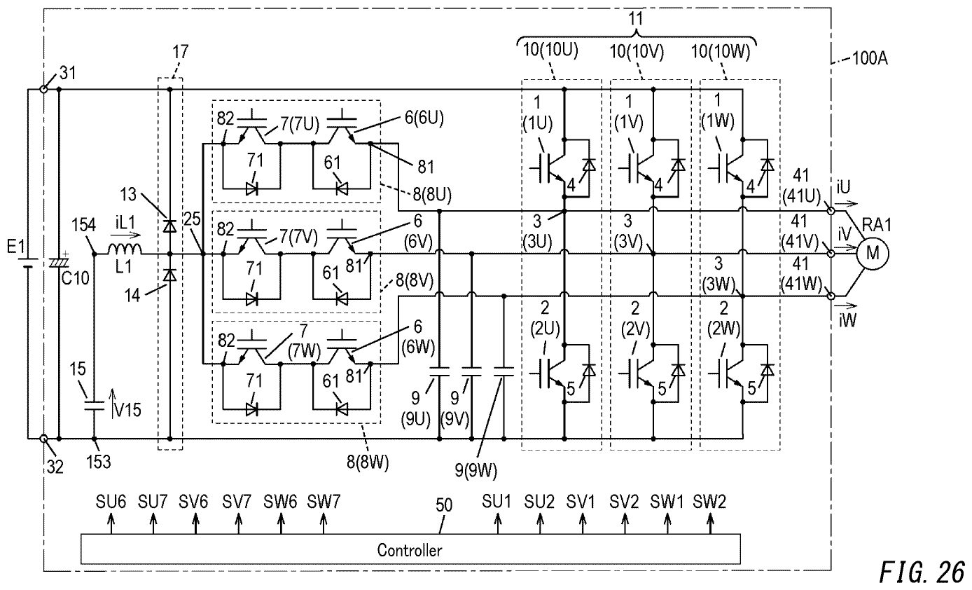

A power converter 100A according to an eleventh embodiment will be described with reference to FIG. 26. In the following description, any constituent element of the power converter 100A according to the eleventh embodiment, having the same function as a counterpart of the power converter 100 according to the first embodiment described above, will be designated by the same reference numeral as that counterpart's, and description thereof will be omitted herein.

In the power converter 100A according to the eleventh embodiment, in each of the plurality of switches 8, the first IGBT 6 and second IGBT 7 thereof are connected in anti-series. In the power converter 100A according to the eleventh embodiment, in each of the plurality of switches 8, the collector terminal of the first IGBT 6 and the collector terminal of the second IGBT 7 are connected to each other, the emitter terminal of the first IGBT 6 is connected to the connection node 3 of a corresponding one of the plurality of switching circuits 10, and the emitter terminal of the second IGBT 7 is connected to the common connection node 25. In addition, each of the plurality of switches 8 further includes a diode 61 connected to the first IGBT 6 in antiparallel and a diode 71 connected to the second IGBT 7 in antiparallel.

In the power converter 100A according to the eleventh embodiment, each of the first IGBT 6 and the second IGBT 7 may be replaced with either a MOSFET or a bipolar transistor. In that case, the diode 61 and diode 71 shown in FIG. 22 may each be replaced with, for example, either a parasitic diode of the replacement element or an element built in one chip of the replacement element. Also, in the power converter 100A according to the eleventh embodiment, the diode 61 and the diode 71 do not have to be provided as external elements for the first IGBT 6 and the second IGBT 7, respectively, but may also be elements built in one chip.

The controller 50 may operate in the same way as, for example, the controller 50 according to the first embodiment. However, this is only an example and should not be construed as limiting. Alternatively, the controller 50 may also operate in the same way as the controller 50 according to the first variation of the first embodiment, the second variation of the first embodiment, or any of the second to tenth embodiments described above and may also perform any of these operations in combination.

### Twelfth Embodiment

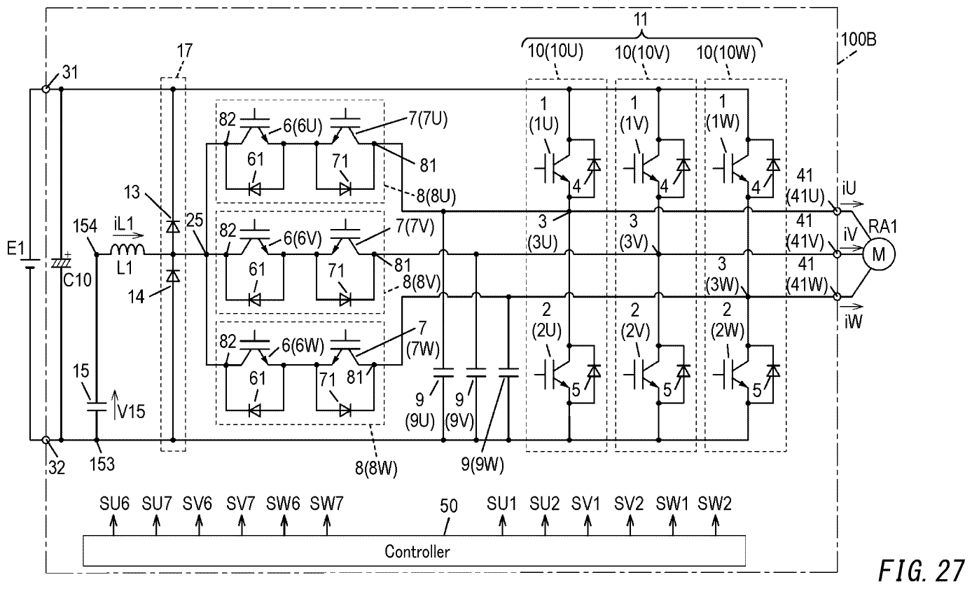

A power converter 100B according to a twelfth embodiment will be described with reference to FIG. 27. In the following description, any constituent element of the power converter 100B according to the twelfth embodiment, having the same function as a counterpart of the power converter 100 according to the first embodiment described above, will be designated by the same reference numeral as that counterpart's, and description thereof will be omitted herein.

In the power converter 100B according to the twelfth embodiment, in each of the plurality of switches 8, the first IGBT 6 and second IGBT 7 thereof are connected in anti-series. In the power converter 100B according to the twelfth embodiment, in each of the plurality of switches 8, the emitter terminal of the first IGBT 6 and the emitter terminal of the second IGBT 7 are connected to each other, the collector terminal of the second IGBT 7 is connected to the connection node 3 of a corresponding one of the plurality of switching circuits 10, and the collector terminal of the first IGBT 6 is connected to the common connection node 25. In addition, each of the plurality of switches 8 further includes a diode 61 connected to the first IGBT 6 in antiparallel and a diode 71 connected to the second IGBT 7 in antiparallel.

In the power converter 100B according to the twelfth embodiment, each of the first IGBT 6 and the second IGBT 7 may be replaced with either a MOSFET or a bipolar transistor. In that case, the diode 61 and diode 71 shown in FIG. 27 may each be replaced with, for example, either a parasitic diode of the replacement element or an element built in one chip of the replacement element. Also, in the power converter 100B according to the twelfth embodiment, the diode 61 and the diode 71 do not have to be provided as external elements for the first IGBT 6 and the second IGBT 7, respectively, but may also be elements built in one chip.

The controller 50 may operate in the same way as, for example, the controller 50 according to the first embodiment. However, this is only an example and should not be construed as limiting. Alternatively, the controller 50 may also operate in the same way as the controller 50 according to the first variation of the first embodiment, the second variation of the first embodiment, or any of the second to tenth embodiments described above and may also perform any of these operations in combination.

### Thirteenth Embodiment

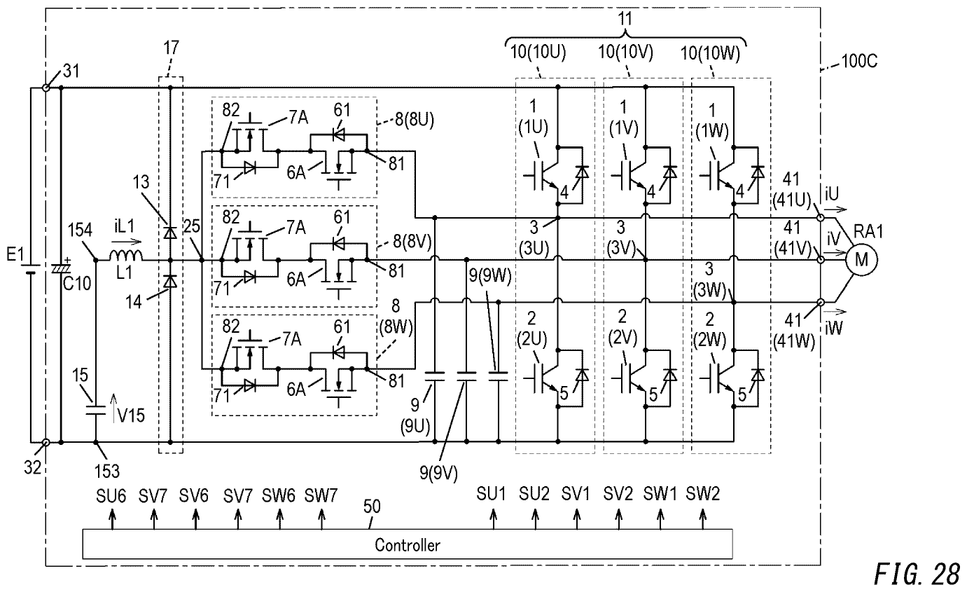

A power converter 100C according to a thirteenth embodiment will be described with reference to FIG. 28. In the following description, any constituent element of the power converter 100C according to the thirteenth embodiment, having the same function as a counterpart of the power converter 100 according to the first embodiment described above, will be designated by the same reference numeral as that counterpart's, and description thereof will be omitted herein.

In the power converter 100C according to the thirteenth embodiment, in each of the plurality of switches 8, a first MOSFET 6A and a second MOSFET 7A are connected in anti-series. In the power converter 100C according to the thirteenth embodiment, in each of the plurality of switches 8, the drain terminal of the first MOSFET 6A and the drain terminal of the second MOSFET 7A are connected to each other. In addition, each of the plurality of switches 8 further includes a diode 61 connected to the first MOSFET 6A in antiparallel and a diode 71 connected to the second MOSFET 7A in antiparallel. In each of the plurality of switches 8, the source terminal of the second MOSFET 7A is connected to the common connection node 25. In each of the plurality of switches 8, the source terminal of the first MOSFET 6A is connected to the connection node 3 of a switching circuit 10 corresponding to the switch 8 including the first MOSFET 6A. Control signals SU6, SU7 are respectively applied from the controller 50 to the first MOSFET 6A and second MOSFET 7A of the switch 8U. Control signals SV6, SV7 are respectively applied from the controller 50 to the first MOSFET 6A and second MOSFET 7A of the switch 8V. Control signals SW6, SW7 are respectively applied from the controller 50 to the first MOSFET 6A and second MOSFET 7A of the switch 8W.

The controller 50 may operate in the same way as, for example, the controller 50 according to the first embodiment. However, this is only an example and should not be construed as limiting. Alternatively, the controller 50 may also operate in the same way as the controller 50 according to the first variation of the first embodiment, the second variation of the first embodiment, or any of the second to tenth embodiments described above and may also perform any of these operations in combination.

### Fourteenth Embodiment

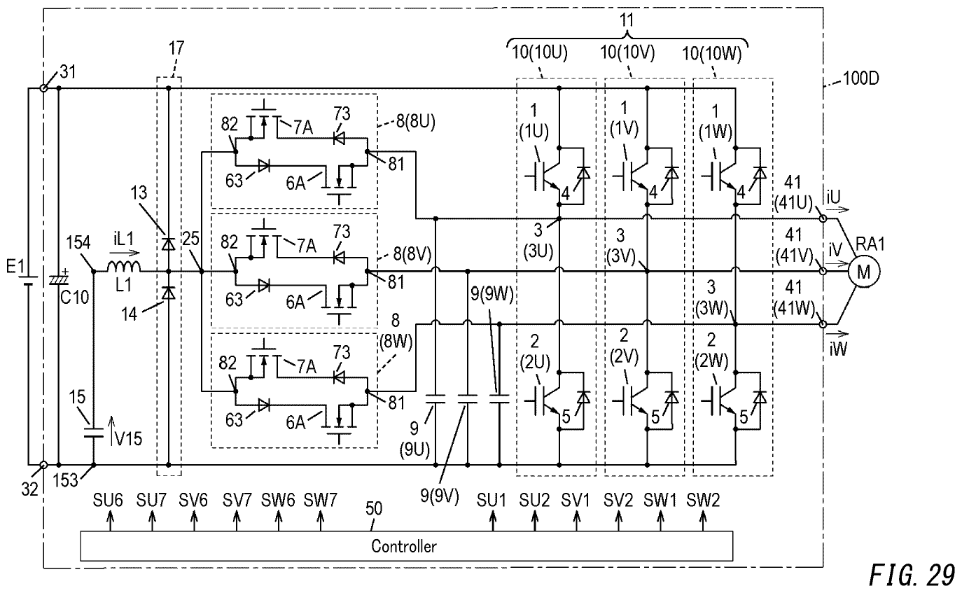

A power converter 100D according to a fourteenth embodiment will be described with reference to FIG. 29. In the following description, any constituent element of the power converter 100D according to the fourteenth embodiment, having the same function as a counterpart of the power converter 100 according to the first embodiment described above, will be designated by the same reference numeral as that counterpart's, and description thereof will be omitted herein.

In the power converter 100D according to the fourteenth embodiment, in each of the plurality of switches 8, a diode 63 is connected to a first MOSFET 6A in series and a diode 73 is connected to a second MOSFET 7A in series. In the power converter 100D according to the fourteenth embodiment, a series circuit of the first MOSFET 6A and the diode 63 and a series circuit of the second MOSFET 7A and the diode 73 are connected to each other in antiparallel.

The controller 50 may operate in the same way as, for example, the controller 50 according to the first embodiment. However, this is only an example and should not be construed as limiting. Alternatively, the controller 50 may also operate in the same way as the controller 50 according to the first variation of the first embodiment, the second variation of the first embodiment, or any of the second to tenth embodiments described above and may also perform any of these operations in combination.

### Fifteenth Embodiment

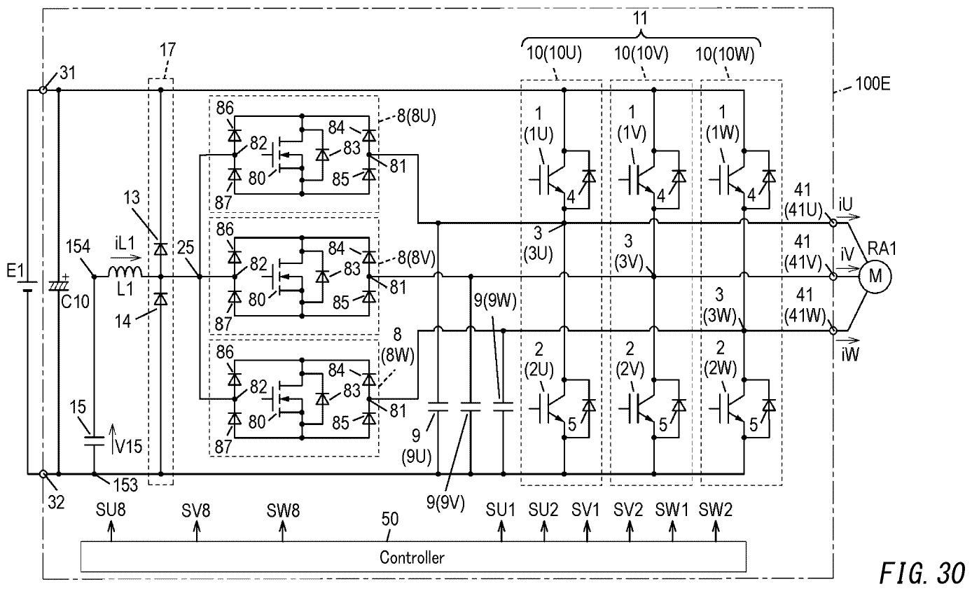

A power converter 100E according to a fifteenth embodiment will be described with reference to FIG. 30. In the following description, any constituent element of the power converter 100E according to the fifteenth embodiment, having the same function as a counterpart of the power converter 100 according to the first embodiment described above, will be designated by the same reference numeral as that counterpart's, and description thereof will be omitted herein.

In the power converter 100E according to the fifteenth embodiment, each of the plurality of switches 8 includes: a MOSFET 80; a diode 83 connected to the MOSFET 80 in antiparallel; a series circuit of two diodes 84, 85 connected to the MOSFET 80 in antiparallel; and a series circuit of two diodes 86, 87 connected to the MOSFET 80 in antiparallel. In each of the plurality of switches 8, a connection node between the diodes 84, 85 in the switch 8 (i.e., a first end 81 of the switch 8) is connected to the connection node 3 of a corresponding one of the plurality of switching circuits 10, and a connection node between the diodes 86, 87 (i.e., a second end 82 of the switch 8) is connected to the common connection node 25. In each of the switches 8, when the MOSFET 80 is ON, the switch 8 is ON. On the other hand, when the MOSFET 80 is OFF, the switch 8 is OFF.

The MOSFETs 80 of the plurality of switches 8 are controlled by the controller 50. The controller 50 outputs a control signal SU8 for controlling the ON/OFF states of the MOSFET 80 of the switch 8U, a control signal SV8 for controlling the ON/OFF states of the MOSFET 80 of the switch 8V, and a control signal SW8 for controlling the ON/OFF states of the MOSFET 80 of the switch 8W.

In each of the switches 8, when its MOSFET 80 is ON, a resonant current produced by a resonant circuit including the resonant inductor L1 and a corresponding one of the resonant capacitors 9 flows. In the power converter 100E, a charging current including the resonant current flows, when one of the plurality of switches 8 is ON, along the path passing through the regenerative capacitor 15, the resonant inductor L1, the diode 86, the MOSFET 80, the diode 85, and the resonant capacitor 9 in this order. Also, in the power converter 100E, a discharging current including the resonant current flows, when one of the plurality of switches 8 is ON, along the path passing through the resonant capacitor 9, the diode 84, the MOSFET 80, the diode 87, the resonant inductor L1, and regenerative capacitor 15 in this order.

In the power converter 100E according to the fifteenth embodiment, each of the plurality of MOSFETs 80 may be replaced with an IGBT. Also, in the power converter 100E according to the fifteenth embodiment, each of the plurality of switches 8 may include, for example, a bipolar transistor or a GaN-based gate injection transistor (GIT) instead of the MOSFET 80.

The controller 50 may operate in the same way as, for example, the controller 50 according to the first embodiment. However, this is only an example and should not be construed as limiting. Alternatively, the controller 50 may also operate in the same way as the controller 50 according to the first variation of the first embodiment, the second variation of the first embodiment, or any of the second to tenth embodiments described above and may also perform any of these operations in combination.

### Sixteenth Embodiment

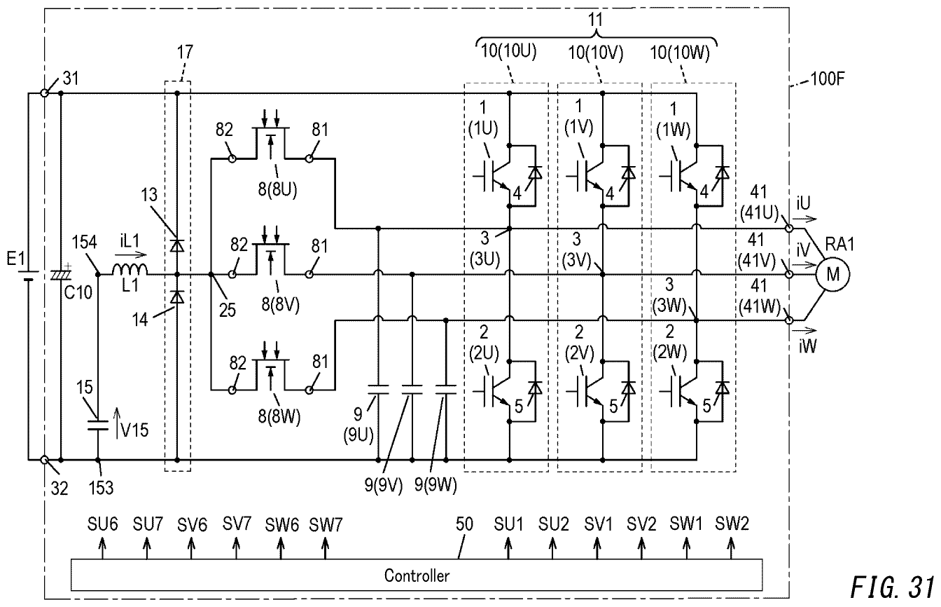

A power converter 100F according to a sixteenth embodiment will be described with reference to FIG. 31. In the following description, any constituent element of the power converter 100F according to the sixteenth embodiment, having the same function as a counterpart of the power converter 100 according to the first embodiment described above, will be designated by the same reference numeral as that counterpart's, and description thereof will be omitted herein.

In the power converter 100F according to the sixteenth embodiment, each of the plurality of switches 8 is a dual-gate GaN-based GIT including a first source terminal, a first gate terminal, a second gate terminal, and a second source terminal. In the power converter 100F according to the sixteenth embodiment, a control signal SU6 is applied to between the first gate terminal and first source terminal of a dual-gate GaN-based GIT serving as the switch 8U, and a control signal SU7 is applied to between the second gate terminal and the second source terminal thereof. In addition, a control signal SV6 is applied to between the first gate terminal and first source terminal of a dual-gate GaN-based GIT serving as the switch 8V, and a control signal SV7 is applied to between the second gate terminal and the second source terminal thereof. Furthermore, a control signal SW6 is applied to between the first gate terminal and first source terminal of a dual-gate GaN-based GIT serving as the switch 8W, and a control signal SW7 is applied to between the second gate terminal and the second source terminal thereof.

The controller 50 may operate in the same way as, for example, the controller 50 according to the first embodiment. However, this is only an example and should not be construed as limiting. Alternatively, the controller 50 may also operate in the same way as the controller 50 according to the first variation of the first embodiment, the second variation of the first embodiment, or any of the second to tenth embodiments described above and may also perform any of these operations in combination.

### Seventeenth Embodiment

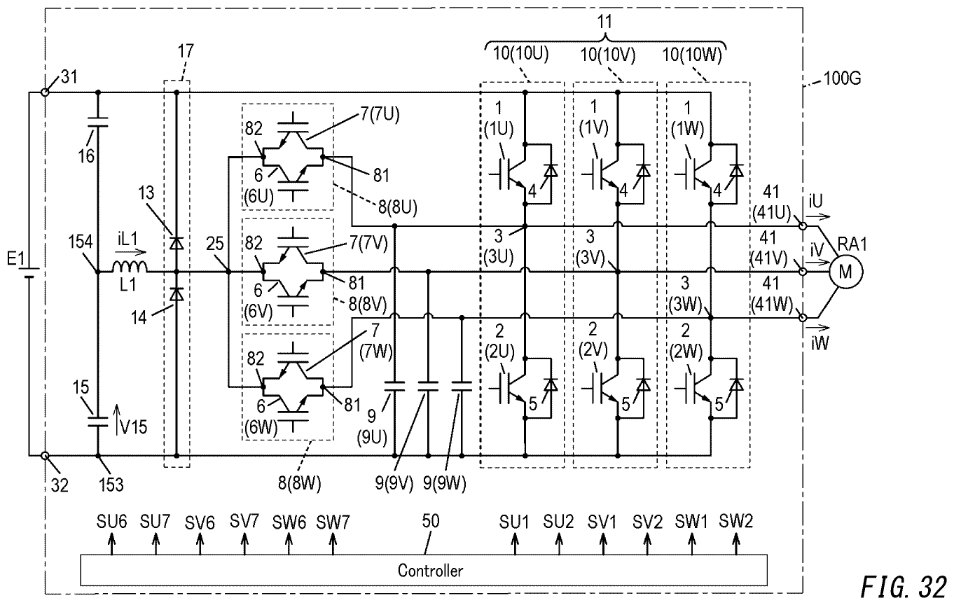

A power converter 100G according to a seventeenth embodiment will be described with reference to FIG. 32. The power converter 100G according to the seventeenth embodiment further includes a capacitor 16 connected between the second end of the resonant inductor L1 and the first DC terminal 31, which is a difference from the power converter 100 according to the first embodiment. In the following description, any constituent element of the power converter 100G according to the seventeenth embodiment, having the same function as a counterpart of the power converter 100 according to the first embodiment described above, will be designated by the same reference numeral as that counterpart's, and description thereof will be omitted herein.

The power converter 100G does not include the capacitor C10 of the power converter 100 according to the first embodiment. The capacitor 16 is connected to the regenerative capacitor 15 in series. Thus, in this power converter 100G, a series circuit of the capacitor 16 and the regenerative capacitor 15 is connected between the first DC terminal 31 and the second DC terminal 32. The capacitance of the capacitor 16 is equal to the capacitance of the regenerative capacitor 15. As used herein, the expression “the capacitance of the capacitor 16 is equal to the capacitance of the regenerative capacitor 15” refers to not only a situation where the capacitance of the capacitor 16 is exactly equal to the capacitance of the regenerative capacitor 15 but also a situation where the capacitance of the capacitor 16 is equal to or greater than 95% and equal to or less than 105% of the capacitance of the regenerative capacitor 15 as well.

In the power converter 100G according to the seventeenth embodiment, the potential V15 at the fourth end 154 of the regenerative capacitor 15 has a value calculated by dividing the voltage value Vd of the DC power supply E1 by two that is the number of the capacitors, namely, the capacitor 16 and the regenerative capacitor 15. Thus, the potential V15 at the fourth end 154 of the regenerative capacitor 15 is approximately Vd/2. In the power converter 100G according to the seventeenth embodiment, the controller 50 may store in advance the value of the potential V15 at the fourth end 154 of the regenerative capacitor 15.

The controller 50 of the power converter 100G according to the seventeenth embodiment, as well as the controller 50 of the power converter 100 according to the first embodiment, performs the first operation and the second operation. Thus, the power converter 100G according to the seventeenth embodiment, as well as the power converter 100 according to the first embodiment, may make zero-voltage soft switching of each of the plurality of first switching elements 1 and the plurality of second switching elements 2.

The controller 50 may operate in the same way as, for example, the controller 50 according to the first embodiment. However, this is only an example and should not be construed as limiting. Alternatively, the controller 50 may also operate in the same way as the controller 50 according to the first variation of the first embodiment, the second variation of the first embodiment, or any of the second to tenth embodiments described above and may also perform any of these operations in combination.

### Eighteenth Embodiment

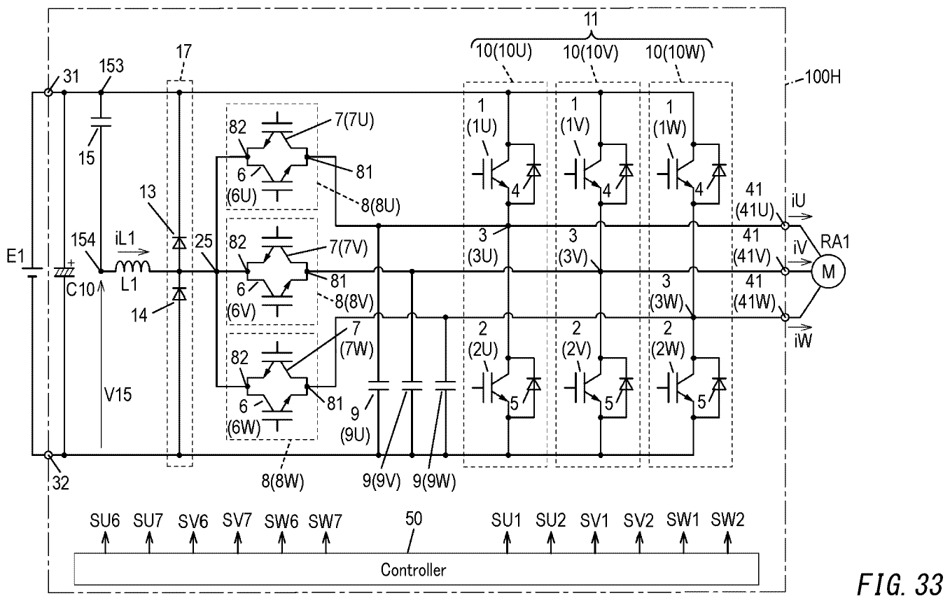

A power converter 100H according to an eighteenth embodiment will be described with reference to FIG. 33. In the power converter 100H according to the eighteenth embodiment, the regenerative capacitor 15 is connected between the second end of the resonant inductor L1 and the first DC terminal 31, which is a difference from the power converter 100 according to the first embodiment. In the following description, any constituent element of the power converter 100H according to this eighteenth embodiment, having the same function as a counterpart of the power converter 100 according to the first embodiment described above, will be designated by the same reference numeral as that counterpart's, and description thereof will be omitted herein.

The controller 50 of the power converter 100H according to the eighteenth embodiment, as well as the controller 50 of the power converter 100 according to the first embodiment, performs the first operation and the second operation. Thus, the power converter 100H according to the eighteenth embodiment, as well as the power converter 100 according to the first embodiment, may make soft switching with more reliability.

### Other Variations

Note that the first to eighteenth embodiments and their variations described above are only exemplary ones of various embodiments of the present disclosure and their variations and should not be construed as limiting. Rather, the first to eighteenth exemplary embodiments and their variations may be readily modified in various manners depending on a design choice or any other factor without departing from the scope of the present disclosure.

The operation performed by the controller 50 to “determine that a plurality of resonant currents be going to flow simultaneously” is not limited to the operation of “determining that a plurality of resonant currents be going to flow simultaneously” if the time lag described for the first embodiment is less than a threshold value.

Alternatively, the controller 50 may determine that two-phase resonant currents be going to flow simultaneously if any one of the current difference between the U-phase load current iU and the V-phase load current iV, the current difference between the V-phase load current iV and the W-phase load current iW, or the current difference between the W-phase load current iW and the U-phase load current iU is less than a current difference threshold value.

Still alternatively, the controller 50 may determine that three-phase resonant currents be going to flow simultaneously if the current difference between the U-phase load current iU and the V-phase load current iV, the current difference between the V-phase load current iV and the W-phase load current iW, and the current difference between the W-phase load current iW and the U-phase load current iU are all less than the current difference threshold value.

Yet alternatively, the controller 50 may determine “two-phase resonant currents be going to flow simultaneously” if the electrical angle determined by calculation, or estimated, based on sensor information provided by a sensor device (such as an encoder or a resolver) for detecting the number of revolutions of a motor falls within a first rotational angle range (e.g., equal to or larger than 55 degrees and equal to or smaller than 65 degrees), or a second rotational angle range (e.g., equal to or larger than 115 degrees and equal to or smaller than 125 degrees), or a third rotational angle range (e.g., equal to or larger than 175 degrees and equal to or smaller than 185 degrees), or a fourth rotational angle range (e.g., equal to or larger than 235 degrees and equal to or smaller than 245 degrees), or a fifth rotational angle range (e.g., equal to or larger than 295 degrees and equal to or smaller than 305 degrees), or a sixth rotational angle range (e.g., equal to or larger than 355 degrees and equal to or smaller than 365 degrees).

For example, each of the plurality of first switching elements 1 and the plurality of second switching elements 2 does not have to be an IGBT but may also be a MOSFET. In that case, each of the plurality of first diodes 4 may also be replaced with, for example, a parasitic diode of a MOSFET serving as its corresponding first switching element 1. In addition, each of the plurality of second diodes 5 may also be replaced with, for example, a parasitic diode of a MOSFET serving as its corresponding second switching element 2. The MOSFET may be, for example, an Si-based MOSFET or an SiC-based MOSFET. Each of the plurality of first switching elements 1 and the plurality of second switching elements 2 may also be, for example, a bipolar transistor or a GaN-based GIT.

Optionally, in the power converters 100 and 100A-100H, if each of the plurality of resonant capacitors 9 has a relatively small capacitance, then the parasitic capacitors across the plurality of second switching elements 2 may also serve as the plurality of resonant capacitors 9 instead of providing the plurality of resonant capacitors 9 as separate elements.

Furthermore, the length of the dead time period Td does not have to be set to be as long as one resonant half cycle but may also be set to be different from one resonant half cycle.

The dead time period Td may also be set by a dead time generator circuit included in a gate driver integrated circuit (IC) provided separately from the controller 50. Alternatively, the controller 50 may include a gate driver IC and a dead time generator circuit included in the gate driver IC may set the dead time period Td.

Furthermore, in the second to eighteenth embodiments, the controller 50 may set a clamp period as already described for the second variation of the first embodiment. In this case, the length of the clamp period of the control signal SU6 for the U-phase switch 8U, for example, does not have to agree with the additional time Tau. Optionally, the length of the clamp period may also be zero, may be set at a value falling within the range from 0 to Tau, or may be greater than the period of the additional time Tau by an arbitrary period ΔTclp. There is no problem even if the arbitrary period ΔTclp is set at any value as long as the end time of the period Tau+ΔTclp falls within one carrier cycle.

Furthermore, in any of the second to eighteenth embodiments, as well as in the first embodiment, the length of the shortening period Tred may be equal to or less than the length of the additional time Tad. This allows the soft switching to be made in any of the second to eighteenth embodiments even if the length of the shortening period Tred varies.

Furthermore, in the first embodiment described above, the controller 50 calculates the shifted time (e.g., Tsu)=ΔT+Tdef. However, the shifted time is not limited to the result calculated by this equation but may also be calculated by any other equation as long as soft switching may be achieved substantially compared to the situation before the shift. Alternatively, the shifted time may deviate from the result obtained by the equation.

Furthermore, when determining that two-phase resonant currents, such as U-phase and V-phase resonant currents, be going to flow simultaneously, the standby time Tdef may have a value calculated by the equation Tdef=L×|iV−iU I/V15 in the first embodiment described above and Tdef=0 is satisfied in the second embodiment described above. Alternatively, the standby time Tdef may also be set at a value falling within the range from 0 to (L×|iV−iU|/V15). The standby period Tdef may be set in the same way in any of the other third to eighteenth embodiments as well.

Furthermore, the new additional time is supposed to be calculated by, for example, the equation Tav2=L×(iV−iU)/V15 in the fourth embodiment and Tav2=0 is satisfied in the fifth embodiment. Alternatively, the new additional time may also be set at any value falling within the range from 0 to (L×|iV−iU|/V15). The new additional time may be set in the same way in any of the other embodiments as well.

Furthermore, the power converters 100 and 100A-100H do not have to be configured to output three-phase AC power but may also be configured to output multi-phase AC power in more than three phases. As for the method for determining the additional time Tau, Tav, Taw already described in the “(3.1) Basic example” section for the first embodiment, the equation cited above is an example of ideal design, and therefore, calculation is not always made using such an equation. Rather, as the case may be, there is no problem even if the additional time Tau, Tav, Taw is set at either 0 or any other fixed value. Also, as long as the object of providing the additional time Tau, Tav, Taw is achievable, the additional time Tau, Tav, Taw may also have a value calculated by any other equation. For example, in the basic example described above, the additional time Tau is calculated by the equation: Tau=iU×(L/V15). However, this is only an example and should not be construed as limiting. Alternatively, Tau may also be set at 0, may be set at a value falling within the range from 0 to iU×(L/V15), may be set at an always constant additional time, may be calculated by another equation, or may be set as a combination of these.

### Aspects

The foregoing description provides specific implementations of the following aspects of the present disclosure.

A power converter (100; 100A; 100B; 100C; 100D; 100E; 100F; 100G; 100H) according to a first aspect includes a first DC terminal (31) and a second DC terminal (32), a power converter circuit (11), a plurality of AC terminals (41), a plurality of switches (8), a plurality of resonant capacitors (9), a resonant inductor (L1), a regenerative capacitor (15), and a controller (50). The power converter circuit (11) includes a plurality of first switching elements (1) and a plurality of second switching elements (2). In the power converter circuit (11), a plurality of switching circuits (10), in each of which one of the plurality of first switching elements (1) and a corresponding one of the plurality of second switching elements (2) are connected one to one in series, are connected to each other in parallel. In the power converter circuit (11), the plurality of first switching elements (1) are connected to the first DC terminal (31), and the plurality of second switching elements (2) are connected to the second DC terminal (32). The plurality of AC terminals (41) are provided one to one for the plurality of switching circuits (10). Each of the plurality of AC terminals (41) is connected to a connection node (3) between the first switching element (1) and the second switching element (2) of a corresponding one of the plurality of switching circuits (10). The plurality of switches (8) are provided one to one for the plurality of switching circuits (10). Each of the plurality of switches (8) has a first end (81) thereof connected to the connection node (3) between the first switching element (1) and the second switching element (2) of a corresponding one of the plurality of switching circuits (10). The plurality of switches (8) have their respective second ends (82) connected in common to a common connection node (25). The plurality of resonant capacitors (9) are provided one to one for the plurality of switches (8). Each of the plurality of resonant capacitors (9) is connected between the first end (81) of a corresponding one of the plurality of switches (8) and the second DC terminal (32). The resonant inductor (L1) has a first end and a second end. In the resonant inductor (L1), the first end of the resonant inductor (L1) is connected to the common connection node (25). The regenerative capacitor (15) has a third end (153) and a fourth end (154). In the regenerative capacitor (15), the third end (153) of the regenerative capacitor (15) is connected to either the first DC terminal (31) or the second DC terminal (32). The controller (50) applies a control signal, having a potential alternating between a high level and a low level, to each of the plurality of first switching elements (1), the plurality of second switching elements (2), and the plurality of switches (8). The controller (50) sets, with respect to each of the plurality of switching circuits (10), a dead time period (Td) between a high-level period of the control signal for the first switching element (1) and a high-level period of the control signal for the second switching element (2) and sets a high-level period of the control signal for each of the plurality of switches (8) based on the dead time period (Td) with respect to a corresponding switching circuit (10) belonging to the plurality of switching circuits (10). Each of the plurality of AC terminals (41) allows a load current, passing through either the first switching element (1) or the second switching element (2) of the corresponding switching circuit (10), to flow therethrough. The controller (50) performs, when determining that resonant currents respectively passing through two or more switches (8) belonging to the plurality of switches (8) be going to flow through the resonant inductor (L1) simultaneously, a first operation and further performs a second operation, supposing the two or more switches include two switches (8) corresponding one to one to two AC terminals (41) causing load currents of the same polarity to flow therethrough which belong to the plurality of AC terminals (41) and one of the two switches (8) is a first switch and a remaining one of the two switches (8) is a second switch. The first operation includes shortening a high-level period of a control signal for the first switch by a shortening period (Tred) from a period including a resonant half cycle and an additional time (Tad). The resonant half cycle is determined by capacitance of one resonant capacitor (9) corresponding to the first switch which belongs to the plurality of resonant capacitors (9) and inductance of the resonant inductor (L1). The additional time (Tad) is determined by a voltage (V15) of the regenerative capacitor (15), inductance of the resonant inductor (L1), and a load current value. The second operation includes shifting a high-level period of a control signal for at least one of the first switch or the second switch to cause the high-level period of the control signal for the first switch to begin when a standby period (Tdef) has passed since a point in time when a current value of a resonant current passing through the second switch agreed with a current value of a load current flowing through an AC terminal (41) corresponding to the second switch which belongs to the two or more AC terminals (41) after the current value of the resonant current passing through the second switch had become equal to an extreme value.

This aspect allows soft switching to be made with more reliability.

In a power converter (100; 100A; 100B; 100C; 100D; 100E; 100F; 100G; 100H) according to a second aspect, the shortening period (Tred) is equal to or shorter than the additional time (Tad).

This aspect allows the soft switching to be made even if the length of the shortening period varies.

In a power converter (100; 100A; 100B; 100C) according to a third aspect, which may be implemented in conjunction with the first or second aspect, when performing the second operation, the controller (50) shifts, in mutually different directions, the high-level period of the control signal for the first switch and the high-level period of the control signal for the second switch.

This aspect contributes to increasing the operating frequency.

In a power converter (100; 100A; 100B; 100C; 100D; 100E; 100F; 100G; 100H) according to a fourth aspect, which may be implemented in conjunction with the first or second aspect, the controller (50) shifts, when performing the second operation, either the high-level period of the control signal for the first switch or the high-level period of the control signal for the second switch.

This aspect allows a variation in line voltage to be reduced.

### INDUSTRIAL APPLICABILITY

A power converter according to the present disclosure allows soft switching to be made with more reliability, thus further improving the reliability of the power converter. As can be seen, the power converter according to the present disclosure is effectively applicable to various fields on an industrial basis.

### REFERENCE SIGNS LIST

1 First Switching Element
2 Second Switching Element
3 Connection Node
8 Switch
9 Resonant Capacitor
10 Switching Circuit
11 Power Converter Circuit
15 Regenerative Capacitor
153 Third End
154 Fourth End
31 First DC Terminal
32 Second DC Terminal
41 AC Terminal
50 Controller
100, 100A, 100B, 100C, 100D, 100E, 100F, 100G, 100H Power Converter
iU, iV, iW Output Current (Load Current)
L1 Resonant Inductor
RA1 AC Load
SU1, SU2, SU6, SU7 Control Signal
SV1, SV2, SV6, SV7 Control Signal
SW1, SW2, SW6, SW7 Control Signal
Tad Additional Time
Tred Shortening Period
Tdef Standby Period
Tres Resonant Half Cycle
V15 Voltage

1. A power converter comprising:
a first DC terminal and a second DC terminal;
a power converter circuit including a plurality of first switching elements and a plurality of second switching elements, the power converter circuit being implemented as a parallel connection of a plurality of switching circuits in each of which one of the plurality of first switching elements and a corresponding one of the plurality of second switching elements are connected one to one in series, the plurality of first switching elements being connected to the first DC terminal, the plurality of second switching elements being connected to the second DC terminal;
a plurality of AC terminals provided one to one for the plurality of switching circuits, each of the plurality of AC terminals being connected to a connection node between the first switching element and the second switching element of a corresponding one of the plurality of switching circuits;
a plurality of switches provided one to one for the plurality of switching circuits, each of the plurality of switches having a first end thereof connected to the connection node between the first switching element and the second switching element of a corresponding one of the plurality of switching circuits, the plurality of switches having their respective second ends connected in common to a common connection node;
a plurality of resonant capacitors provided one to one for the plurality of switches, each of the plurality of resonant capacitors being connected between the first end of a corresponding one of the plurality of switches and the second DC terminal;
a resonant inductor having a first end and a second end, the first end of the resonant inductor being connected to the common connection node;
a regenerative capacitor having a third end and a fourth end, the third end of the regenerative capacitor being connected to either the first DC terminal or the second DC terminal; and
a controller configured to apply a control signal, having a potential alternating between a high level and a low level, to each of the plurality of first switching elements, the plurality of second switching elements, and the plurality of switches,
the controller being configured to set, with respect to each of the plurality of switching circuits, a dead time period between a high-level period of the control signal for the first switching element and a high-level period of the control signal for the second switching element and set a high-level period of the control signal for each of the plurality of switches based on the dead time period with respect to a corresponding switching circuit belonging to the plurality of switching circuits,
each of the plurality of AC terminals being configured to allow a load current, passing through either the first switching element or the second switching element of the corresponding switching circuit, to flow therethrough,
the controller being configured to, when determining that resonant currents respectively passing through two or more switches belonging to the plurality of switches be going to flow through the resonant inductor simultaneously, perform a first operation and a second operation,
supposing the two or more switches include two switches corresponding one to one to two AC terminals causing load currents of the same polarity to flow therethrough which belong to the plurality of AC terminals and one of the two switches is a first switch and a remaining one of the two switches is a second switch,
the first operation including shortening a high-level period of a control signal for the first switch by a shortening period from a period including a resonant half cycle and an additional time, the resonant half cycle being determined by capacitance of one resonant capacitor corresponding to the first switch which belongs to the plurality of resonant capacitors and inductance of the resonant inductor, the additional time being determined by a voltage of the regenerative capacitor, inductance of the resonant inductor, and a load current value,
the second operation including shifting a high-level period of a control signal for at least one of the first switch or the second switch to cause the high-level period of the control signal for the first switch to begin when a standby period has passed since a point in time when a current value of a resonant current passing through the second switch agreed with a current value of a load current flowing through an AC terminal corresponding to the second switch which belongs to the two or more AC terminals after the current value of the resonant current passing through the second switch had become equal to an extreme value.

212. The power converter of claim 1, wherein
the shortening period is equal to or shorter than the additional time.

3. The power converter of claim 1, wherein
the controller is configured to, when performing the second operation, shift, in mutually different directions, the high-level period of the control signal for the first switch and the high-level period of the control signal for the second switch.

4. The power converter of claim 1, wherein
the controller is configured to, when performing the second operation, shift either the high-level period of the control signal for the first switch or the high-level period of the control signal for the second switch.
